(19) United States
(12) Patent Application Publication
(10) Pub. No.: US 2023/0221343 A1
(43) Pub. Date: Jul. 13, 2023

(54) Biological Analysis Systems and Methods

(71) Applicant: Life Technologies Holdings PTE Limited, Singapore (SG)

(72) Inventors: Kuan Moon Boo, Singapore (SG); Wei Fuh Teo, Singapore (SG); Zeqi Tan, Singapore (SG); Ming Tiong Sia, Singapore (SG); Ching Yee Lam, Singapore (SJ); Shan Hua Dong, Singapore (SG); Woon Liang Soh, Singapore (SG); Soo Yong Lau, Singapore (SG)

(73) Assignee: Life Technologies Holdings PTE Limited, Singapore (SG)

(21) Appl. No.: 17/923,900

(22) PCT Filed: May 8, 2021
(86) PCT No.: PCT/IB2021/053928

§ 371 Date: Nov. 7, 2022

Related U.S. Application Data
(60) Provisional application No. 63/022,206, filed on May 8, 2020.
(60) Provisional application No. 63/108,842, filed on Nov. 2, 2020.

(51) Int. Cl. G01N 35/04; G01N 35/00; B01L 3/00; B01L 7/00

(52) U.S. Cl. CPC G01N 35/04; B01L 3/502715; B01L 7/52; G01N 35/00732; B01L 2200/16; B01L 2200/026; B01L 2300/022; B01L 2300/042; B01L 2300/0663; G01N 2035/00366; G01N 2035/00376; G01N 2035/00831

(57) ABSTRACT

A biological analysis system for performing a performing an assay or experiment includes one or more of a carrier, base, or tray. The carrier, base, or tray is/are configured to interchangeably receive (1) a first block and a corresponding first cover placed over the first block or (2) a second block and a corresponding second cover placed over the second block; The system also includes a computer readable memory comprising instructions for detecting when the second cover is placed over the first block and/or for detecting when the first cover is placed over the second block based on lack of electrical continuity along an electrical path comprising one of the blocks and one of the covers.

### FIELD OF THE DISCLOSURE

The present disclosure relates broadly, but not exclusively, to biological analysis systems and related methods, including polymerase chain reaction (PCR) systems.

### BACKGROUND

Biological analysis systems, such as PCR systems, are useful tools for conducting diagnostics and research in biological or biochemical samples. A PCR system typically has a thermal cycler that heats and cools the samples over a number of cycles to achieve the desired amplification of one or more target molecules. Real-time PCR systems, also known as qualitative PCR (qPCR) systems allow monitoring of a PCR assay during each thermal cycle of the process.

Generally, there is an increasing need to simplify the installation and setup of biological analysis systems so that operators can more quickly and efficiently use biological analysis systems for their intended purpose. However, existing systems typically require manual operation or intervention which may result in inefficiency and inconsistency.

Thus, it is desirable to provide a biological analysis system that can address at least one of the above problems.

### BRIEF DESCRIPTION OF THE DRAWINGS

Embodiments of the present disclosure will be better understood and readily apparent to one of ordinary skill in the art from the following written description, by way of example only, and in conjunction with the drawings, in which:

FIG. 1 shows a block diagram that illustrates a PCR instrument upon which embodiments of the present teachings may be implemented.

FIG. 2 shows a block diagram that illustrates a computer system that may be employed to carry out processing functionality, according to some exemplary embodiments of the disclosure.

FIGS. 3A-3B show exploded and assembled views, respectively, of a block assembly according to an example embodiment.

FIGS. 3C-3D show perspective views of sample block and sample holder according to an example embodiment.

FIGS. 4A-4B show withdrawn and extended positions, respectively, of the block assembly of FIGS. 3A-3B according to an example embodiment.

FIGS. 5A-5B show the sample block of the block assembly of FIGS. 3A-3B in disengaged and engaged states, respectively, with a base according to an example embodiment.

FIGS. 6A-6B shows magnified views of portions of the block assembly of FIGS. 3A-3B.

FIG. 7 shows a perspective view of an optics assembly having a cover carrier connected thereto according to an example embodiment.

FIGS. 8A-8D show cross-sectional view illustrating an operation of the cover carrier according to an example embodiment.

FIGS. 9A-9K show various views a cover carrier according to an example embodiment.

FIGS. 10A-10B show exploded and assembled views, respective, of a biological analysis system according to an example embodiment and a reagent with RFID tag.

FIGS. 11A-11B show close-up cross-sectional views inside the assembled system of FIGS. 10A-10B according to an example embodiment.

FIG. 12 shows a partial cross-sectional view of the assembled system of FIGS. 10A-10B according to an example embodiment.

FIG. 13 shows a flow diagram of a method accord to an example embodiment.

FIG. 14 shows a flow diagram of a method accord to an example embodiment.

FIG. 15 shows a flow diagram of a method accord to an example embodiment.

FIG. 16 shows bottom view of a cover according to embodiments of the present disclosure.

FIG. 17 shows a top view of a sample block according to embodiments of the present disclosure.

FIGS. 17A, 17B, 17C show magnified views of elements of the sample block illustrated in FIG. 17.

FIG. 18 shows a perspective view of the cover illustrated in FIG. 16.

FIG. 19 shows a perspective view of the sample block illustrated in FIG. 17.

FIG. 20 shows perspective view of the sample block shown in FIGS. 17 and 19 with a sample holder placed on the sample block.

FIG. 21 shows cross section of the sample block shown in FIGS. 17 and 19 with a sample holder.

FIG. 22 shows perspective view of a second cover according to embodiments of the present disclosure.

FIGS. 22A-22B show magnified views of elements of the cover illustrated in FIG. 22.

FIG. 23 shows perspective view of a second sample block according to embodiments of the present disclosure.

FIG. 24 shows a first combination of a connector of a sample block and a connector of a cover according to embodiments of the present disclosure in which the is a lack of electrical continuity between the connectors.

FIG. 25 shows a second combination of a connector of a sample block and a connector of a cover according to embodiments of the present disclosure in which the is a lack of electrical continuity between the connectors.

FIGS. 26A-26B show views of embodiments when a cover is to be place over sample block for which is does not correspond.

FIG. 27 shows perspective view of another embodiment of a cover located above a sample block corresponding to the cover.

FIG. 28 shows a plane view of the cover and sample block illustrated in FIG. 27.

FIG. 29 shows another perspective view of the cover and sample block illustrated in FIG. 27.

FIGS. 30 and 31 show plane views of the electrical connectors of different covers configured to accommodate different types of sample holders.

FIG. 32 shows perspective view of the sample block shown in FIGS. 27-29 with a calibration or alignment fixture placed on the sample block.

FIGS. 33-35 show cross-sectional views of the calibration or alignment fixture shown in FIG. 32.

FIG. 36 shows a view of a pill box or well of a sample holder configured for use with the sample block shown in FIGS. 27-29, which illustrates the location of an illumination beam and a bubble at the edge of the pill box or well.

FIG. 37 shows a cross-section of the sample block shown in FIGS. 27-29, which shows features of the sample block used to move the sample block for calibration or alignment to an optical system of an instrument or system into which the sample block may be placed.

FIG. 38 is a flow chart of a method for calibration or alignment of the sample block shown in FIGS. 27-29 to the optical system of an instrument or system into which the sample block may be placed.

FIGS. 39-41 are images of scans of wells of the calibration or alignment fixture shown in FIGS. 32-35.

### DETAILED DESCRIPTION

To provide a more thorough understanding of the present disclosure, the following description sets forth numerous specific details, such as specific configurations, parameters, examples, and the like. It should be recognized, however, that such description is not intended as a limitation on the scope of the present invention, but is intended to provide a better description of the exemplary embodiments.

It should also be recognized that the methods and systems described herein may be implemented in various types of systems, instruments, and machines such as biological analysis systems. For example, various embodiments may be implemented in an instrument, system or machine that performs polymerase chain reactions (PCR) on a plurality of samples. While generally applicable to quantitative polymerase chain reactions (qPCR) where a large number of samples are being processed, it should be recognized that any suitable PCR method may be used in accordance with various embodiments described herein. Suitable PCR methods include, but are not limited to, digital PCR, allele-specific PCR, asymmetric PCR, ligation-mediated PCR, multiplex PCR, nested PCR, qPCR, genome walking, and bridge PCR, for example. Furthermore, as used herein, thermal cycling may include using a thermal cycler, isothermal amplification, thermal convection, infrared mediated thermal cycling, or helicase dependent amplification.

The term “radio frequency identifier”, “radio frequency identifier tag”, or “RFID tag” as used herein may refer to a chip comprising an integrated circuit and an antenna. The integrated circuitry may store data that can be communicated by a radio frequency transmitted by the antenna. The integrated circuit and antenna circuitry may be printed on the chip. An RFID “tag” or “transponder” can be read by an RFID reader using an antenna that emits radio frequencies to query the transponder. A “passive RFID” does not have its own energy source, but responds to signals from a reader to transmit a signal. An “active RFID” includes a battery as a power source. Some examples of RFID tags can be found in U.S. Pat. Nos. 6,147,662; 6,917,291; 5,949,049; 6,652,812; 6,112,152; and U.S. Pat. Application No. 2003/0183683 all of which are herein incorporated by reference in their entireties for their disclosure of RFID tags, chips, labels, or devices, RFID readers, and RFID systems, their design and use. A “writable radio frequency identifier” or “writable RFID” is an RFID tag that has memory space that can be written to by an RFID writer.

The term “sample holder” as used herein may refer to a structure for directly or indirectly supporting one or more reaction sites, each configured to contain a biological sample and any associated reagents, dyes, probes, detergents, enzymes, master mixes, or the like. Examples of sample holders include, but are not limited to, microtiter plates, reaction plates, tubes, tube carriers, surface plasmon resonance arrays, slides, conical low-volume tubes, microfluidic cards, microarray chips, plates or cartridges, through-hole arrays, sample preparation devices, assay preparation devices, electrophoretic type device, electroosmotic type devices, immunoassays, combinatorial libraries, molecular libraries, phage display libraries, DNA libraries, DNA fingerprinting devices, SNP detection devices, vacuum containers, and other types of containers for supporting biological reagents or assays. The sample holder can comprise a plurality of reaction regions, reaction sites, or sample retainment regions. The reaction regions may be in the form of wells, through-holes, chambers cavities, or material surface indentations or spots (e.g., hydrophilic spots on a surface), or the like. The sample holder can be a multi-well tray or microtiter plate including, for example, 4, 12, 24, 48, 96, 192, 384, 768, 1536, 3072, 6144, 12288, or more wells or other types of sample retainment regions. The sample holder can retain a fluid, if the sample holder can be utilized to transfer, contain, encompass, or otherwise hold, permanently or temporarily, a fluid. The sample holder material can comprise any materials used in chemical and biochemical synthesis. The sample holder material can comprise polymeric materials that are compatible with chemical and biological syntheses and assays, and include glasses, silicates, celluloses, polystyrenes, polysaccharides, sand, and synthetic resins and polymers, including acrylamides, particularly cross-linked polymers, cotton, and other such materials. The sample holder material can be in the form of particles or can be continuous in design, such as a test tube or microtiter plate or the like.

As used herein, the terms “communication”, “electrical communication”, or “electronic communication” generally means communication between two or more electronic components (e.g., electronic devices or electronic systems). The communication may be achieved via a physical connection between (e.g., an electrical wire, an electrical cable, fiber optic cable, or the like connected to both two electronic components or via a third electronic component to which first and second communicating components are commonly connected, for example, a network system such as a Local Area Network (LAN), or a wide area network (WAN), or the like). Additionally or alternatively, the electrical communication may be via a transmitter/receiver configuration, for example, a direct wireless communication between the devices (e.g., between antennas in two communicating components, a Bluetooth connection, and/or the like) or via wireless network (e.g., a wireless router system, Wi-Fi connection, or wireless data communication system, such as provided by a telecommunications provider). The electrical communication may additionally or alternatively be provided via communication of the device to a common database, such as a Cloud database.

### System Overview

As mentioned above, an instrument according to embodiments of the present teaching may be utilized to perform various types of biological assays, experiments, tests, or the like. In the current disclosure, embodiments of an instrument for use in conducting polymerase chain reaction (PCR) assays are illustrated using a microtiter plate. However, embodiments of the present teaching extend to other types of instruments (e.g. capillary electrophoresis instruments, sequencing instruments, such as Next Generation Sequencing (NGS) instruments, microarray systems, flow cytometers, and the like), sample holders (e.g., as discussed above herein), and assays such (e.g., capillary electrophoresis, genetic sequencing, genotyping, and the like).

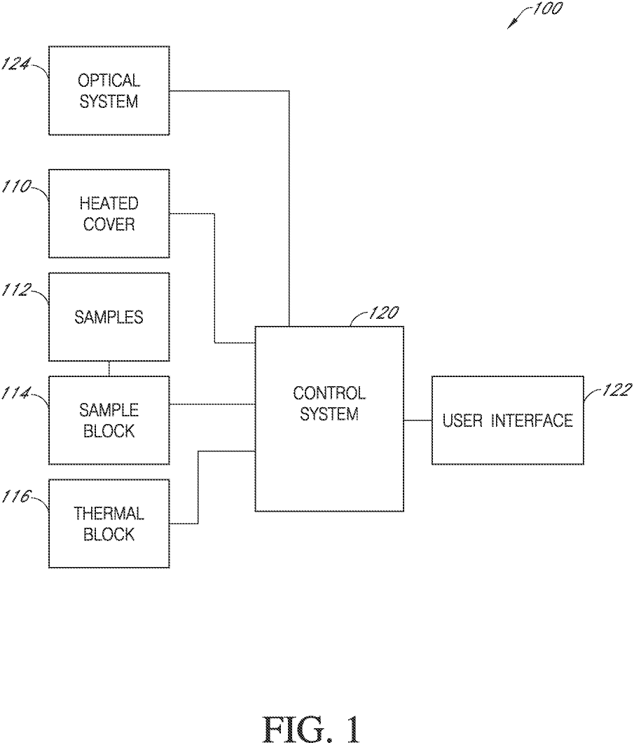

FIG. 1 shows a block diagram that illustrates elements of an instrument 100, such as a Real-time PCR instrument 100, upon which embodiments of the present teachings may be implemented. Real-time PCR instrument 100 may include a cover or heated cover 110 that is placed over a plurality of samples 112 contained in a substrate, plate, or sample holder (not shown here). In various embodiments, a sample holder may be a glass or plastic slide with a plurality of sample regions, which sample regions have a cover between the sample regions and heated cover 110. The sample holder may comprise one or more reaction sites in various embodiments, which may include depressions, wells, through-holes, indentations, surface discontinuities, ridges, and combinations thereof, which may be patterned in regular or irregular arrays formed on the surface of the sample holder. The PCR instrument also includes a sample block 114 for holding or maintaining a plurality of samples and a thermal block 116 for heating and/or cooling the sample block 114 and the samples contained therein. Blocks 114 and 116 may be coupled or connected together to from an integral block or sample block assembly 114.

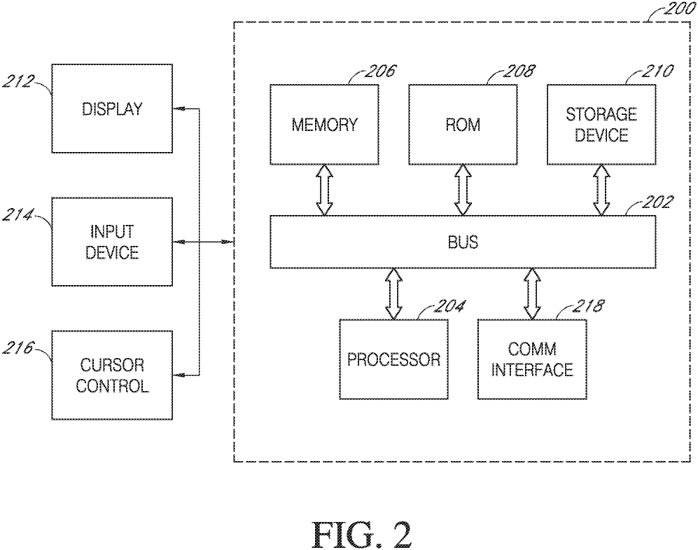

Real-time PCR instrument 100 has an optical system 124. In FIG. 1, the optical system 124 may have an illumination source (not shown) that emits electromagnetic energy, an optical sensor, detector, or imager (not shown), for receiving electromagnetic energy from samples 112 in a sample holder, and optics 140 used to guide the electromagnetic energy from each DNA sample to the imager. For embodiments of PCR instrument / real-time PCR instrument 100 in FIG. 1, control system 120 may be used to control the functions of the detection system, heated cover, and thermal block. Control system 120 may be accessible to an end user through user interface 122 of PCR instrument / real-time PCR instrument 100 in FIG. 1. Also, a computer system 100, as depicted in FIG. 2, may serve as to provide the control the function of PCR instrument 100 in FIG. 1, as well as the user interface function. Additionally, computer system 200 of FIG. 2 may provide data processing, display and report preparation functions. All such instrument control functions may be dedicated locally to the PCR instrument, or computer system 200 of FIG. 2 may provide remote control of part or all of the control, analysis, and reporting functions, as will be discussed in more detail subsequently.

### Computer-Implemented System

Methods in accordance with embodiments described herein may be implemented using a computer system.

Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on non-transitory computer-readable media. Some other processes can be implemented using analog circuitry, as is well known to one of ordinary skill in the art. Additionally, memory or other storage, as well as communication components, may be employed in embodiments of the invention.

FIG. 2 shows a block diagram that illustrates a computer system 200 that may be employed to carry out processing functionality, according to various embodiments. Instruments to perform experiments may be connected to the exemplary computing system 200. Computing system 200 can include one or more processors, such as a processor 204. Processor 204 can be implemented using a general or special purpose processing engine such as, for example, a microprocessor, controller or other control logic. In this example, processor 204 is connected to a bus 202 or other communication medium.

Further, it should be appreciated that a computing system 200 of FIG. 2 may be embodied in any of a number of forms, such as a rack-mounted computer, mainframe, supercomputer, server, client, a desktop computer, a laptop computer, a tablet computer, hand-held computing device (e.g., PDA, cell phone, smart phone, palmtop, etc.), cluster grid, netbook, embedded systems, or any other type of special or general purpose computing device as may be desirable or appropriate for a given application or environment. Additionally, a computing system 200 can include a conventional network system including a client/server environment and one or more database servers, or integration with LIS/LIMS infrastructure. A number of conventional network systems, including a local area network (LAN) or a wide area network (WAN), and including wireless and/or wired components, are known in the art. Additionally, client/server environments, database servers, and networks are well documented in the art. According to various embodiments described herein, computing system 200 may be configured to connect to one or more servers in a distributed network. Computing system 200 may receive information or updates from the distributed network. Computing system 200 may also transmit information to be stored within the distributed network that may be accessed by other clients connected to the distributed network.

Computing system 200 may include bus 202 or other communication mechanism for communicating information, and processor 204 coupled with bus 202 for processing information.

Computing system 200 also includes a memory 206, which can be a random access memory (RAM) or other dynamic memory, coupled to bus 202 for storing instructions to be executed by processor 204. Memory 206 also may be used for storing temporary variables or other intermediate information during execution of instructions to be executed by processor 204. Computing system 200 further includes a read only memory (ROM) 208 or other static storage device coupled to bus 202 for storing static information and instructions for processor 204.

Computing system 200 may also include a storage device 210, such as a magnetic disk, optical disk, or solid state drive (SSD) is provided and coupled to bus 202 for storing information and instructions. Storage device 210 may include a media drive and a removable storage interface. A media drive may include a drive or other mechanism to support fixed or removable storage media, such as a hard disk drive, a floppy disk drive, a magnetic tape drive, an optical disk drive, a CD or DVD drive (R or RW), flash drive, or other removable or fixed media drive. As these examples illustrate, the storage media may include a computer-readable storage medium having stored therein particular computer software, instructions, or data.

In alternative embodiments, storage device 210 may include other similar instrumentalities for allowing computer programs or other instructions or data to be loaded into computing system 200. Such instrumentalities may include, for example, a removable storage unit and an interface, such as a program cartridge and cartridge interface, a removable memory (for example, a flash memory or other removable memory module) and memory slot, and other removable storage units and interfaces that allow software and data to be transferred from the storage device 210 to computing system 200.

Computing system 200 can also include a communications interface 218. Communications interface 218 can be used to allow software and data to be transferred between computing system 200 and external devices. Examples of communications interface 218 can include a modem, a network interface (such as an Ethernet or other NIC card), a communications port (such as for example, a USB port, a RS-232C serial port), a PCMCIA slot and card, Bluetooth, etc. Software and data transferred via communications interface 218 are in the form of signals that can be electronic, electromagnetic, optical or other signals capable of being received by communications interface 218. These signals may be transmitted and received by communications interface 218 via a channel such as a wireless medium, wire or cable, fiber optics, or other communications medium. Some examples of a channel include a phone line, a cellular phone link, an RF link, a network interface, a local or wide area network, and other communications channels.

Computing system 200 may be coupled via bus 202 to a display 212, such as a cathode ray tube (CRT) or liquid crystal display (LCD), for displaying information to a computer user. An input device 214, including alphanumeric and other keys, is coupled to bus 202 for communicating information and command selections to processor 204, for example. An input device may also be a display, such as an LCD display, configured with touchscreen input capabilities. Another type of user input device is cursor control 216, such as a mouse, a trackball or cursor direction keys for communicating direction information and command selections to processor 204 and for controlling cursor movement on display 212. This input device typically has two degrees of freedom in two axes, a first axis (e.g. x-axis) and a second axis (e.g. y-axis), that allows the device to specify positions in a plane. Computing system 200 provides data processing and provides a level of confidence for such data. Consistent with certain implementations of embodiments of the present teachings, data processing and confidence values are provided by computing system 200 in response to processor 204 executing one or more sequences of one or more instructions contained in memory 206. Such instructions may be read into memory 206 from another computer-readable medium, such as storage device 210. Execution of the sequences of instructions contained in memory 206 causes processor 204 to perform the process states described herein. Alternatively hard-wired circuitry may be used in place of or in combination with software instructions to implement embodiments of the present teachings. Thus implementations of embodiments of the present teachings are not limited to any specific combination of hardware circuitry and software.

The term “computer-readable medium” and “computer program product” as used herein generally refers to any media that is involved in providing one or more sequences or one or more instructions to processor 204 for execution. Such instructions, generally referred to as “computer program code” (which may be grouped in the form of computer programs or other groupings), when executed, enable the computing system 200 to perform features or functions of embodiments of the present invention. These and other forms of non-transitory computer-readable media may take many forms, including but not limited to, non-volatile media, volatile media, and transmission media. Non-volatile media includes, for example, solid state, optical or magnetic disks, such as storage device 210. Volatile media includes dynamic memory, such as memory 206. Transmission media includes coaxial cables, copper wire, and fiber optics, including the wires that comprise bus 202.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 204 for execution. For example, the instructions may initially be carried on magnetic disk of a remote computer. The remote computer can load the instructions into its dynamic memory and send the instructions over a telephone line using a modem. A modem local to computing system 200 can receive the data on the telephone line and use an infra-red transmitter to convert the data to an infra-red signal. An infra-red detector coupled to bus 202 can receive the data carried in the infra-red signal and place the data on bus 202. Bus 202 carries the data to memory 206, from which processor 204 retrieves and executes the instructions. The instructions received by memory 206 may optionally be stored on storage device 210 either before or after execution by processor 204.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

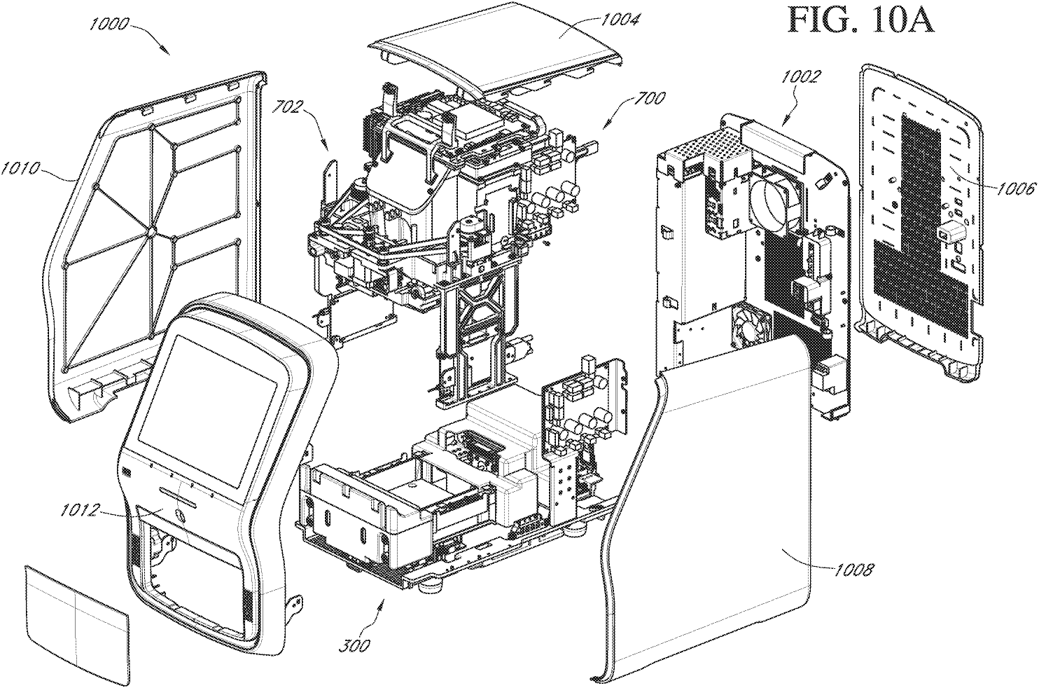

FIG. 10A shows an exploded perspective view of a biological analysis system or instrument 1000 according to an example embodiment. FIG. 10B shows an assembled perspective view of the system 1000 of FIG. 10A. The system 1000 may include a baseplate, frame, or support structure 301 and a housing, enclosure, or case 1001 that is used to house, isolate, and/or protect the various components, assemblies, and subassemblies of the system 1000. System 1000 may further comprise a frame 704, which may be attached, secured, coupled to and/or supported by support structure 301. As discussed herein, the system or instrument 1000 comprises elements and systems pertaining to a qPCR system or instrument. However, the scope of the various embodiment disclose herein may cover other types of systems or instruments, such as other types of biological analysis systems or instruments, such as those listed above herein.

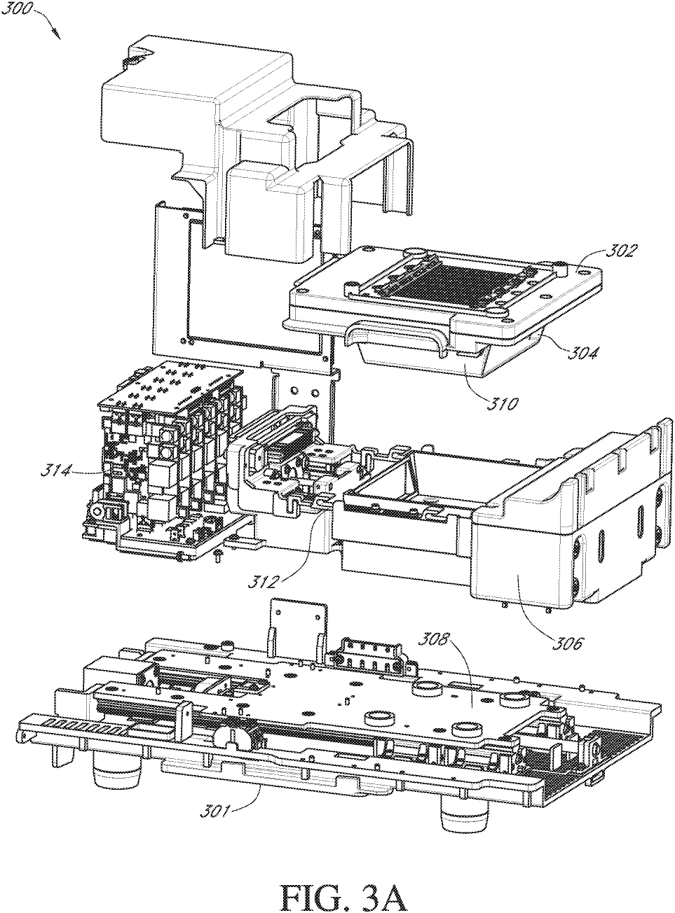

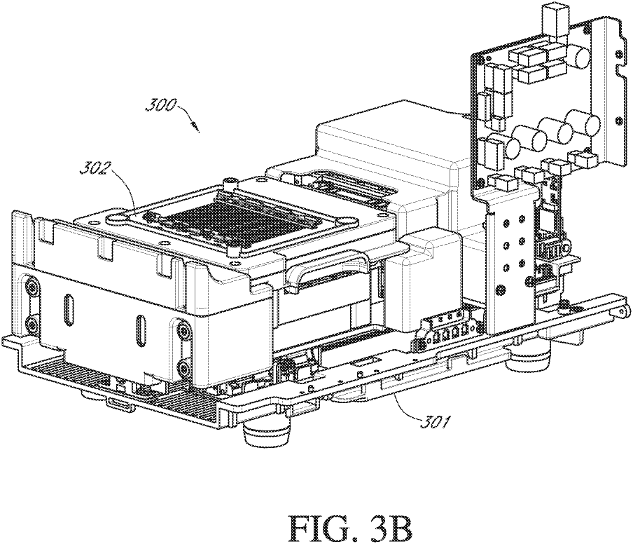

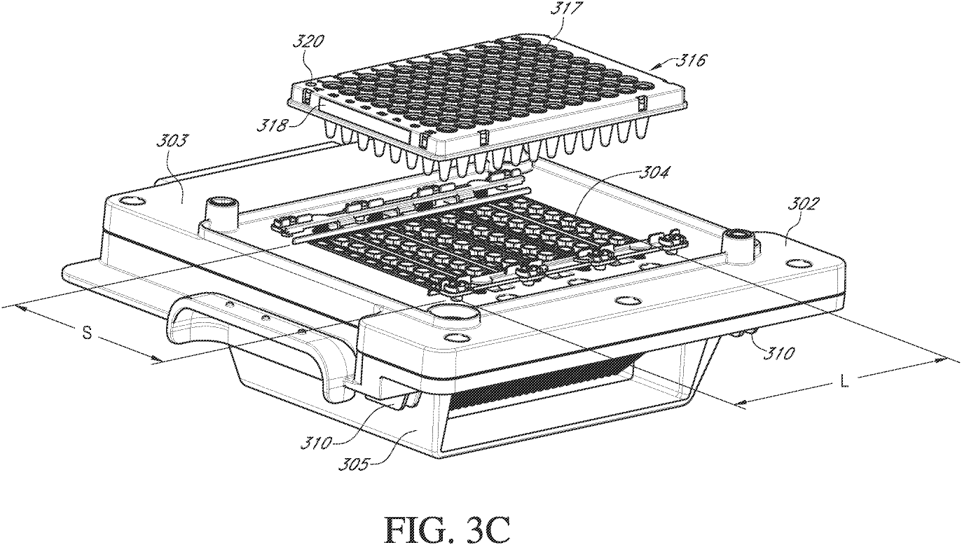

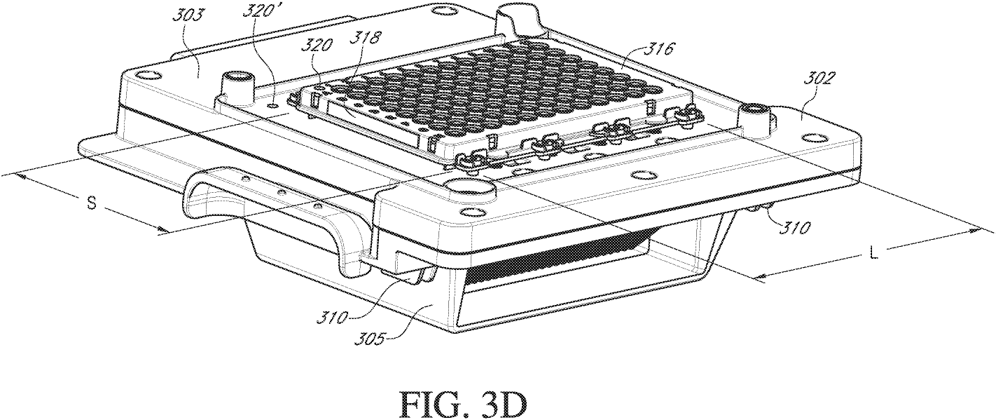

Referring to FIGS. 3A and 3B, the system 1000 may comprise a block assembly 300. FIG. 3A shows an exploded perspective view of the block assembly 300 according to an example embodiment. FIG. 3B shows an assembled perspective view of the block assembly 300 of FIG. 3A. With additional reference to FIGS. 3C and 3D, the block assembly 300 includes a sample block or block 302 comprising an upper surface 303 and a plurality of vessel or sample well or receiving elements 304. The receiving elements may be disposed within a rectangular area having a long side having a dimension “L” and a short side having a dimension “S” that is less than the dimension L, for example, when the sample block 302 is configured to receive a standard 96-well or 384-well microtiter plate. The sample block 302 may comprise a thermal block 305 that is mounted to, and in thermal contact with, the upper portion of sample block 302, which is configured to receive a sample holder or carrier. The thermal block 305 may comprise one or more elements for heating and/or cooling (not shown), such as thermoelectric elements, one or more thermal or heat sinks, one or more heat exchangers or fins, and/or one or more fans. The sample block 302 may be disposed in or on a movable support or base 308, which may include a carrier, base, or tray 306 configured to support, hold, or lock the sample block 302. The carrier 306 may be a separate component that is attached to moveable base 308 or may be integrally formed with moveable base 308.

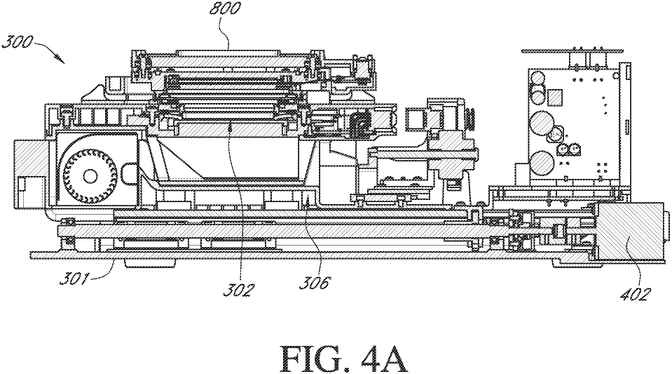

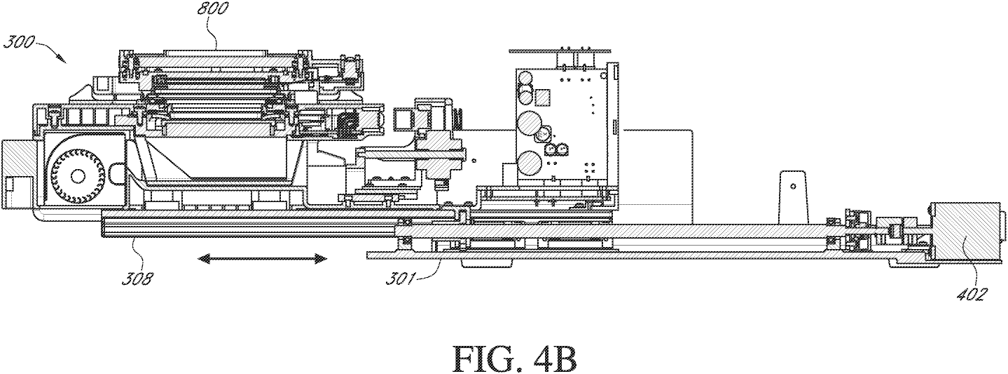

Still referring to FIGS. 3A-3D, and additional reference to FIGS. 4A and 4B, the sample block 302 may be configured to receive a sample holder 316. The sample holder 316 may comprise a plurality of reaction sites or reaction regions 317. The sample holder 316 in the illustrated embodiment comprises a microtiter plate including 96 reaction sites 317 in the form 96 wells. Alternatively, the sample holder may comprise a microtiter plate including 4, 12, 24, 48, 96, 192, 384, 768, 1536, 3072, 6144, 12288, or more wells or other types of sample retainment regions. In certain embodiments, the sample holder 316 comprises card including 384 chambers or wells that are loaded via a plurality of channels into the chambers or wells, for example, a TaqMan Array card (TAC) produced by Thermo Fisher Scientific. Additionally or alternatively, the sample holder 316 comprises reaction regions 317 in the form of a plurality of reaction volume in a fluidics card, through-holes in a plate or chip, surface indentations or other discontinuities or a surface, or the like. In other embodiments, sample holder 316 may comprise one or more linear strips of reaction sites, a plurality of individual vials, a sample card, a microfluidics card, a through-hole array, or the like. The reactions sites 317 may alternatively comprise a plurality of through-holes or other formats discussed above herein. In certain embodiments, the block assembly 300 may also include a cover 800, which may be configured cover sample holder 316 and/or to protect and/or provide optical access to reaction sites 317. In the illustrated embodiments, cover 800 is a heated cover 800 that is configured to heat the top of sample holder 316, the top of the thermal block 302, and/or a volume above the sample holder 316 and/or thermal block 302. Alternatively, cover 800 may be a non-heated cover, for example, a cover plate to protect the content of sample holder 316, a plate with openings to provide optical access to reaction sites 317, and/or a lenslet array configured to focus light into or onto the reaction sites 317.

In certain embodiments, the sample block 302 may be located on or in a moveable base 308 configured to move or transport sample block 302 from a location inside the housing 1001 to a position suitable, for example along a horizontal axis as illustrated by the double arrow line in FIG. 4B. The moveable base 308 may be configured to move or transport sample block 302 along with the sample holder 316, when present, from a location inside the housing 1001 to a location completely or partially outside the housing 1001, for example, for exchanging the sample block 302 for a different sample block 302 (e.g., having a different format and/or reaction site density) and/or for exchanging the sample holder 316 for a different sample holder 316 (e.g., having different samples or number of reaction sites).

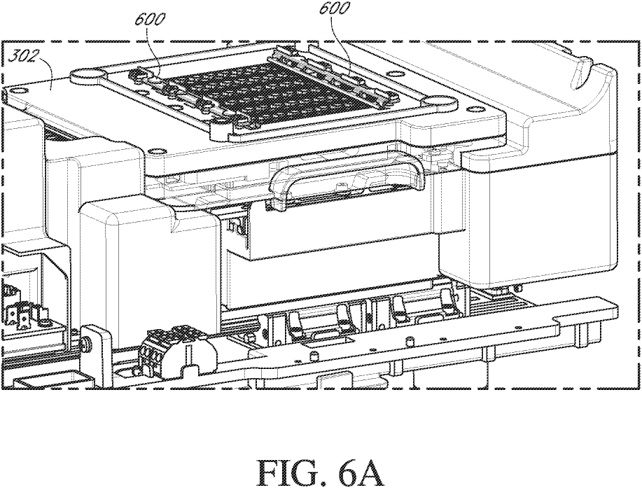

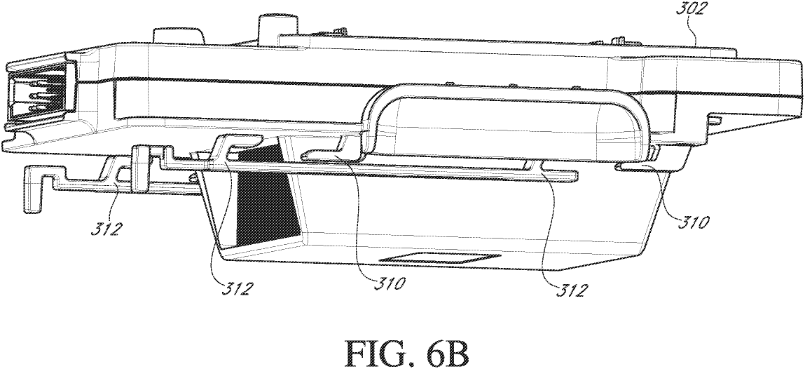

With additional reference to FIGS. 6A and 6B, sample block 302 may include at least one lock member 310, and the carrier, base, or tray 306 may include at least one corresponding lock member 312. The lock members 310, 312 are preferably configured to engage with each other to prevent removal from the carrier 306. Additionally or alternatively, lock members 310, 312 may be configured to register and/or align sample block 302 to carrier 306. In the illustrated embodiment, lock member 310 comprises a rail member 310a and a pair of two latch members 310b attached to or integral with rail member 310a. Alternatively, lock member 310 may comprises a single latch member 310b or three or more latch members 310b. In the illustrated embodiment, the lock member 312 comprises a rail member 312a and a pair of two latch members 312b attached to or integral with rail member 312a, wherein each latch member 312b is configured to slide over and/or interlock with a respective latch member 310b. Alternatively, lock member 312 may comprises a single latch member 312b or three or more latch members 312b. As seen in the illustrated embodiment, sample block 302 preferably comprises two lock members 310 located on opposites sides of the sample block 302, while carrier 306 comprises two corresponding lock members 312 located on opposites sides of carrier 306. In certain embodiments, sample block 302 comprises a single lock member 310 located on one side of the sample block 302, while carrier 306 comprises a corresponding lock members 312 located on same side of carrier 306. As discussed further herein, the lock members 310, 312 may be controlled by a controller to be in either a locked configuration, for example when sample holder 316 is being exchanged, or unlocked configuration, for example when the sample block 302 and/or a mating heated cover (e.g., cover 800) are being exchanged. heated cover 800

The sample holder 316 may additionally comprise a sample holder radio-frequency identification (RFID) tag 318 containing information or data regarding the sample holder 316, reagents, dyes, or other chemistry contained in or on the sample holder 316, history of sample holder use, assay parameters or instructions, and/or the like. In certain embodiments, the sample block 302 and/or sample holder 316 comprise a sensor 320 and/or 320′ in communication with the sample holder RFID tag 318. Additionally or alternatively, the sensor 320′ may be located on the thermal block 305.

As seen in FIG. 10B, in some embodiments, system 1000 may optionally include at least one reagent container 1030 comprising a reagent container RFID tag 1032. The content of the reagent container 1030 may added to at least some of the reaction sites 317 in preparation to conduct an assay.

FIG. 4A shows a cross-sectional view of the block assembly 300 of FIGS. 3A-3B in a closed position or configuration (e.g., withdrawn or engaged) according to an example embodiment. When the block assembly 300 is in the closed position, the sample block 302 and cover or heated cover 800 are in position for performing an assay on the sample holder 316. FIG. 4B shows a cross-sectional view of the block assembly 300 in an open position or configuration (e.g., extended or disengaged). In certain embodiments, when the block assembly 300 is in the open position, the sample holder 316 may be exchanged for a different sample holder 316; however, the sample block 302 remains locked to the carrier 306 and the cover 800 is held by the cover carrier 710 and remains inside the housing 1001 of the system 1000. In an alternative embodiment, when the block assembly 300 is in the open position, the sample block 302 and the heated cover 800 are disengaged from their respective carriers and, therefore, the sample holder 316, the sample block 302, and the heated cover 800 are all available for exchange. In one embodiment, a driver, actuator, or drive mechanism 402, e.g., in the form of a stepper motor and worm gear, can operate to drive the movable base 308 and the carrier, base, or tray 306, and sample block 302 mounted thereon, to slide back and forth relative to the support structure 301 by one or more predetermined distances between the opened and closed positions. A controller may be used to automatically operate the drive mechanism. At least one sensor may be used to detect the position of the block assembly 300 to provide feedback to the drive mechanism 402. In the open position, the sample block 302 may be placed onto or removed from the carrier 306, thereby allowing one sample block to be replaced or exchanged for another sample block have a different construction and/or configured to accommodate a different type of sample holder while the system 1000 is still powered up (e.g., while power is still being supplied to the current sample block 302 and/or the heated cover 800). In the closed position, normal operations involving the sample block 302 may be carried out.

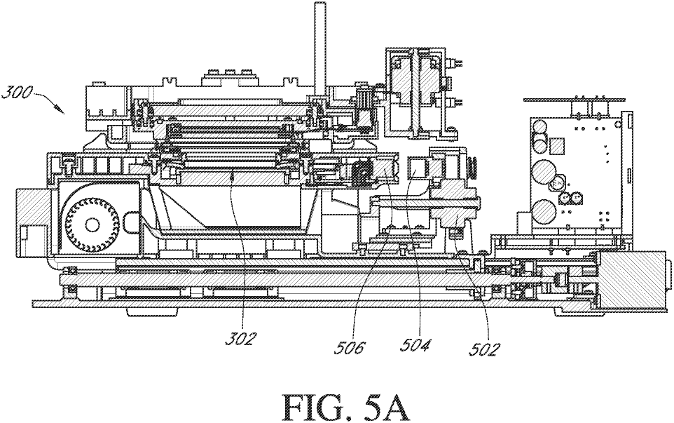

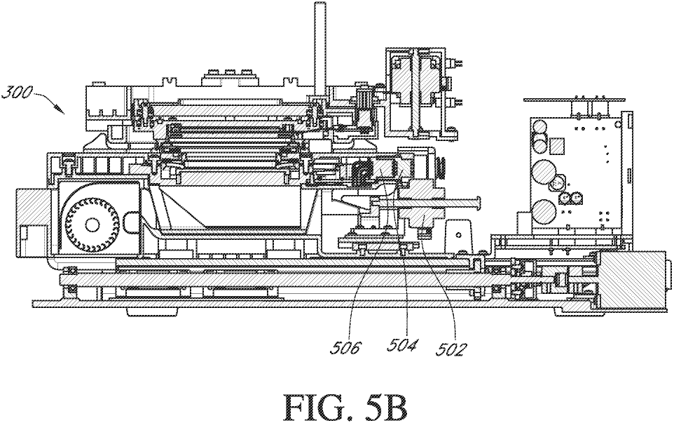

FIG. 5A shows a cross-sectional view of the block assembly 300 of FIGS. 3A-3B having the sample block 302 disengaged with the movable base 308 according to an example embodiment. FIG. 5B shows a cross-sectional view of the block assembly 300 having the sample block 302 engaged with the movable base 308. For example, a driver, actuator, or drive mechanism 502, e.g. in the form of a can-stack linear actuator, can drive a first connector member 504 (e.g. a female connector) linked to the movable base 308 back and forth horizontally to engage/disengage with a second connector member 506 linked to the sample block 302. When the first and second connector members 504, 506 engage with each other, movement of the sample block 302 relative to the movable base 308 is prevented or minimised.

To further positionally secure the sample block 302 relative to the base and prevent dislodgement of the sample block 302 during operation, additional locking features are provided in the example embodiments as described above with reference to FIGS. 3A-D and also shown in FIGS. 6A-B. In one implementation, as the drive mechanism 502 (see FIGS. 5A-5B) moves the first connector member 504 (see FIGS. 5A-5B) toward the second connector member 506 (see FIGS. 5A-5B), the lock members 310, 312 engage with each other. Together with the connector members 504, 506, the lock members 310, 312 help to secure the sample block 302 in position.

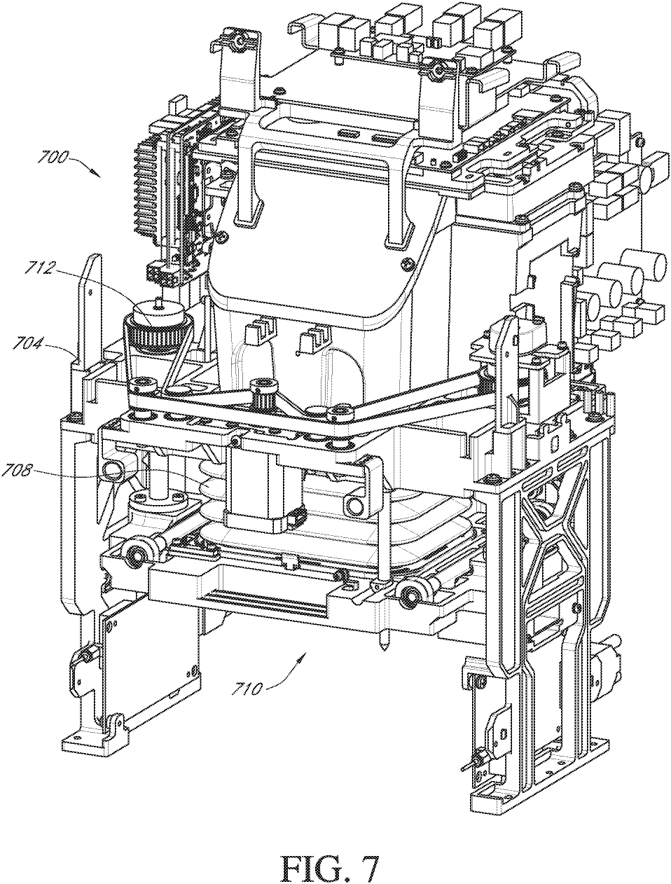

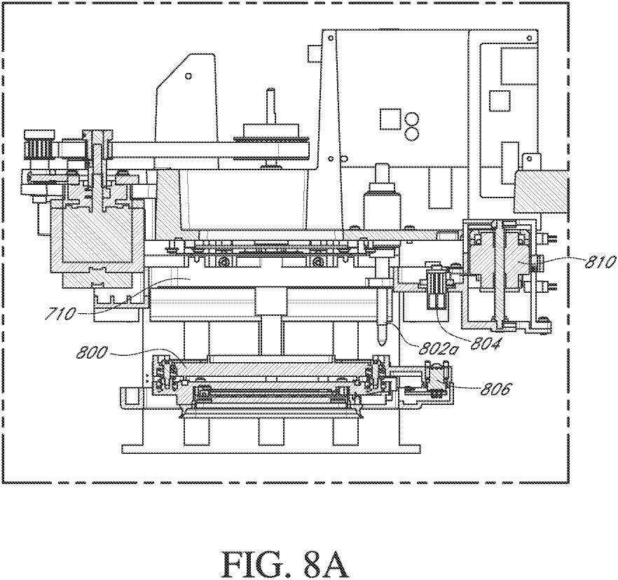

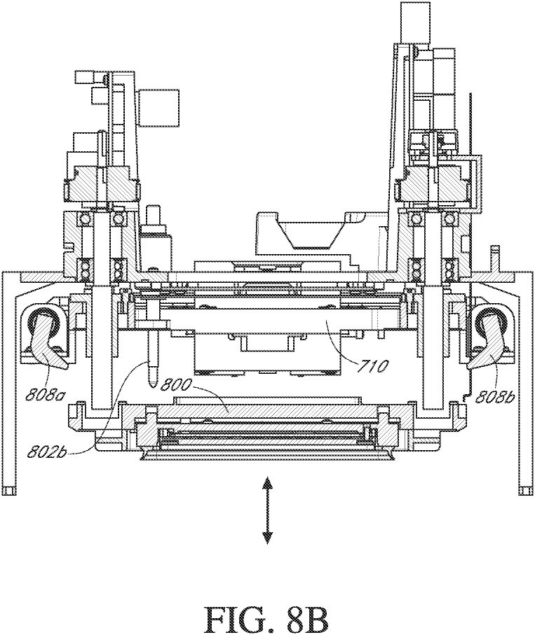

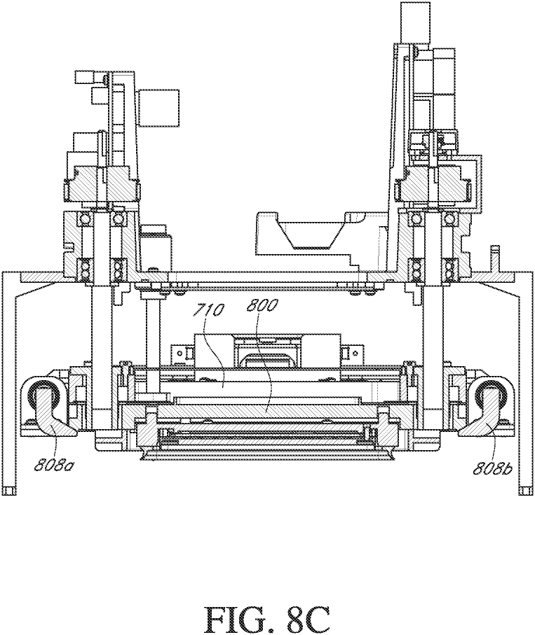

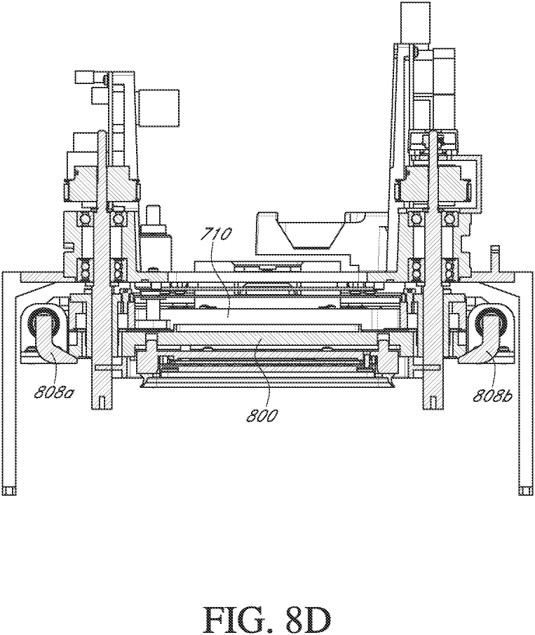

FIG. 7 shows a perspective view of an optics module or assembly 700 and a cover carrier 710 according to an example embodiment. The cover carrier 710 and/or the optics assembly 700 may be attached to and/or supported by the frame 704. An extendable bellow 708 is disposed between the optics assembly 700 and the cover carrier 710. For example, the bellow 708 is connected to the optics assembly 700 at one end and to a cover carrier 710 at the other end. A driver, actuator, or drive mechanism 712 is configured to move the cover carrier 710 vertically up and down, as will be described in further details below with reference to FIGS. 8A-8D.

As the cover carrier 710 is lowered, the bellow 708 extends, and as the cover carrier 710 is raised, the bellow 708 collapses. Bellow 708 provides an enclosure between the top of the cover carrier 710 and the optics module 700 so that when the cover carrier is in the extended, lowered position, the bellow 708 provides optical isolation from stay light from outside sources that might otherwise introduce noise at the optical sensor during an assay. Advantageously, the bellow 708 facilitates the disclosed configuration which allows the heavier sample block 302 to be translated in a horizontal axis for placement or exchange of the sample holder and/or sample block, while the lighter heated cover may be translated in an orthogonal axis for engagement in preparation for and during a run or assay using the system 1000. As seen in FIG. 10A, the frame 704, including the optics assembly 700 and the cover carrier 710 may be attached or mounted to the support structure 301 used to hold and transport the thermal block assembly 300. This provides two separate, single-axis translation systems (one for transporting the thermal block assembly 300 and the other to place the cover 800 over the thermal block assembly 300). It has been found that this arrangement provides more accurate alignment of the cover 800 to the reaction sites 317 of sample holder 316 than a more complex system comprising a dual-axis arrangement.

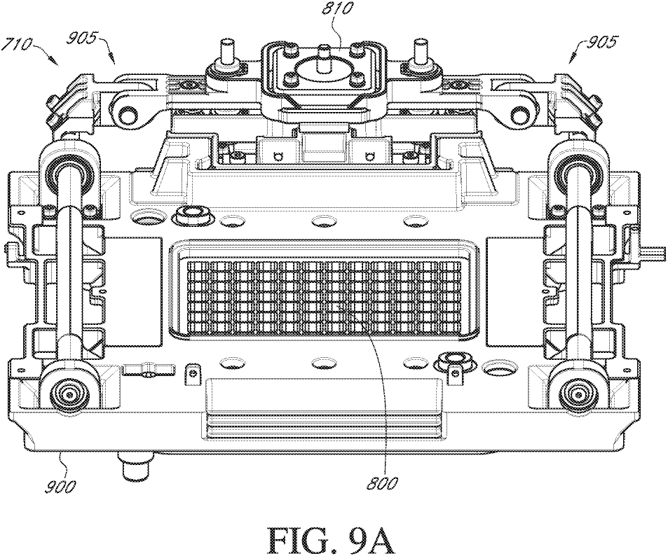

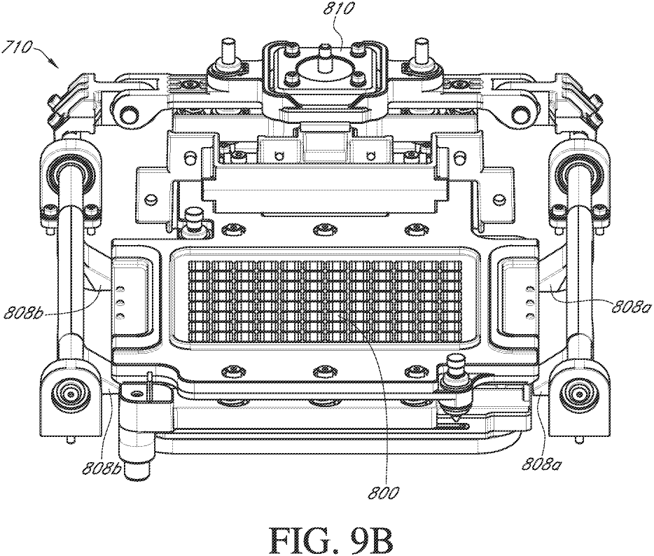

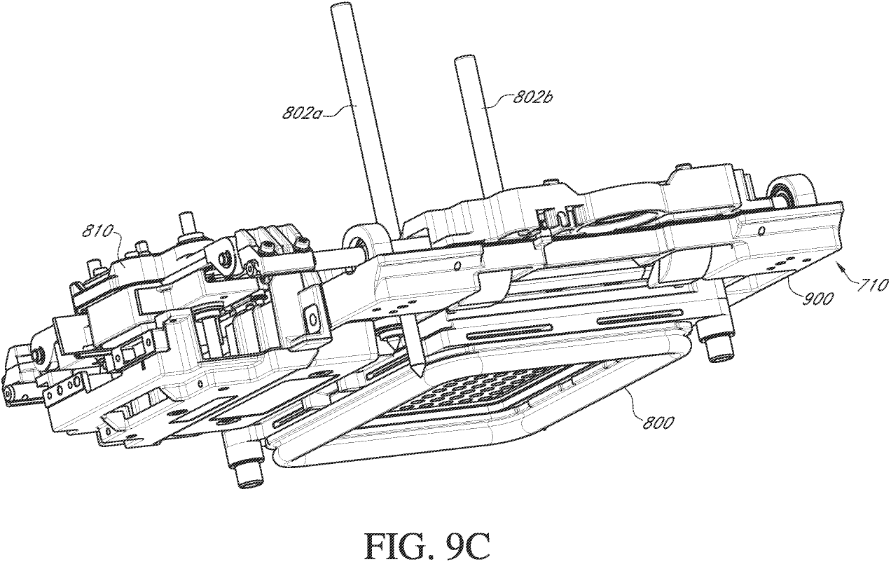

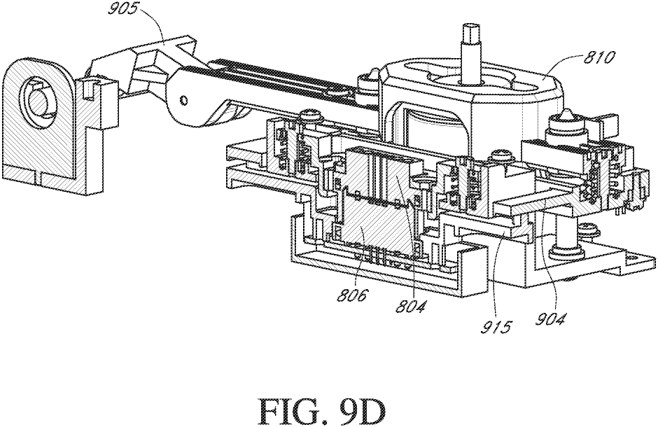

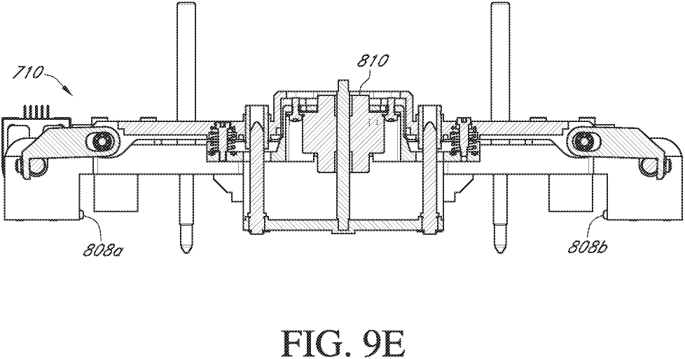

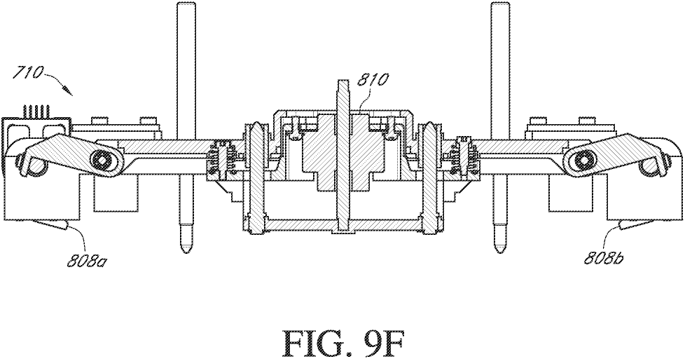

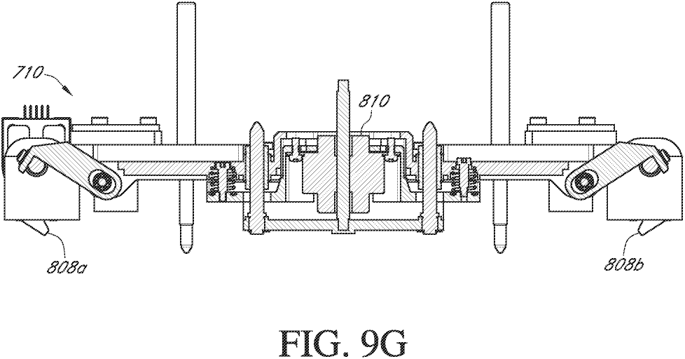

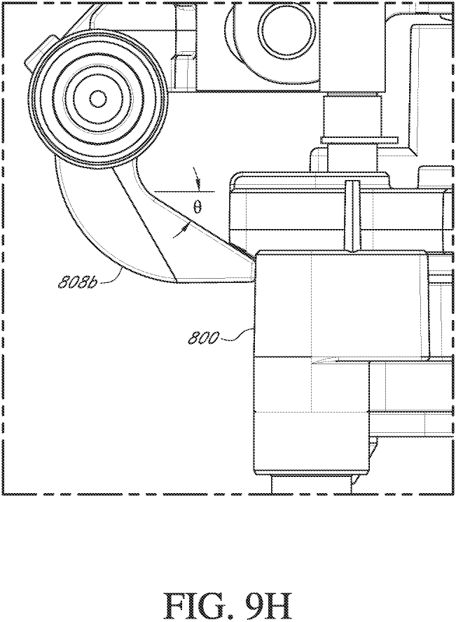

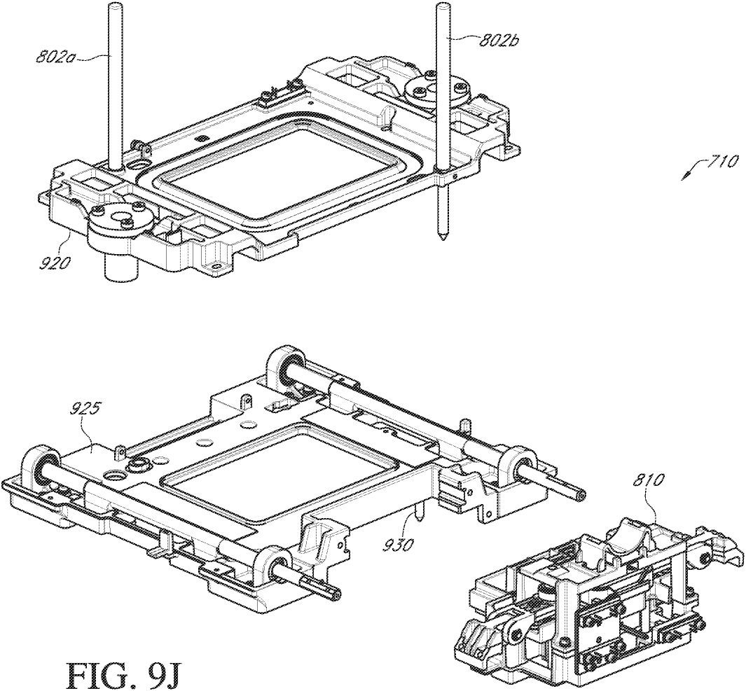

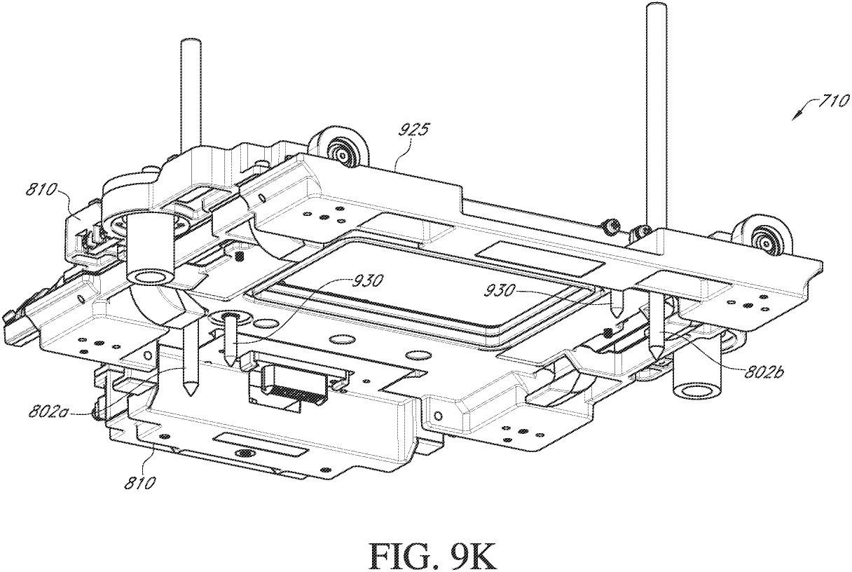

FIGS. 8A-8D show cross-sectional views illustrating an operation of the cover carrier 710 according to an example embodiment. FIGS. 8A-8B show alternative cross-sectional views as the cover carrier 710 is being lowered onto a heated cover 800 disposed on a block assembly (not shown), such as the block assembly 300 discussed above. In one implementation, the cover carrier 710 includes a plurality alignment pins 802a, 802b (typically at least 2 such alignment pins are used) to align or approximately align the cover carrier 710 with the heated cover 800. In particular, the alignment pins 802a, 802b help to ensure alignment between a third connector member 804 on the cover carrier 710 with a fourth connector member 806 on the heated cover 800. Additionally or alternatively, alignment pins 802a, 802b are used to register or align a sample block 302 to the cover carrier 710. The certain embodiments, upper portions of align pins 802a, 802b are inserted into corresponding through-holes or cylinders of system 1000 to register or align the cover carrier 710 and the sample block 302 to the system 1000 (e.g., to the optical assembly 700). Connector members 804, 806 may include electrical contact to provide electrical communication and/or power to heated cover 800. The cover carrier 710 also includes a gripper mechanism which includes gripper arms 808a, 808b driven by a driver, actuator, or drive mechanism 810. As the cover carrier 710 moves down towards the heated cover 800, the gripper arms 808a, 808b are opened. As seen in FIG. 9B, there are two gripper arms 808a and two gripper arms 808b in the illustrated embodiment. In other embodiments there may be one, three, or more gripper arms 808a, 808b.

FIG. 8C shows a cross-sectional view as the cover carrier 710 is in contact with the heated cover 800. At this point, the third connector member 806 engages with the fourth connector member 808 (not shown in FIG. 8C). Further, the gripper arms 808a, 808b are actuated to close and generate an active clamping force onto the heated cover 800 to securely grip the heated cover 800. Accordingly, the heated cover 800 is fully engaged with the cover carrier 710 by way of both the connector members 804, 806 and the gripper arms 808a, 808b. From this state, the drive mechanism 712 can move both the cover carrier 710 and the engaged heated cover 800 upward to a raised position as shown in FIG. 8D.

FIGS. 9A-9K show various views of the cover carrier 710, drive mechanism 810, and gripper arms 804, 806. Referring to FIGS. 9A-9C, the cover carrier 710 comprise a carrier plate 900 that mates with a top surface of the heated cover 800 and the drive mechanism 810, which is configured to rotate gripper arms 808 through a linkage 905. FIG. 9A shows a partial cross-sectional view of the drive mechanism 810 according to an example embodiment. The drive mechanism 810 can control movement of the gripper arms 808a, 808b via respective linkages, with linkage 905being shown in FIG. 9. In addition, the drive mechanism can actuate an ejection bar 910 to exert a downward force onto and a corresponding part 915. The part 915 is connected to the fourth connector member 806. Accordingly, the drive mechanism 810 can disengage the third and fourth connector members 804, 806 while opening the gripper arms 808a, 808b to thereby disengage the heated cover 800 from the cover carrier 710. In certain embodiments, the carrier plate 900 comprises the ejector bar 910, which may be coupled to the carrier plate 900 (e.g., using an adhesive, bolt, fastener, or the like) be part of a unitary structure with the carrier place 900. Additionally or alternatively, the third and fourth connector members 804, 806 may be disengaged by using the driver mechanism 712, for example, by separating the cover carrier 710 from the heated cover 800, which may be accomplished by lifting the cover carrier 710 away from the heated cover 800.

FIGS. 9E-9H illustrate a preferred embodiment of operation of the drive mechanism 810. The mating heated cover 800 is not shown for simplicity. FIG. 9E shows a first configuration of the drive mechanism 810 and cover carrier 710 in which the gripper arms 808a, 808b are in a closed position suitable for holding the heated cover 800, for example, during an assay or biological test. FIG. 9F show a second configuration of the drive mechanism 810 and cover carrier 710 in which the drive mechanism 810 is lower relative to the axis of rotation of the gripper arms 808a, 808b. As a result of this relative motion, the gripper arms 808a, 808b are now in an open position suitable for release of the heated cover 800, for example, in preparation for exchanging the heated cover 800 and/or the sample block 302 for a different heated cover 800 and/or the sample block 302 (e.g., exchanging the 96 well format heated cover 800 and the sample block 302 for a 384 well or 384 array card format heated cover 800 and the sample block 302). FIG. 9G show a third configuration of the drive mechanism 810 and cover carrier 710 in which the drive mechanism 810 is lowered even further relative to the axis of rotation of the gripper arms 808a, 808b. As a result of this relative motion, the gripper arms 808a, 808b may now extended beyond the open position in the second configuration. The movement between the second configuration and the third configuration the actuation of the ejection bar 910 to exert a downward force so as to disengage the third and fourth connector members 804, 806, as described above.

With further reference to FIG. 9H, it has been discovered that by proper design of the interface between heated cover 800 and the gripper arms 808, the heated cover 800 can be more accurately aligned to the optical assembly 700. For example, it has been found that a sloped interface angle, θ, may be selected to provide a desirable lateral accuracy or repeatability in the location in X and Y axes of a plane parallel to the upper surface 303. That is, the sample block 302 may be removed from the system 1000, then later be placed back into the system 1000, with an accuracy or repeatability that is within a predetermined range. For example, in a preferred embodiment, it has been found that sloped interface angle, θ, from 30 degrees to 50 degrees provides a lateral accuracy or repeatability that is less than or equal to 200 micrometers. For an optical system with a 20x demagnification, this is equivalent to an accuracy or repeatability at the imaging sensor of 10 micrometers. In another preferred embodiment, it has been found that sloped interface angle, θ, from 30 degrees to 50 degrees provides a lateral accuracy or repeatability that is less than or equal to 100 micrometers.

With further reference to FIGS. 9J-K, it has been discovered that initial alignment of cover carrier 710 to the optical assembly 700 and to the block assembly 300 is critical. For example, in certain embodiments, the cover 800 includes a lenslet array that focuses excitation light or electromagnetic radiation from an excitation source into each reaction site 317 of a sample holder 316. The lateral positioning of the lenslet array in two axes in a horizontal plane determine where the focus of each lenslet is positioned within a corresponding reaction region 317. To facilitate initial alignment of the lenslet array to the block assembly 300 and/or sample blocks 300, the cover carrier 710 may comprise an upper plate or assembly 920 and a lower plate or assembly 925. During installation and/or alignment of cover carrier 710 into the system 1000, the upper plate 920 may be mounted or fixed to a frame of system 1000 (e.g., to the optical assembly 700). The lower plate 925, to which the heated cover 800 is mounted or engage with during use, is moveably mounted or attached to upper plate 920. The lower plate 925 may then be moved in a horizontal direction in one or two axes, for example while a heated cover 800 or a substitute thereof, to position the lower plate to a location such that light or radiation from the excitation source is properly located within the wells or reaction sites 317 of a sample holder 316. Once the lenslet array of the heated cover 800 is aligned to the wells or reaction sites 317, the lower plate may be locked or fixed to the upper plate.

In certain embodiments, lower plate 925 comprises at least two alignment pins 930, which are used to register or align a heated cover 800 to the lower plate. As discussed above, upper portions of align pins 802a, 802b are inserted into corresponding through-holes or cylinders of system 1000 to register or align the cover carrier 710 (more specifically the upper plate 920) to the system 1000 (e.g., to the optical assembly 700). Additionally or alternatively, alignment pins 802a, 802b are used to register or align a sample block 302 upper plate 920 and, as a consequence, to the system 1000. Lower plate 925 are used to adjust the alignment lenslet array of the heated cover 800 to the wells or reaction regions of a sample block 302, as discussed above. In this way, the pins 802a, 802b are used to approximately align the lenslet array to the wells or reaction regions of the sample block 302 and the adjustable lower plate is used to provide a more accurate or precise alignment of the lenslet array to the wells or reaction regions of the sample block 302.

The system according to the present teachings can perform automated operations to install and replace/remove the sample block 302 and heated cover 800 as necessary. Some examples are now described with reference to FIGS. 3-9.

In one example to install the sample block 302 and heated cover 800, the block assembly 300 is initially at the open position when a user initiates the installation sequence. Depending on the configuration, the heated cover 800 may already be placed onto the sample block 302 beforehand, or they can be put together in situ. Alignment features can help to position the heated cover 800 correctly relative to the sample block 302. One or more sensors may also be used to determine the presence and/or orientation of the heated cover 800 on top of the sample block 302. The sample block 302 together with the heated cover 800 thereon is then placed into the carrier, base, or tray 306 of the block assembly 300.

It will be appreciated that the above steps can be performed by a human operator, or alternatively, by an articulated arm. In the latter case, the articulated arm may be remotely controlled by a human operator or may be programmed to perform the tasks autonomously.

Once the system can confirm the presence of the sample block 302 and heated cover 800, the remaining steps of the installation sequence can be carried out automatically. For example, the drive mechanism 402 (see FIG. 4A) draws the block assembly 300 to the closed position. There, the drive mechanism 712 (see FIG. 7) moves the cover carrier 710 (see FIG. 7) down to engage with the heated cover 800. As the gripper arms 808a, 808b close onto the heated cover 800 and the cover carrier 710 exerts a clamping force onto the heated cover 800 which is mounted on the sample block 302, the sample block 302 is effectively immobilised at this time.

While the sample block 302 is held in position, the drive mechanism 502 (see FIG. 5A) moves the first connector member 504 to engage with the second connector member 506. The same movement causes the lock members 310, 312 to engage with each other. As a result, the sample block 302 is secured to the movable base 308.

After the engagement is completed, the drive mechanism 712 moves the cover carrier 710 in engagement with heated cover 800 to a raised position, ready for deployment. For example, the operator may start a PCR experiment, and the block assembly 300 may be extended to the open position for loading a sample holder and then drawn to the closed position, before the cover carrier 710 is lowered to begin thermal cycling.

In another example to remove the sample block 302 and heated cover 800, the block assembly 300 may is initially at the closed position and the heated cover 800 is at the raised position when the operator initiates the removal sequence. The system can automatically operate the drive mechanism 712 to lower the heated cover 800 onto the sample block 302. Once the heated cover 800 is detected to be on top of the sample block 302, the gripper arms 808a, 808b open to release the heated cover 800. In addition, the drive mechanism 810 (see FIG. 8) causes the ejection bar 910 to exert a downward force to disengage the third and fourth connector members 804, 806 from each other. The cover carrier 710, after being separated from the heated cover 800, can be drawn to the raised position.

Separately, the drive mechanism 502 automatically causes the first and second connector members 504, 506 to disengage from each other, and lock members 310, 312 to dislodge from each other. Accordingly, the sample block 302, having the heated cover 800 on top, is disengaged from the movable base 308, and the drive mechanism 402 can move the sample block 302 to the open position where both the sample block 302 and heated cover 800 can be retrieved/removed, for example, by a human operator or an articulated arm.

As seen in FIG. 3A system 1000 may also include electronic components 314, which may include or be part of one or more controllers configured to control movement and/or engagement of the various components of system 1000. For example, at least some of the electronics components 314 may be configured, alone or in conjunction with electronics of systems outside housing 1001 in communication with system 1000, to control the motion or engagement of any or all of sample block 302, the carrier 306, moveable base 308, connector members 504 and/or 506, cover 800, connectors 804 and/or 806, lock members 310 and/or 312, gripper arms 808a, b, cover carrier 710, bellows 708. For example, at least some of the electronics components 314 may be configured, alone or in conjunction with electronics of systems outside housing 1001 in communication with system 1000, to control the motion of the sample block 302 and/or movable base 308 relative to support structure 301, as illustrated in FIGS. 4A and 4B. Additionally or alternatively, electronic components 314 may be configured to move cover 800 and/or cover carrier 710 relative to sample holder 316 and/or sample block 302. In certain embodiments, electronic components 314 may be configured to operate lock members 312 to engage lock members 310 of the sample block 302, for example, to secure or lock the sample block 302 to the moveable base 308 or carrier 306. In certain embodiments, electronic components 314 may be configured to secure or lock cover 800 to cover carrier 710, for example, using gripper arms 808a and/or 808b, wherein the cover carrier 710 may be used to lift cover 800 off of the sample block 302 before moving the sample block outside housing 1001 to exchange or adjust the sample holder 316. Alternatively, the electronic components 314 may be configured to disengage

### System Integration

In addition to the block assembly 300, optics assembly 700 and cover carrier 710 as described above, the system 1000 also includes a back chassis assembly 1002 which can provide electrical and thermal management for the system 1000. As illustrated in FIGS. 10A and 10B, the housing 1001 may enclose any or all of block assembly 300, optics assembly 700, cover carrier 710, and/or back chassis assembly 1002. Housing 1001 may be formed by various member that are attached to one another, for example members 1004, 1006, 1008, 1010 together with front housing 1012 shown in FIG. 10B.

The front housing 1012 also include a drawer face 1014 and a door face 1015 disposed above the drawer face. During operation, the drawer face moves forward when the block assembly moves from the closed position to the open position. If only a sample holder 316 is to be inserted or exchanged, the door face 1015 remains stationary. If the sample block 302 and/or the heated cover 800 are being exchanged, the drawer face 1014 moves forward and the door face 1015 is flipped open from the top to allow passage of the heated cover 800. Alternatively, the door face 1015 may be raised up and/or retracted into the system 1000 during this operation to allow passage of the heated cover 800. As a safety or precautionary feature, the door face 1015 may be configured to move to an open position (e.g., flipped or raised) during start up of the system 1000. This preclude possible damage to the system 1000 if, for example, the block assembly 300 was in an open position during the most recent power down (either intentionally or accidentally, for example due to a power failure). In this case, no damage to the door face 1015 would occur during retraction of the block assembly 300 back into the housing 1001 to a closed position during or after start up of the system, since the door face 1015 would be opened or retracted.

The front housing 1012 includes several input/output features. A display screen 1016 capable of receiving touch input is mounted on the front housing 1012. In one implementation, the front housing 1012 comprises an image system 1017 comprising one or more cameras that may be configured to detect or identify the face of a perspective user of the system 1000. The image system 1017 may be configured to provide or produce one or more outputs if one or more predetermined criteria are met, for example, if the face of the perspective user matches that stored data of individuals authorized of use the system 1000 and/or have access to certain capabilities of the instrument or information stored in the system 1000 or in a database to which the system 1000 has access. In certain embodiments, the image system 1017 may comprise a 3-dimensional (3D) camera module 1017. The 3D camera module 1017 is capable of detecting facial expressions and body gestures, and may be equipped with facial recognition software to automatically recognise a face of a registered user. Additionally or alternatively, the image system 1017 may be located at other locations, such as in or one a top or side panel of the system 1000.

Alternatively or in addition, the system 1000 may comprise voice system 1018 comprising one or more microphones 1018, for example, mounted on the front housing 1012. The voice system 1018 may be equipped with voice recognition software to automatically recognise voice instructions from a registered user.

The system 1000 and/or the front housing 1012 may also have a proximity sensor 1020 to detect an object or individual, e.g. a user, at a predetermined distance to turn on the 3D camera module 1017 and activate the microphones 1018. The proximity sensor may by any of the proximity sensors, probe, or device known in the art. Accordingly, in some example embodiments, it is possible to operate the system 100 in hand-free mode, e.g. by a voice command or body gesture. In certain embodiments, an output from the proximity sensor 1012 may be used enable the imaging system 1017 and/or the voice system 1018. The proximity sensor 1012 may be utilized in an environment in which two or more instruments 1000 are located in the same in a laboratory or room. Additionally or alternatively, the output from the proximity sensor 1020 may be used to determine whether output from the imaging system 1017 and/or the voice system 1018 will be utilized for starting, powering up, or activating the system 1000 and/or allow access to certain capabilities of the instrument or information stored in the system 1000 or in a database to which the system 1000 has access.

In this manner, it may be determined which system 1000 a user having access to the two or more instruments 1000 is to respond to a voice command or a face recognition signal. For example, if the user provides a voice command to activate or start one of the instruments 1000, or to implement some function of the system 1000, only the system 1000 to which the user is in closest proximity will respond. In certain embodiments, several authorized uses may be in the same laboratory or room, and each system 1000 will respond to each user in accordance to their proximity to a respective one of the instruments. It is anticipated that such capabilities may be utilized in other types of biological analysis instruments or non-biological analysis instruments having capabilities and features different from those disclosed herein, but having a proximity sensor 1020 according to the embodiments discussed herein used in the manner just described.

A pair of speakers 1022 may also be mounted to the front housing 1012 to provide audio updates, warnings, etc. such that a human operator does not need to regularly look at the display screen 1016.

The system 1000 may also include several features to further enhance performance. With reference to FIGS. 3C, 3D and 6A, the block assembly 300 further includes at least one ejector member 600 configured to at least partially raise the sample holder 316 away from the sample block 302 when in the open position. This can prevent the sample holder from sticking to the sample block 302 (as is the case in some existing systems) and facilitate removal of the sample holder from the sample block 302 after an experiment, especially when the removal is performed by an articulated arm (i.e. a robot). The inventors discovered that manual and/or robotic removal of sample holder 316 is better facilitated when ejector members 600 are located along the long side for the sample holder 316 corresponding to the L dimension in FIG. 3, rather than on the short side corresponding to the S dimension. For example, after a PCR assay using the system 1000, the edges of the sample holder 316 bow downward toward the center. It has been discovered that the depth of the bowing is greater on the long side that the short side of the sample holder 316. By placing the ejector members 600 along the long side corresponding to the L dimension in FIG. 3C, the clearance between the edge of the sample holder 316 and the surface 303 of the sample block 302 is greater than when the ejector members 600 are place on the short side corresponding to the S dimension in FIG. 3C. This may be accounted since the depth of the bowing is less along the short side of the sample holder 316 and may also be account for in that the greater bowing on the long side will tend to project the sample holder 316 further away from the surface 303.

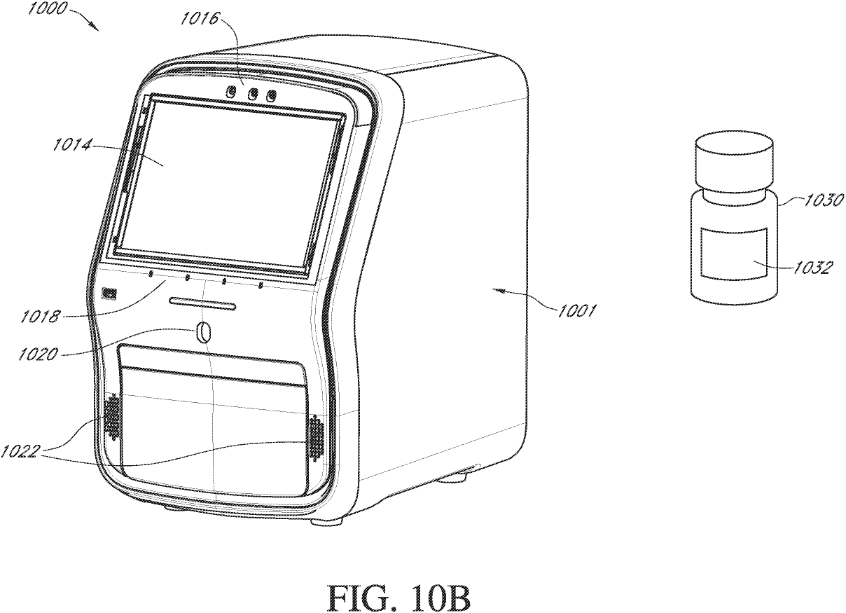

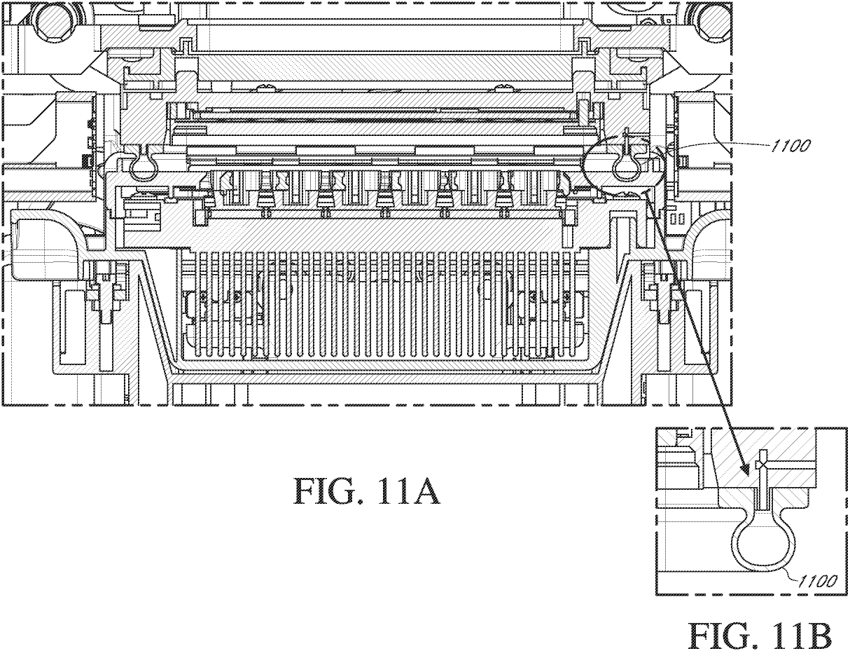

FIG. 11A shows a cross-sectional view illustrating an improved seal in the form of a double lip seal 1100 attached to a lower surface of the heated cover 800. FIG. 11B shows a magnified view of the seal 1100. The double lip design of the seal 1100 can avoid flaring issues, and corresponding poor sealing issues, occurring existing system using prior art single edge or single blade seals. These prior art single blade designs have been found to induce higher pressure in the four corners of the seal during compression when heated cover 800 in down position. As a consequence, sealing degrades over time and repeated use. The disclosed the double lip seal 1100 is configured to provide even contact with the surface 303 of sample block 302, thereby reducing or minimizing heat loss/interference to or from the external environment. In addition to providing a superior sealing at the surface 303, the bellows formed by the double lip seal also provides additional insulating properties of the seal itself, since the air between the inner and outer walls of the seal provided additional insulation.

The system 1000 according to the present teachings is also capable of both detecting a presence of a sample holder on the sample block 302, and reading relevant information about the sample holder. For example, as the cover carrier 710 is lowered together with the heated cover 800 onto the sample block 302 before an experiment run, the actual height of the heated cover 800 is monitored via feedback from one or more encoders. The height of the heated cover 800 is greater when the sample holder is present than when the sample holder is absence, due to the thickness of the sample holder. Accordingly, the presence or absence of the sample holder can then be determined. In certain embodiments, one or more such encoders may be used to distinguish between different types and/or brands of sample holder has been located within the sample block 302 based on differences in thickness between different types or brands. Similarly, the encoder(s) may be used to determine whether a correct or preferred sample holder has been located within the sample block 302.

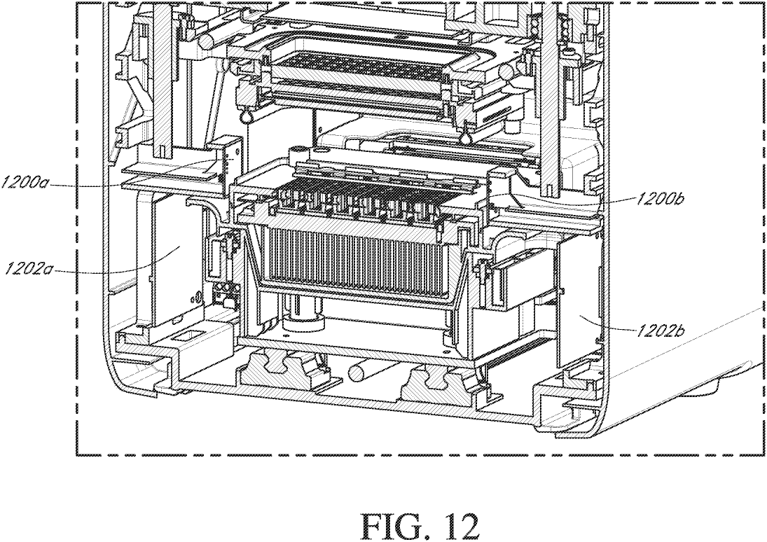

Referring to FIGS. 3C, 3D, and 12, the system 1000 may include first and second RFID antennas 1200a, 1200b in communication with respective first and second devices 1202a, 1202b. The devices 1202a, 1202b may be an RFID reader, RFID writer, or combination RFID reader/writer. In certain embodiments, devices 1202a, 1202b may be combined into a single device that communicates with both antennas 1200a, 1200b. Devices 1202a, 1202b, alone or in combination with system 1000 and/or another system in communication with system 1000, may be configured to read RFID tag 318. The RFID tag 318 and the data contained therein may be used to confirm presence of the RFID, confirm the correct sample holder is being used, perform a pre-run check prior to performance of an assay using system 1000, control the system 1000 and/or assays run on system 1000 (e.g., by providing information about sample holder 316 and/or reaction sites 317 to generate a protocol for use by system 1000 to run an assay, experiment, or test on sample holder 316). In some embodiments, devices 1202a and/or 1202b may be configured to write data generated during an assay conducted on the system 1000. Additionally, data recorded on RFID tag 318 during the assay and/or data already contained on the RFID tag prior to placement in the system 1000 may be used to process the data produced during the assay.

After the run, the RFID writers/readers 1202a, 1202b can write information onto the sample holder RFID tag to mark the sample holder as used which can prevent the sample holder from being re-run. The information can also be transmitted to a remote location, e.g. for inventory control and procurement purposes. The 2 readers also allow detection of the orientation of the sample holder. If a user place does not place the sample holder in normal orientation, system software can account for the angular offset for display and analysis.

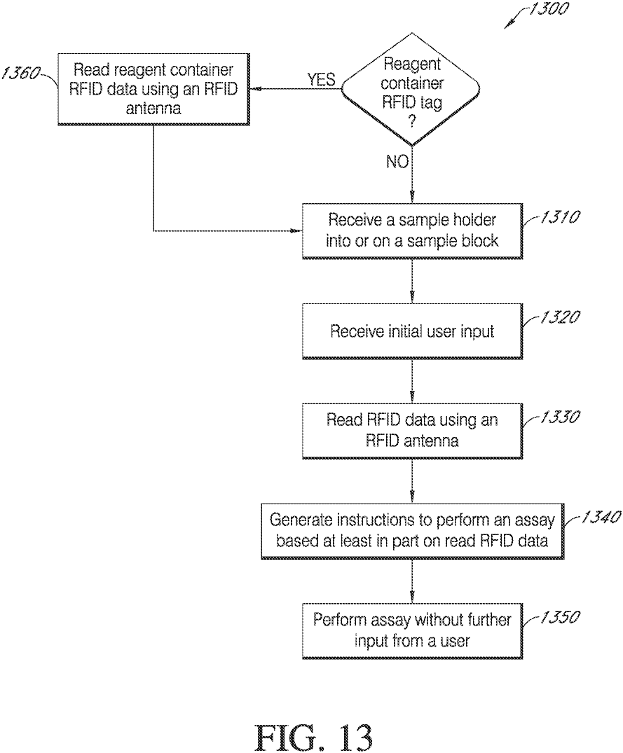

Referring to FIG. 13, in certain embodiments, a method 1300 for performing a biological analysis in an automated fashion without intervention or any further input needed by a user after initial instructions have been sent to begin an assay. The inventors have found that method 1300 produces unexpected advantages over current practices in which a user must either manually input assay protocol information/instructions into a system for running an assay (e.g., by looking in a database by cross referencing a sample holder ID) and/or having obtaining assay protocol information/instructions by connecting to network such as a LAN or cloud database. These current practices are not only time consuming, but are less secure, since proprietary information resides at and/or is sent to sites that are remote from the instrument performing the assay. In many applications, it is critical that input and/or output data related to the assay be maintained in a secure environment to protect from unauthorized access to such data. Using embodiment of the current teaching, all input necessary to configure an assay protocol remains local with sample holder and sample holder RFID tag. In addition, sample holder RFID tags according to embodiments of the present teaching may be used configured to receive information related to output from the assay run, such as run parameters and conditions and/or data generated during the assay run.

The method 1300 may be used in conjunction with the sample holder RFID tag and/or reagent container RFID tag, for example, the sample holder RFID tag 318 and/or reagent container RFID tag 1032. When no reagent container RFID tag is present or being utilized, the method 1300 includes an element 1310 comprising placing a sample holder (e.g., sample holder 316) into or onto a biological analysis system (e.g., system 1000) and an element 1320 comprising receiving from a user an initial user input to initiate an assay. In some embodiments, the initial input from the user may also initiate transport and/or positioning of a sample holder, as discussed above herein regarding movement of sample block 302 / thermal block 305 after placement of a sample holder into carrier, base, or tray 306.

The method 1300 also includes an element 1330 comprising reading at least some of the RFID data using one or more antennas associated with the sample holder RFID tag, for example, one or both RFID antennas 1200a, 1200b. The method 1300 further includes element 1340 comprising generating instructions to perform an assay based at least in part on the read RFID data. After receiving the initial user input, the method 1300 additionally includes an element 1350 comprising executing a set of steps to perform an assay on the sample holder without any further input or intervention from the user until the assay is completed. The set of steps may comprise or be provided by a protocol, which may be configured at least in part from data contained on the sample holder RFID tag. Optionally, additional input to an assay protocol after the initial user input, for example, to further customize the protocol.

In certain embodiments of the method 1300, one or more reagent containers each have their own RFID tag may be included in the system 1000 (e.g., reagent container 1030 and reagent container RFID tag 1032). In such embodiments, the method 1300 may also include an element 1360 comprising reading information from the reagent container RFID tag for one or more of the reagent containers. The method 1300 then includes any or all of the elements 1310 to 1350.

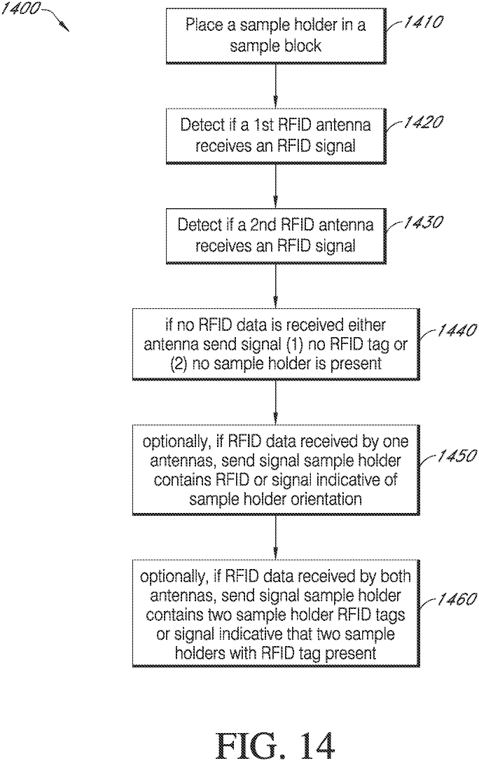

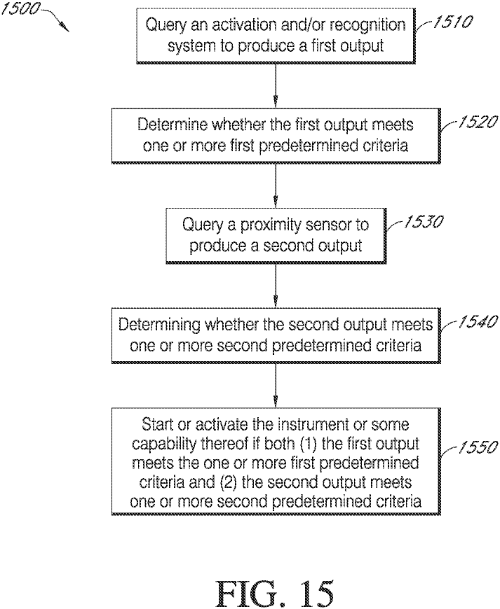

Referring to FIG. 14, in certain embodiments, a method 1400 for performing a biological analysis is utilized to determine an orientation of a sample holder within a system or instrument, for example, the orientation of the sample holder 316 within the sample block 302. Advantageously, this allows the sample holder in some embodiments to be loaded without having to orient the sample holder be matched to a key. Additionally or alternatively, this may allow the same sample block (e.g., sample block 302) to be compatible with different types of sample holders, such as different types of plates or with various plates having different form features (e.g., to be compatible with both 96 well microtiter plates and 4, 8, or 12 well strips).

Using the system 1000 as an example, the method 1400 includes an element 1410 comprising placing the sample holder 316 in or on the sample block 302. The method 1400 also comprises elements 1420 and 1430 comprising determining if RFID data from sample holder RFID tag 318 is being detected from either or both RFID antennas 1200a, 1200b. if no RFID data is received by either antenna 1200a, 1200b, the method 1400 includes element 1440 of generating either (1) producing or generating a signal indicative that the sample holder 316 does not contain an RFID tag or (2) producing or generating a signal indicative that no sample holder is present. If other means, either active or passive, are used for determining the presence of the sample holder 316, then the system would be configured to utilize the second option. Additionally or alternatively, the system may be configured to produce or generate an uncertainty signal if the possibility of a faulty RFID tag is suspected (e.g., based on an antenna signal that is ambiguous or if other means exists for validating the presence of an RFID tag on the sample holder).

Optionally, the method 1400 may include an element 1450 comprising, if RFID data is received by one of the RFID antennas, then generating at least one of (1) a signal indicative that the sample holder 302 contains a sample holder RFID 318 or (2) a signal indicative of an orientation of the sample holder 316. In certain embodiments, the inventors have discovered that detection of the orientation is accomplished by configuring the antennas 1200a, 1200b, the sample holder 316, and the RFID tag 318 so that when the sample holder 316 is oriented as shown in FIGS. 3C, 3D, the signal from the RFID tag 318 is strong enough to be received by antenna 1200a, but the signal to antenna 1200b is too weak to be received. Conversely, if the sample holder 316 is rotated 180 degrees from that shown in FIGS. 3C, 3D, then the signal from the RFID tag 318 is strong enough to be received by antenna 1200b, but the signal to antenna 1200a is too weak to be received. In this manner, the orientation of the sample holder 316 can be detected based on the signal or lack of signal in antennas 1200a, 1200b. Additionally or alternatively, a single RFID device 1202a or b, and/or a single RFID antenna 1200a or b, may be used to determine the orientation of sample holder 316 based on the strength of the signal received from the RFID tag 318.

The inventors have discovered that there is an advantage in separating the antennas 1200a, 1200b from the RFID devices 1202a, 1202b. In certain embodiments, communication between antennas 1200a, 1200b and RFID devices 1202a, 1202b is provided by a wire between each antenna and the corresponding RFID device. By separating in this way, the inventors have found that the relatively small antennas 1200a, 1200b (compared to devices 1202a, 1202b) can be placed above the sample holder 316 and/or sample block 302 so that a relatively week signal from RFID tag can be received by the antenna that is closer to the RFID tag.

Optionally, the method 1400 may include an element 1460 comprising, if RFID data is received by both of the RFID antennas 1200a, 1200b, then generating (1) a signal indicative that the sample holder 316 contains two sample holder RFID tags 318 or (2) a signal indicative that two sample holders 316 with sample the holder RFID tag 318 are present.

In certain embodiments, a method 1500 of using an instrument or system (e.g., the system 1000) comprises an element 1510 including querying an activation and/or recognition system to produce a first output, the activation and/or recognition system comprising one or more of a voice activation and/or recognition system or a face activation and/or recognition system. For example, the activation and/or recognition system may comprise the image system 1017 and/or the voice system 1018 discussed above herein.

The method 1500 further comprises an element 1520 including determining whether the first output meets one or more first predetermined criteria.

The method 1500 further comprises an element 1530 including querying a proximity sensor to produce a second output. For example, the proximity sensor may comprise the proximity sensor 1020 discussed above herein.

The method 1500 further comprises an element 1540 including determining whether the second output meets one or more second predetermined criteria.

The method 1500 further comprises an element 1550 including starting, powering up, activating, or otherwise using a capability or data of the instrument if both (1) the first output meets the one or more first predetermined criteria and (2) the second output meets one or more second predetermined criteria.

In certain embodiments, the method 1500 of using the instrument comprise a method of starting, powering up, or activating the instrument and/or a method of utilizing or initiating certain capabilities of the instrument or of utilizing or granting access to information stored in the system or in a database to which the instrument has access.

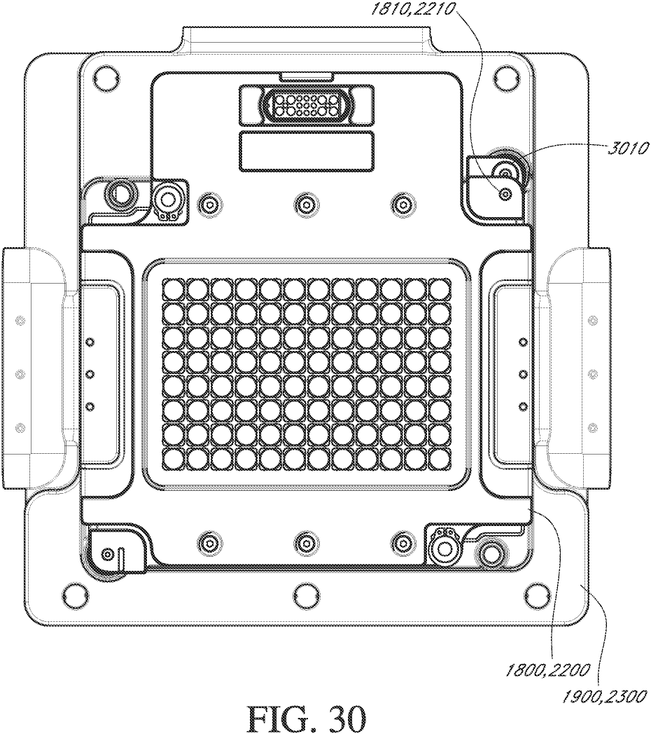

In certain embodiments, the system 1000 is configured to accommodate, and perform biological assays using, any of two or more of pairs of a sample blocks and its associated covers, where each pair of sample blocks and associated covers are configured to accommodate, support, and/or hold a different type of sample holders or sample carriers (e.g., different sample volumes, different number of samples per sample holder, different sample volume geometries, or the like). For example, referring to FIG. 30, the system 1000 may be configured to accommodate a first sample block and associated cover for holding a 96 well microtiter plate (e.g., sample block 302 and associated cover 800), as well as to accommodate a second sample block and associated cover for holding a 384 well microtiter plate.

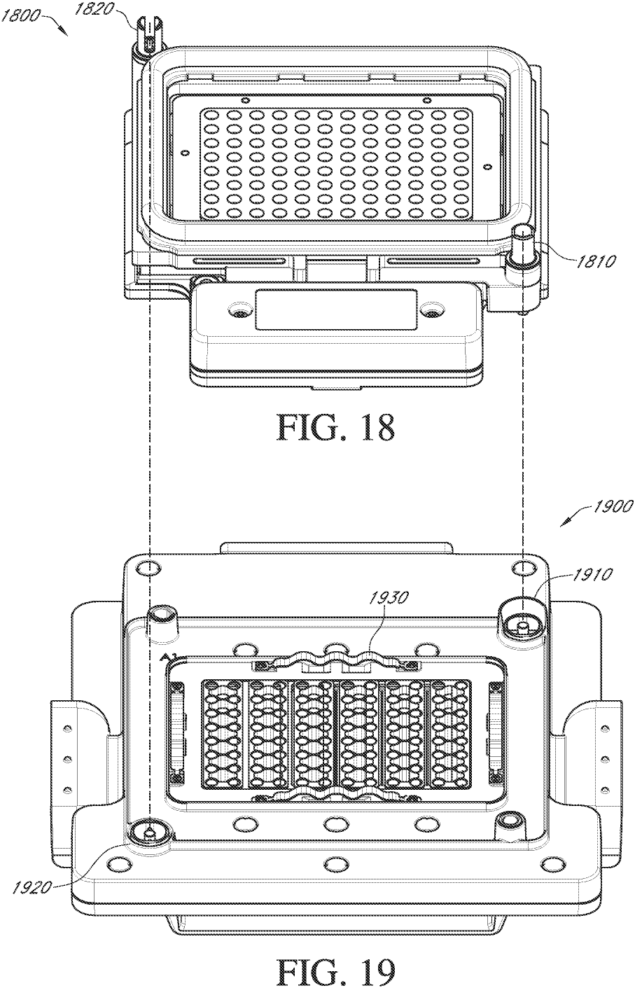

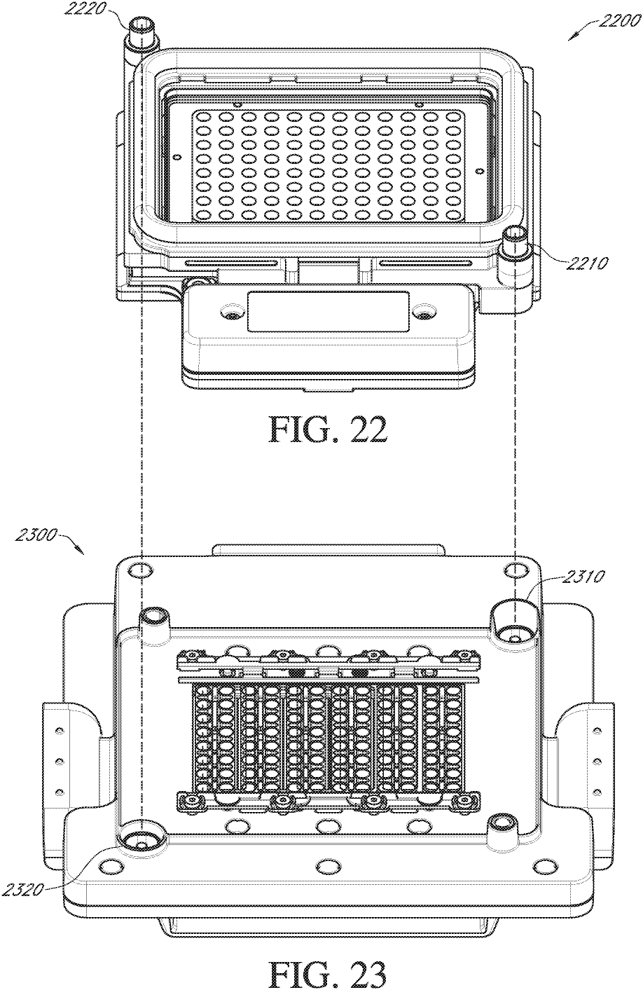

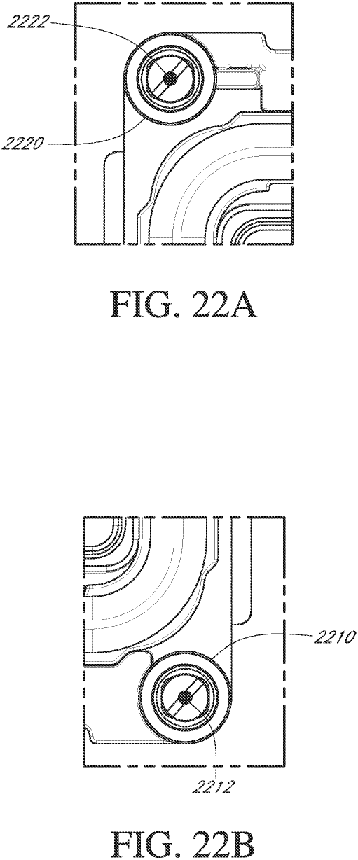

For example, with continued reference to FIG. 30, the system 1000 may be configured to accommodate a first sample block (e.g., a sample block 1900, to be discussed in greater detail below) and an associated first cover (e.g., a cover 1800, to be discussed in greater detail below), as well as to accommodate a second sample block (e.g., a sample block 2300, to be discussed in greater detail below) and an associated second cover (e.g., a cover 2200, to be discussed in greater detail below). In such embodiments, each sample block and associated cover may be constructed provide, or allow the generation of, a continuity signal or other such signal to or by system 1000. The signal may be used by the system 1000 to confirm that the appropriate or correct pair of sample block and associated cover have been provided to the system 1000. The cover 1800 in the illustrated embodiment comprises a connector 1810 that is configured to mate with corresponding connector 1910 of the sample block 1900 (e.g., as seen in FIGS. 18, 19). As discussed in further detail below, the connectors 1810, 1910 may be configured to provide electrical continuity between the connects when the cover 1800 is placed onto sample block 1900. Detection of this electrical continuity may be used to determine that the sample block and associated cover are compatible for use in the system 1000. In similar fashion, the cover 2200 in the illustrated embodiment comprises a connector 2210 that is configured to mate with corresponding connector 2310 of the sample block 2300 (e.g., as seen in FIGS. 22, 23). As discussed in further detail below, the connectors 2210, 2310 may also be configured to provide electrical continuity between the connects when the cover 2200 is placed onto sample block 2300. Again, detection of this electrical continuity may be used to determine that these sample block and associated cover are compatible for use in the system 1000.

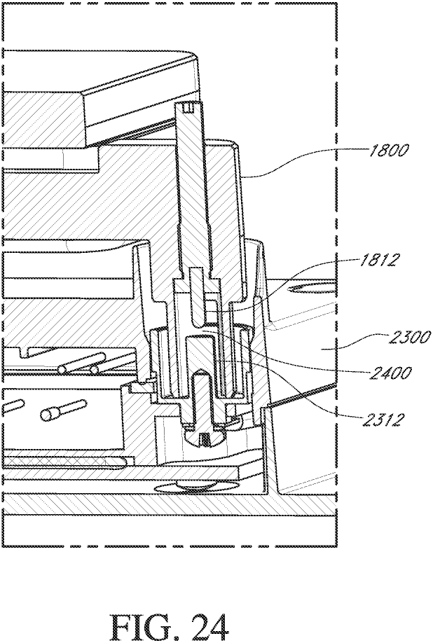

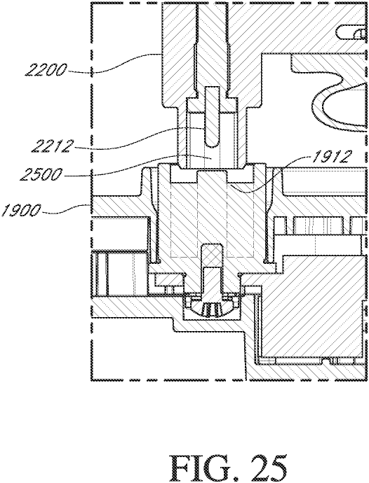

In certain embodiments, the geometry, construction, and/or components connectors in the first and second pairs of sample blocks and covers are configured such that if, for example, the first cover is mistakenly placed on the second sample block and/or the second cover is mistakenly placed on the first sample block, no continuity between corresponding connectors is generated or provided. In certain embodiments, this may be accomplished by changing the geometry and/or components of the first and second sample block connectors and/or the geometry and/or components of the first and second cover connectors. In such embodiments, the location of the connectors in a plane parallel to the facing surfaces may be the same. The inventors have discovered that by configuring the connectors in this way, many of the same parts or elements used to fabricate first and second sample blocks and/or the first and second covers may be used. Advantageously, this increases the efficiency fabrication and reduces inventory requirement and fabrication expenses, since the number of parts that are different between the first and second sample blocks / covers pairs is reduced. For example, the housings or shells of sample blocks 1800, 2200 and/or covers 1900, 2300 may be identical. For example, the housings containing connectors 1810, 2210 and/or containing connectors 1910, 2310 may be identical, and only need incorporate different connector components or component geometry in order to prevent or avoid electrical continuity or the like when the cover 1900 is incorrectly located on sample block 2200 or when the cover 1800 is incorrectly located on sample block 2300. See, for example, FIGS. 24 and 25. As seen in FIG. 24, when cover 1800 is placed on sample block 2300, there is an air gap 2400 between pins 1812 and 2312, thus preventing or avoiding electrical continuity between the connectors. In similar fashion, as seen in FIG. 25, when cover 2200 is placed on sample block 1900, there is an air gap 2500 between pins 1912 and 2212, thus preventing or avoiding electrical continuity between the connectors.

The first set of sample block / cover 1900, 1800 and second set of sample block / cover 2300, 2200 in the illustrated embodiments above are configured to hold, respectively, a standard 96-well microtiter plate comprising wells with a volume of 0.1 milliliter and a standard 96-well microtiter plate comprising wells with a volume of 0.2 milliliter. Other sample holder types are anticipated.

In other embodiments, the mismatch of cover for one type of sample holder or sample carrier and a sample block for another type of sample holder or sample carrier may be accomplished by locating the connectors in a plane parallel to the facing surfaces of first matched set of cover / sample block in a different location than that of a second matched set of cover / sample block used for a different type of sample holder or sample carrier. For example, the system 1000 may be configured to accommodate a third set sample block / cover pair that is configured to accommodate sample holder or carrier that is different than that of the first and second sets discussed above. For example, referring again to FIG. 30, the third cover of the set may comprise a third connector 3010 that is displaced as shown from that of first and second connectors 1810, 2210 of the first and second covers (e.g., covers 1800, 2200). Because the third connector is located in a different location when place over the first or second sample blocks 1900, 2300, there is no continuity between connector 3010 and that of the first or second sample blocks 1900, 2300. In this way, the system can detect that when is a mismatch between any of the three sample blocks and the covers configured to be used in the system.

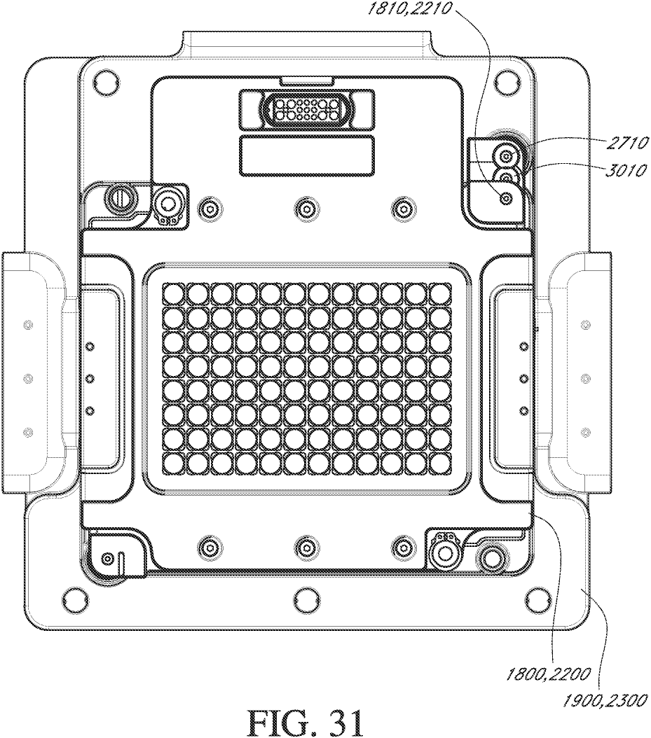

The system 1000 may be configured to accommodate a fourth set sample block / cover pair that is configured to accommodate sample holder or carrier that is different than that of the first, second, or third sets discussed above. For example, referring to FIG. 31, the third cover of the set may comprise a third connector 2710 that is displaced as shown from that of first and second connectors 1810, 2210, 3010 of the first, second, third covers. Because the fourth connector is located in a different location when place over the first, second, and third sample blocks, there is no continuity between connector 3010 and that of the first, second, and third sample blocks. In this way, the system can detect when there is a mismatch between any of the four sample blocks and the covers configured to be used in the system.

The third set of sample block / cover and the fourth set of sample block / cover 2800, 2700 in the illustrated embodiments above are configured to hold, respectively, a standard 384-well microtiter plate and a standard 384-well sample card, such as the TaqMan Array Card manufactured by Thermo Fisher Scientific. In other embodiments, the third set of sample block / cover are configured to hold a standard 384-well sample card. Other types of sample holder or carriers are anticipated.

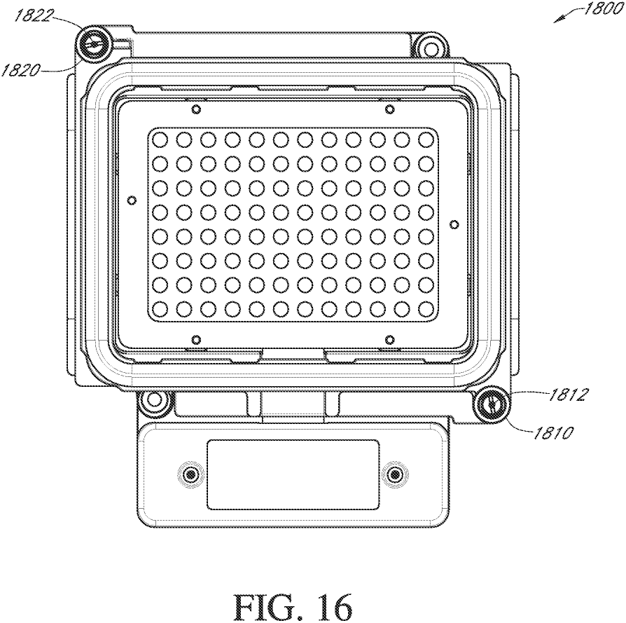

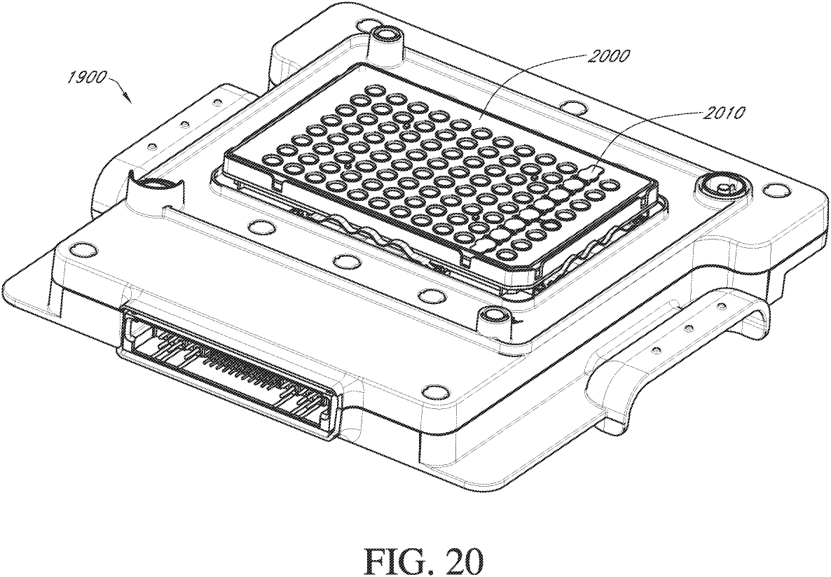

Referring to FIGS. 16-21, in certain embodiments, the system 1000 is configured to receive and for use with a cover 1800 (e.g., a heated cover 1800) that is configured to be placed on top of a sample block 1900. As seen in FIG. 20, the sample block 1900 may be configured to hole a sample holder or sample carrier 2000. Cover 1800 comprises a first connector 1810 comprising a first connector element or pin 1812 and a second connector 1820 comprising a second connector element or pin 1822. Sample block 1900 comprises a first connector 1910 comprising a first connector element or pin 1912 and a second connector 1920 comprising a second connector element or pin 1922. When cover 1800 is placed or fitted onto sample block 1900, first connector 1810 is configured to align to and/or engage with first connector 1910 and second connector 1820 is configured to align to and/or engage with second connector 1920. Each of the pin or connector elements 1812, 1822, 1912, and/or 1922 may be, or may be in electrical communication with, an electrical conductor (not shown), for example, an electrical wire, an electrical cable, or at least a portion of an electrical circuit. In the illustrated embodiment, connectors 1810, 1820, 1910, 1920 are electrical connectors and elements 1812, 1822, 1912, 1922 are electrically conductive elements in electrical contact with corresponding portions of an electrical circuit.

First connector 1910 comprises a first connector element or pin 1912 configured to contact a mating member of connector 1820, wherein element or pin 1912 and the mating member (e.g., a mating connector element or pin, not shown) of connector 1820 produce continuity and/or a closed electrical circuit when cover 1800 is placed on block 1900. Second connector 1920 comprises a second connector element or pin 1924 configured to contact a mating member of connector 1920, wherein connector element or pin 1924 and the mating member of connector 1920 produce continuity and/or a closed electrical circuit when cover 1800 is placed on block 1900.

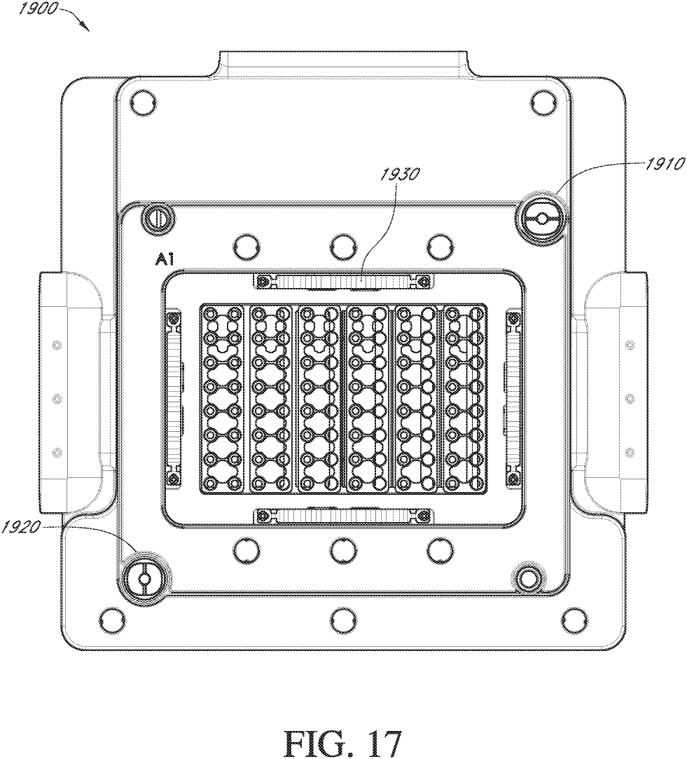

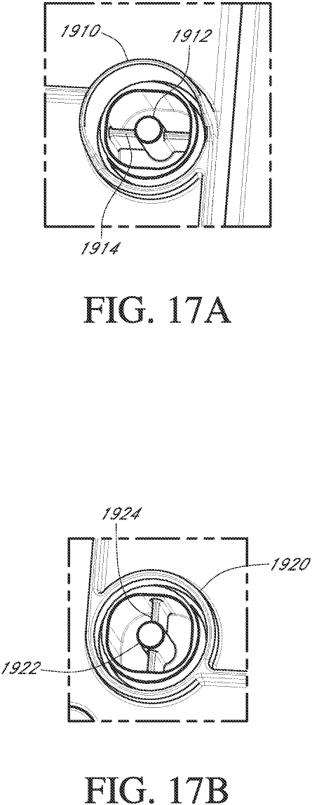

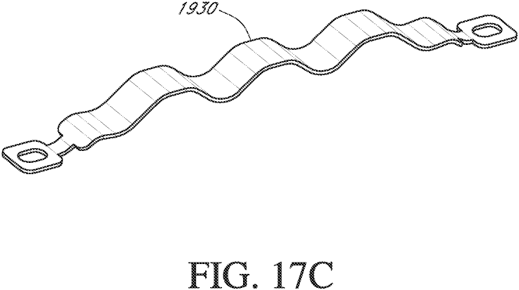

With reference to FIGS. 17A and 17B , first connector 1910 further comprises a cross member 1914 that is configured to fit into a cutout, notch, or groove 1814 in connector 1810 of cover 1800 when cover 1800 is place on block 1900. Similarly, second connector 1920 further comprises a cross member 1924 that is configured to fit into a cutout, notch, or groove 1824 in connector 1810 of cover 1800 when cover 1800 is place on block 1900. In certain embodiments, cross member 1914 and cutout, notch, or groove 1814 are aligned along an axis that is at a different angle (e.g., an axis perpendicular to) that of cross member 1924 and cutout, notch, or groove 1824. In this way, the orientation of cover 1800 to block 1900 may be assured, since the wrong orientation of cover 1800 would not provide electrical continuity.

As shown in FIGS. 17 and 17C, sample block 1900 may further comprise one or more wavy or undulating springs 1930 (1930a, 1930b, 1930c, and 1930d in the illustrated embodiment) which can be used to push a sample holder 2000 away from sample block 1900 when the cover 1800 is not place on sample block 1900. This configuration is in contrast to the ejector member 600, where the construction and dimensions of sample holder 2000 is different than that of sample holder 316 shown in FIGS. 3C and 3D. For example, sample holder 316 may be configured to provide a plurality of sample wells (e.g., 8 or 96 sample wells), where each well is configured to have a nominal volume of 0.2 milliliters, while sample holder 2000 is configured a plurality of sample wells (e.g., 8 or 96 sample wells) of a microtiter plate, where each well is configured to have a nominal volume of 0.1 milliliter. The inventors have discovered that the undulating springs 1930 provide superior performance in ejecting commercially available 0.1 microtiter plates due to the relatively thin edge of 0.1 milliliter compared to 0.2 milliliter plates.

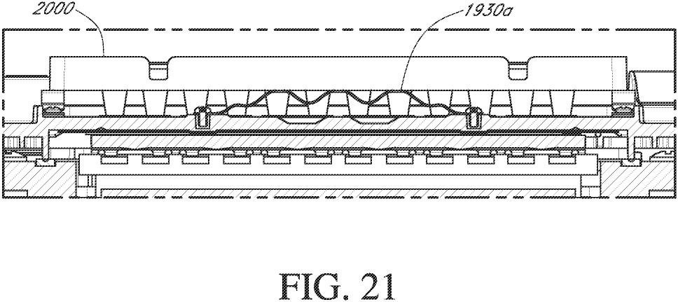

FIGS. 18 and 19 are perspective views of cover 1800 and the sample holder 1900. The two dashed lines show the correspondence between the connectors 1820, 1920 and connectors 1810, 1910 when the cover 1800 is flipped over from the position shown in the figure and placed on top of the sample block 1900. FIG. 20 is a perspective view of the sample block 1900 with the 96-well microtiter plate 2000 placed on the wells of the sample block 1900. In certain embodiments, sample holder 2000 is configured to hold one or more strips of 4, 8, or 12 wells or vials, such as an 8-well sample strip 2010. FIG. 21 shows cross section of the sample holder 2000 in sample block 1900. The undulating springs 1930 is seen in a compressed configuration due to contact with a bottom edge surface of sample holder 2000.

Referring to FIGS. 22-23, in certain embodiments, the system 1000 is configured to receive and for use with a cover 2200 (e.g., a heated cover 2200) that is configured to be placed on top of a sample block 2300. For example, cover 2200 may comprise cover 800 shown in FIGS. 8D, 9B, C, & H. Referring to FIGS. 22A, 22B, cover 2200 may comprise a first connector 2210 comprising a first connector element or pin 2212 and a second connector 2220 comprising a first connector element or pin 2222. Sample block 2300 comprises respective first and second connectors 2310 and 2320 comprising first and second connector elements or pins 2312, 2322. Each of the pin or connector elements 2212, 2222, 2312, and/or 2322 may be, or may be in electrical communication with, an electrical conductor (not shown), for example, an electrical wire, an electrical cable, or at least a portion of an electrical circuit. In certain embodiments, connectors 2210, 2220, 2310, and 2320 do not included the cross members and/or the cutouts, notches, or grooves discussed above for connectors 1810, 1820, 1910, and 1920 discussed above.

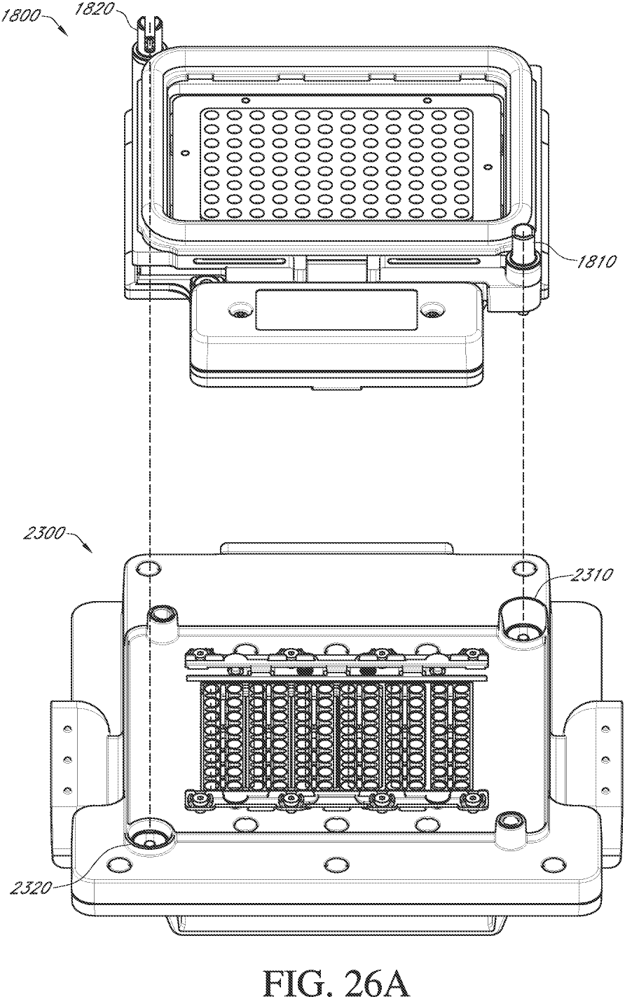

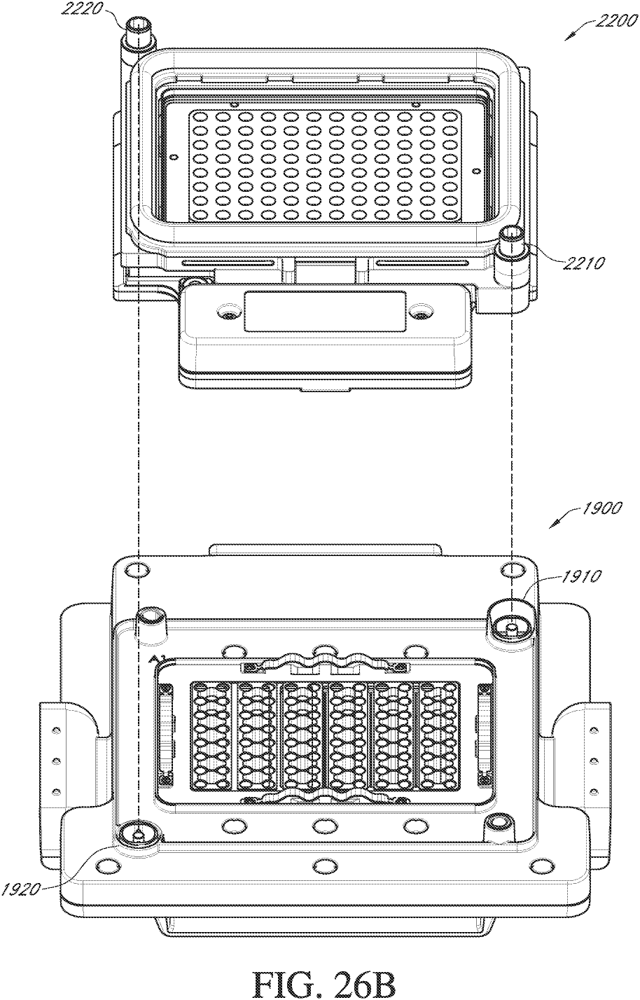

Referring to FIGS. 24-26, it can be seen that the difference in the connectors for cover 1800 / block 1900 compared to cover 2200 / block 2300 can be used to prevent cover 1800 from accidently being placed on block 2300, or from prevent cover 2200 from accidently being placed on block 1900, since the different in construction of the connectors and/or connector elements or pins prevents continuity being achieved when the wrong cover is placed on the wrong sample block. The system may include a processor and/or a memory including instructions to advise a user when a mismatch has occurred and/or prevent the instrument from receiving the sample block and cover unless they are properly paired. The various blocks and covers discussed herein may be used in conjunction with methods for performing a biological experiment, test, or assay.

In the various illustrated embodiments above, the covers 800, 1800, 2200 and the sample blocks 302, 1900, 2300 are configured for used with 96-well microtiter plates. In certain embodiments, the system 1000 and block assembly 300 may be configured for sample holders comprising 384 wells and/or 384 array cards, such as the TaqMan Array Card (TAC) produced by Thermo Fisher Scientific. For example, cover 800 and sample block 302 may be configured to receive a microtiter plate comprising 384 sample wells, wherein the sample block 302 comprises 384 sample well or receiving elements 304 and the cover 800 comprises 384 corresponding openings for illuminating the 384 wells of the microtiter plate.

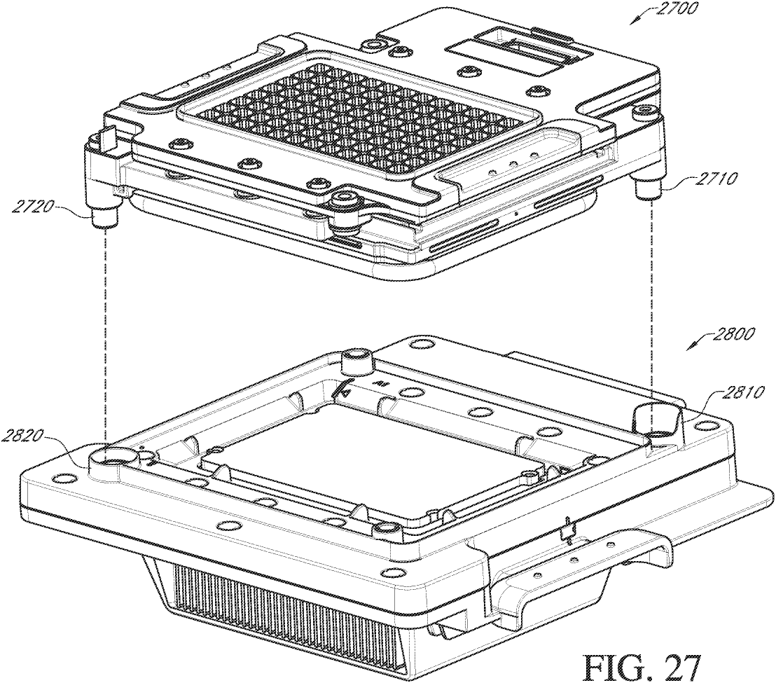

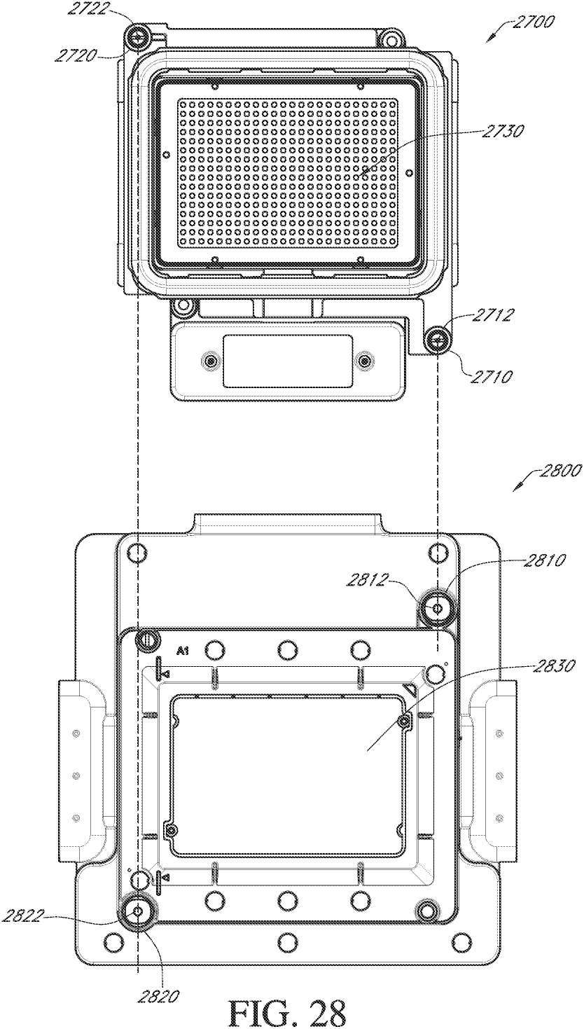

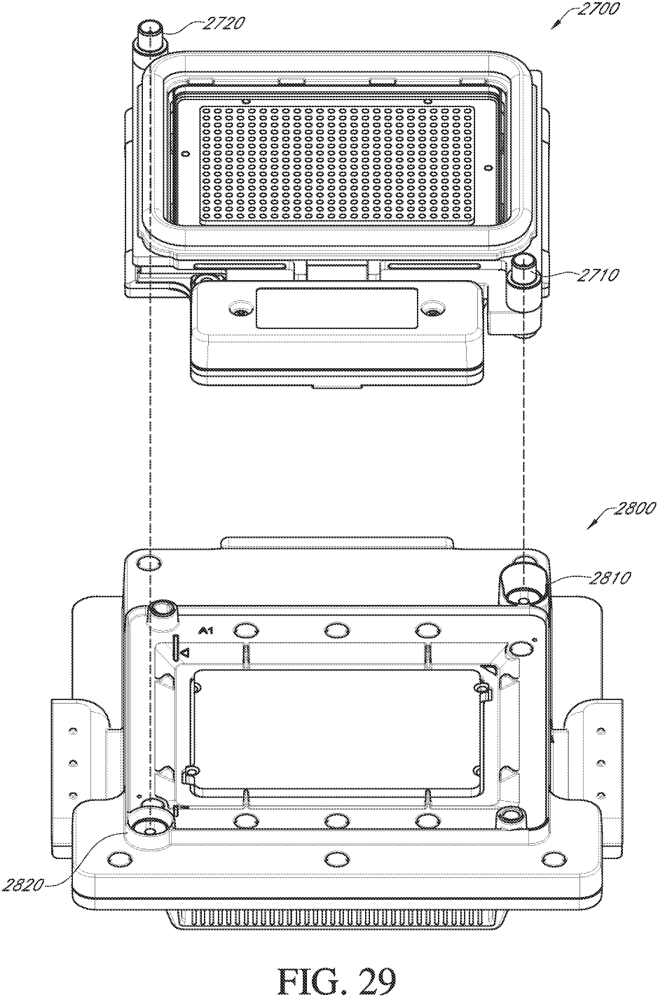

Referring to FIGS. 27-29, in certain embodiments, the system 1000 is configured for use with a cover 2700 (e.g., a heated cover 2700) that is configured to be placed over or on top of a sample block 2800. The cover 2700 and sample block 2800 are configured to receive a TAC including 384 sample sites. In the illustrated embodiment, the cover comprises 384 opening for permitting optical access to each of the 384 reaction sites of the TAC. In certain embodiment, the sample block comprises a smooth or flat surface 2830 that has thermal contact with the TAC and may be configured to perform thermal cycling of the samples in the TAC, or to otherwise control the temperature of the samples. In other embodiments, the flat surface 2830 is replaced with a structure including 384 sample well receiving elements (not shown) configured to receive the 384 reaction sites of the TAC or similar sample holder.

In certain embodiments, the cover 2700 comprises a first connector 2710 comprising a first connector element or pin 2712 and a second connector 2720 comprising a first connector element or pin 2722. Sample block 2800 comprises respective first and second connectors 2810 and 2820 comprising first and second connector elements or pins 2812, 2822. In the illustrated embodiment, connectors 2710, 2720, 2810, 2820 are electrical connectors and elements 2712, 2722, 2812, 2822 are elements in electrical contact with corresponding portions of an electrical circuit.

Referring to FIG. 30, in certain embodiments, a connector of sample block 800 for a 384-well microtiter plate is offset along further up along a vertical axis of the drawing page relative to the connectors 1910, 2310 of the sample blocks 1900, 2300. Referring to FIG. 31, the connector 2810 of sample block 2800 is offset further up along the vertical axis of the drawing page relative to the connectors 1810, 1910, 2110, 2210 of the sample blocks 1900, 2300 and relative to the connector of the sample block 800 referenced above and in FIG. 31. It is also seen in FIG. 31 that the corresponding connectors for the cover and sample block configured for the 384-well microtiter plate are located at an intermediate location between that for the cover/block 2700, 2800 and that for the covers 1800, 2200 / block 1900, 2300. Thus, the connectors for all four sample carrier formats are configured to prevent inadvertent used of any of the four covers with any of the remaining three sample blocks.

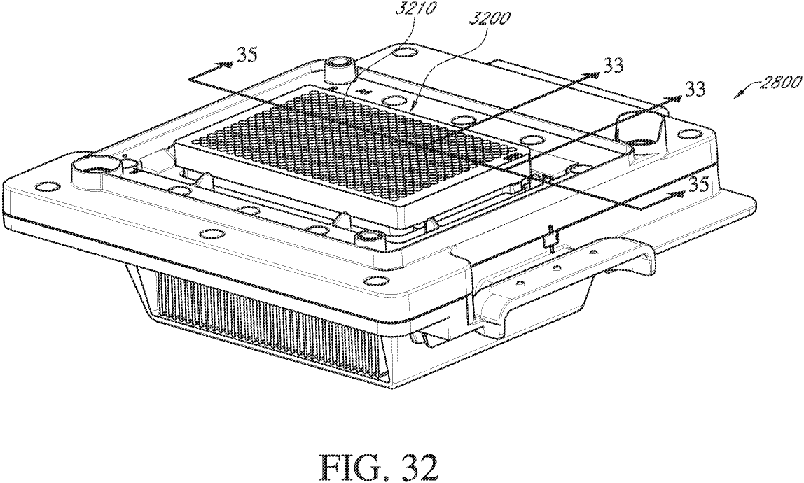

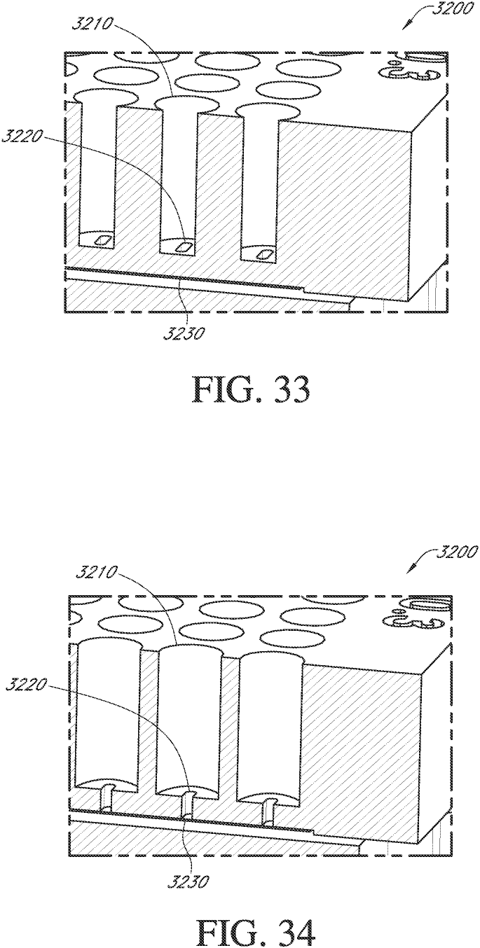

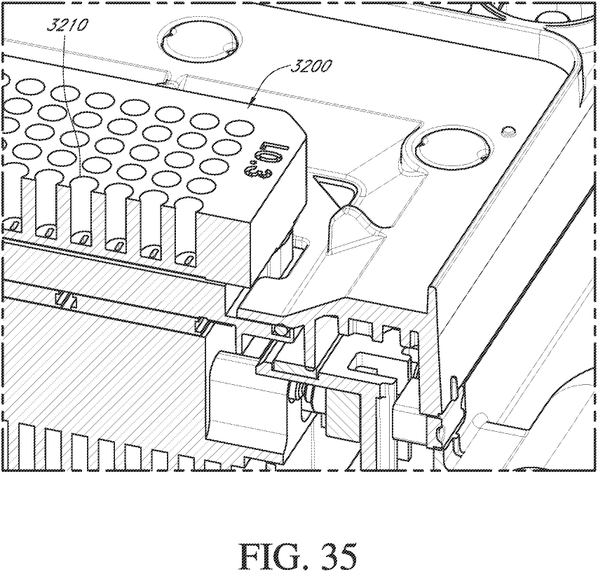

Referring to FIG. 32, in certain embodiments, a calibration or alignment fixture 3200 is configured for use in aligning the sample block 2800 to the optical system of system 1000. As shown in the illustrated embodiment, the alignment fixture 3200 may comprise one or more openings or wells 3210 in the top surface thereof, for example, 384 openings corresponding to the 384 openings 2730 in the cover 2700. With further reference to FIGS. 33-35, one or more of the wells 3210 of the alignment fixture 3200 may comprise a smaller opening 3220 located at a bottom of the well. In certain embodiments, the one or more wells 3210 further comprise a reflective or optically active material (e.g., a fluorescent or phosphorous material) within or at the bottom of the opening. In the illustrated embodiment, the opening(s) 3220 comprises an elongated opening or slit that is location to which the sample block 2800 is to be aligned. The opening 3220 may have other shapes such as circular. The opening 3220 may be centered within well 3210 or disposed at a different alignment location.

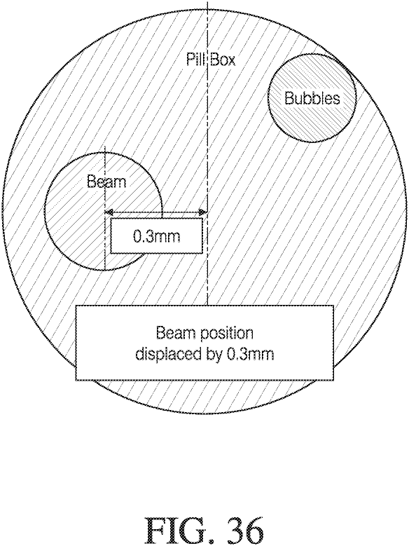

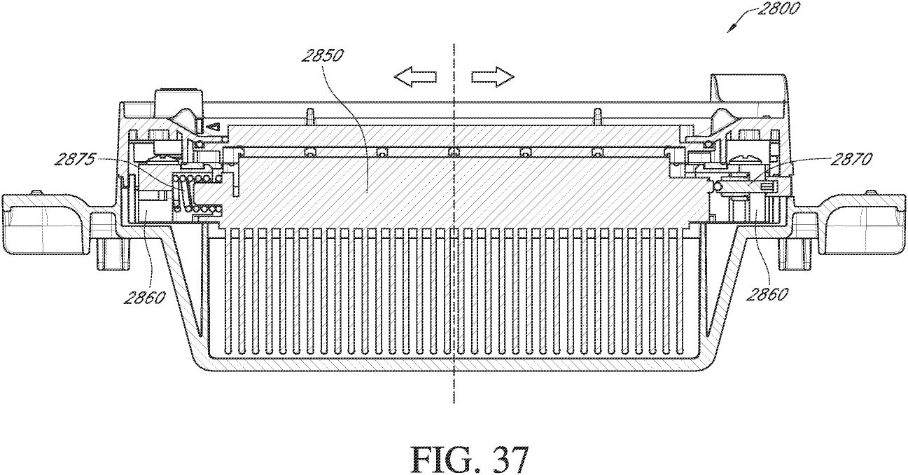

In the illustrated embodiment, the opening is offset from the center of a well 3210 by 300 micrometer (0.3 millimeters) to compensate for possible air bubbles that can form at a sample entry point into the wells of the reaction region or well of the sample holder (e.g., TaqMan Array card). Referring to FIG. 36, the location of such a bubble and the offset alignment location are shown. Referring to FIG. 37, the sample block 2800 may comprise a movable portion 2850 that may be disengaged and moved relative to a fixed portion 2860 that may be fixed, for example, to the tray 306. In the illustrated embodiment, the moveable portion 2850 is registered or placed in contact with an adjuster 2870 by a compression spring 2875. During alignment of the moveable portion to system 1000, the adjuster 2870 may be used to change the location of the sample block 2800 relative to system 1000.

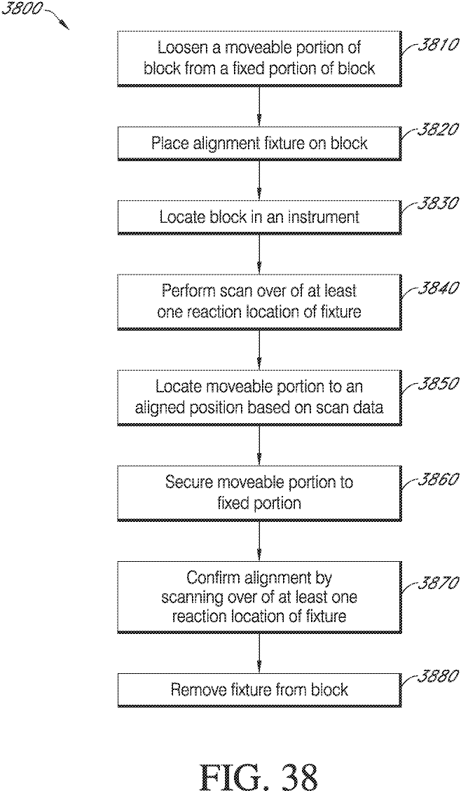

Referring to FIG. 38, a method 3800 of aligning the sample block 2800 is shown. The method 3800 comprises an element 3810 including loosening a moveable portion of a sample block from a fixed portion of the sample block. The method 3800 further comprises an element 3820 including placing an alignment fixture on the sample block. The method 3800 additionally comprises an element 3830 including locating the sample block in an instrument (e.g., the instrument 1000). The method 3800 also comprises an element 3840 including performing a scan over of at least one reaction location of the fixture. The method 3800 further comprises an element 3850 including locating the moveable portion to an aligned position based on scan. The method 3800 additionally comprises an element 3860 including securing the moveable portion to the fixed portion. The method 3800 also comprises an element 3870 including confirming the alignment by scanning over of the at least one reaction location of the fixture. The method 3800 further comprises an element 3880 including removing the fixture from the sample block.

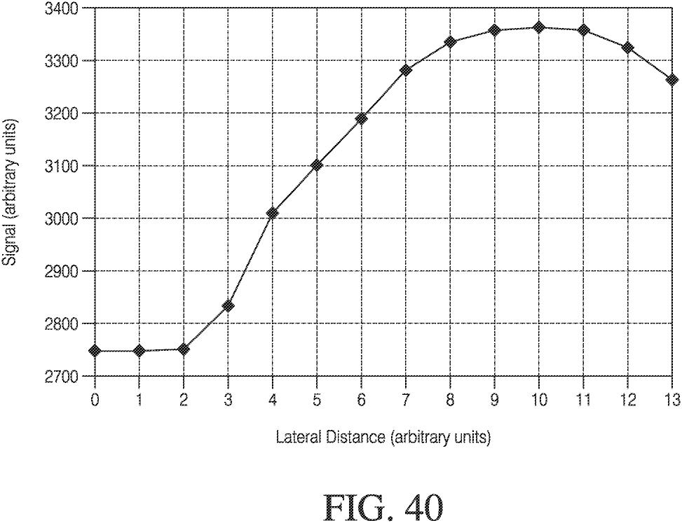

The method 3800 may be used to align sample block 2800 based on signals received at a detector (e.g., the imaging detector used in system 1000 during an assay). Alternatively, the method 3800 may be performed using an instrument specifically configured to perform the method 3800. The alignment of sample block 2800 may be based on signals produced during a scan of one or more of the well 3210, for example, based on the average location of a peak signal from a plurality of wells 3210 (e.g., all 384 wells 3210). In other embodiments, the alignment of sample block 2800 may be based on signals produced during a scan of a few wells 3210 or a single well 3210, for example, one or more wells 3210 located at or near the center of the array of wells 3210 and/or wells at one or more corners of the array of wells 3210. Referring to FIG. 40, a signal from a representative well 3210 is shown. The peak signal is seen to be produced 300 micrometer away from the center of the well, which corresponds to the location of the smaller opening 3220.

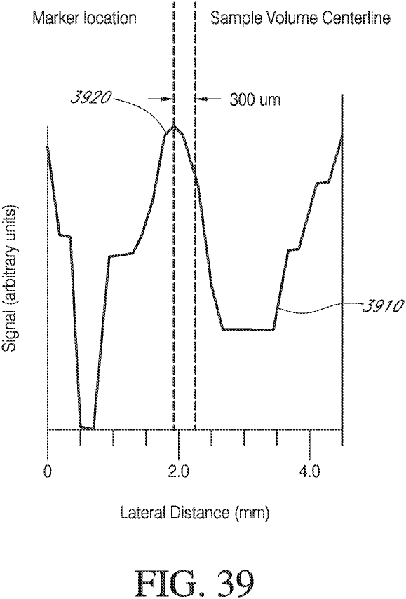

Referring to FIG. 39, a typical scan 3910 is shown. A peak signal 3920 of scan 3910 is indicative of center portion one of one of the sample volumes of wells 3210 and the minimums to either side of peak signal 3920 may be indicative of a portion of alignment fixture 3200 between adjacent wells 3210. As indicated in FIG. 39, once the local maximum is determined, the fixture 3200 may be off-set or translated a predetermine amount of 300 micrometer (0.3 millimeters). The amount of off-set may be different from 300 micrometers, depending on the particular application or amount determined by a user. The amount of offset may be based on the peak signal 3920 from a single well 3210 or by the peak signal from two or more well 3210, for example, based on an average spacing between peak signals 3920 of a plurality of wells.

Referring to FIG. 40, a typical scan using the method 3800 is shown using alignment fixture 3200 with sample block 2800. Each data point in the plot shows an averaged signal from the 384 openings or wells 3210 of fixture 3200 at each of the 14 data points (0 to 13) corresponding to progressively increasing shifts in location across the wells 3210 as the moveable portion 2850 is moved using adjuster 2870. A peak signal is noted at the data point number 10. The data for locations 11-14 may be used confirm that data point 10 corresponds to the maximum signal due to alignment with the smaller opening 3220 and, therefore, the desired or predetermined alignment of the sample block 2800. For the illustrated embodiment, the desired or predetermined location is one that is offset from the centers of the wells or openings 3210. In the illustrated embodiment, the maximum signal corresponds to an offset of 0.3 millimeters from the centers of the wells or openings 3210.

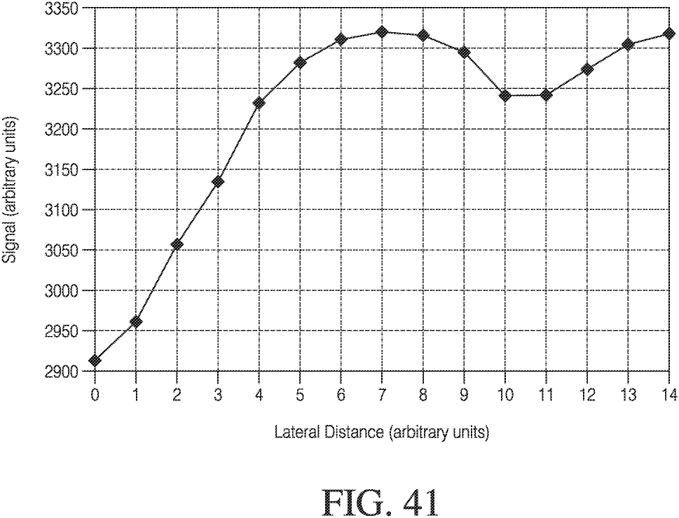

Referring to FIG. 41, a typical scan using the method 3800 is shown using alignment fixture 3200 with sample block 2800. The scan at locations 0 to 10 are obtained in the same way as described above for FIG. 40. For locations 11-14, the moveable portion 2850 is moved in the opposite direction to that for data points 0-10. In this way, the alignment position is determined based on data points 0-10 and the sample block is then move back to the proper where the signal is again maximum at data point 14.

It will be appreciated by a person skilled in the art that numerous variations and/or modifications may be made to the present disclosure as shown in the specific embodiments without departing from the scope of the present disclosure as broadly described. The present embodiments are, therefore, to be considered in all respects to be illustrative and not restrictive.

The following is a list of illustrative embodiments and/or implementations of the present disclosure:

1. A biological analysis system comprising:
a sample block configured to hold a biological sample and a base configured to hold the sample block, the sample block comprising a first connector;
a first driver comprising a second connector;
a cover disposed to cover the sample block and a cover carrier configured to hold the cover, the cover comprising a third connector;
a second driver comprising a fourth connector;
a controller communicatively coupled to the first driver and to the second driver, the controller configured to:
   align the cover and/or the sample block to the cover carrier using the second driver;
   engage the third connector with the fourth connector using the second driver;
   engage the first connector with the second connector using the first driver; and
   secure and/or lock the sample block to the base using the first driver.

2. The system of 1, wherein the connectors are electrical connectors configured to provide electrical power and/or communication between the system and the sample block and between the system and the cover.

3. The system of 1 or 2, further comprising:
a third driver, the controller being communicatively coupled to the third driver;
wherein the controller is configured to secure and/or lock cover to the cover carrier using the third driver.

4. The system of 3, wherein the controller is configured to:
disengage the cover from the cover carrier using the third driver; and
disengage the third electrical connector from the fourth electrical connector using the second driver to separate the cover carrier from the cover.

5. The system of any of 1-4, wherein the controller is configured to disengage the third electrical connector from the fourth electrical connector using the third driver by moving a linkage from a first position to release the cover from the cover carrier to a second position to separate the third electrical connector from the fourth electrical connector

6. A biological analysis system comprising:
a sample block configured to hold a biological sample and a base configured to hold the sample block, the sample block comprising a first connector;
a first driver comprising a second connector;
a controller communicatively coupled to the first driver, the controller configured to:
   engage the first connector with the second connector using the first driver; and
   secure and/or lock the sample block to the base using the first driver.

7. The system of 6, wherein the connectors are electrical connectors configured to provide electrical power and/or communication between the system and the sample block.

8. A biological analysis system comprising:
a sample block configured to hold a biological sample;
a cover disposed to cover the sample block and a cover carrier configured to hold the cover, the cover comprising a first connector;
a first driver comprising a second connector;
a controller communicatively coupled to the first driver, the controller configured to:
   align the cover and/or the sample block to the cover carrier using the first driver; and
   engage the first connector with the second connector using the first driver.

9. The system of 8, wherein the connectors are electrical connectors configured to provide electrical power and/or communication between the system and the cover.

10. The system of 8 or 9, further comprising:
a second driver, the controller being communicatively coupled to the second driver;
wherein the controller is configured to secure and/or lock cover to the cover carrier using the second driver.

11. The system of 10, wherein the controller is configured to:
disengage the cover from the cover carrier using the second driver; and
disengage the first electrical connector from the second electrical connector using the first driver to separate the cover carrier from the cover.

12. The system of any of 8-11, wherein the controller is configured to disengage the third electrical connector from the fourth electrical connector using the third driver by moving a linkage from a first position to release the cover from the cover carrier to a second position to separate the third electrical connector from the fourth electrical connector

13. The system of any of 1-12, wherein the cover is a heated cover.

14. A biological analysis system comprising:
a sample block and a base configured to hold the sample block;
a heated cover and a cover carrier configured to hold the heated cover;
a first drive mechanism configured to engage the sample block;
a second drive mechanism configured to engage the heated cover; and
a controller communicatively coupled to the first and second drive mechanisms,
wherein the controller is configured to, based on a first command, automatically operate the first drive mechanism to releasably engage the sample block with the base, and automatically operate the second drive mechanism to releasably engage the heated cover with the cover carrier.

15. The system of 14, wherein the controller is configured to, based on a second command, automatically operate the first drive mechanism to disengage the sample block from the base, and automatically operate the second drive mechanism to disengage the heated cover from the cover carrier.

16. The system of 14, further comprising a third drive mechanism and a fourth drive mechanism, and wherein, based on the first command, the third drive mechanism is configured to move the base and sample block to an open position and the fourth drive mechanism is configured to move the heated cover and cover carrier to a raised position.

17. The system of 15, wherein, based on the second command, a third drive mechanism is configured to move the base and sample block to an open position and a fourth drive mechanism is configured to move the heated cover and cover carrier to a lowered position.

18. The system of 17, wherein the heated cover is disposed on top of the sample block between the closed and open positions.

19. The system of 18, further comprising at least one sensor configured to determine a presence on the heated cover on top of the sample block.

20. The system of 16, further comprising at least one first lock member connected to the sample block and at least one second lock member connected to the base, and wherein the first and second lock members are configured to engage with each other when the sample block engages with the base to positionally secure the sample block.

21. The system of 16, further comprising a plurality of alignment pins configured to align the cover carrier with the sample block in the closed position.

22. The system of 14, further comprising an optics assembly and an extendable bellow, wherein the bellow is disposed between the optics assembly and the cover carrier.

23. The system of 17, wherein:
the sample block comprises a top surface including a two-dimensional array of reaction regions defining a periphery at the top surface that surround the reaction regions, the periphery comprising a pair of opposing long edges having a first length and a pair of opposing short edges having a second length that is shorter than the first length;
the sample block comprises a pair of ejector members adjacent and substantially parallel to respective ones of the long edges;
the sample block is configured to receive a sample holder
the ejector members are configured to at least partially raise the sample holder relative to the sample block when the sample block is in the open position.

24. The system of 23, further comprising an RFID reader configured to read a sample holder RFID tag attached to the sample holder.

25. The system of 23, further comprising a detector configured to detect a presence of the sample holder on the sample block.

26. The system of 23, further comprising a double lip seal attached to a lower surface of the heated cover, wherein, in use, the double lip seal is configured to contact the sample block and sealingly surround the sample holder.

27. The system of 15, wherein the first command comprises an installation command to install the sample block and heated cover, and the second command comprises a removal command to remove the sample block and heated cover.

28. The system of 15, wherein the first or second command comprises one of a touch input, a keypad input, a voice command, or a gesture.

29. A method of installing a sample block and heated cover in a biological analysis system, the method comprising:
disposing a sample block and heated cover on a base;
positioning a cover carrier to engage the heated cover;
in response to a confirmation of a presence of the sample block and heated cover, automatically moving the cover carrier to engage heated cover.

30. The method of 29, further comprising raising the cover carrier together with engaged the heated cover to separate heated cover from the sample block.

31. The method of 29, wherein engaging the heated cover with the sample block comprises simultaneously aligning the heated cover with the sample block.

32. The method of 29, wherein automatically engaging the heated cover with a cover carrier comprises moving the cover carrier toward the heated cover, and simultaneously aligning the cover carrier with the heated cover.

33. A method of removing a sample block and heated cover from a biological analysis system, the sample block supported by a base, the method comprising:
using a cover carrier, automatically lowering the heated cover onto the sample block while the sample block;
disengaging the heated cover from the cover carrier such that the heated cover is on top of the sample block; and
automatically moving the sample block together with the heated cover from a closed position to an open position; and
removing the sample block from the base of the block assembly.

34. The method of 33, further comprising retrieving the sample block together with the heated cover in the open position.

35. The method of 33, wherein automatically lowering the heated cover onto the sample block comprises aligning the heated cover with the sample block.

36. A biological analysis system comprising:
a housing;
a sample block disposed within the housing and configured to receive a sample holder comprising a sample holder RFID tag;
a first RFID antenna and a second RFID antenna, the RFID antennas configured during use to receive RFID data from the sample holder RFID tag;
at least one RFID reader configured to receive the RFID data from the first RFID antenna and configured to receive the RFID data from the second RFID antenna.

37. The biological analysis system of 36, further comprising at least one RFID writer configured to write data on the sample holder RFID tag.

38. The biological analysis system of any of 36-37, wherein the RFID antennas are spatially separated from the at least one RFID reader.

39. The biological analysis system of 38, wherein the RFID antennas communicate with the at least one RFID reader via an electrical wire or electrical cable.

40. The biological analysis system of any of 38-39, wherein the first RFID antenna is disposed proximal one side of the sample block and the second RFID antenna is disposed proximal a different side of the sample block.

41. The biological analysis system of any of 38-40, wherein the first RFID antenna is disposed proximal one side of the sample block and the second RFID antenna is disposed proximal an opposite side of the sample block.

42. The biological analysis system of any of 38-41, wherein the sample block has an uppermost surface, the at least one RFID reader is(are) disposed below the uppermost surface, and the RFID antennas are disposed above the uppermost surface.

43. The biological analysis system of any of 36-42, wherein the system comprises the sample holder and the sample holder RFID tag.

44. The biological analysis system of 43, wherein:
sample holder comprises a plurality of spatially separated reaction locations, each of the plurality of spatially separated reaction locations comprising a plurality of characteristics;
the sample holder RFID tag includes RFID data comprising data for the plurality of characteristics each of the reaction location;
wherein the RFID data comprises at least 8 kilobytes, at least 64 kilobytes, or at least 128 kilobytes.

45. The biological analysis system of 44, wherein the plurality of spatially separated reaction locations comprises at least 96 reaction locations, at least 384 reaction locations, at least 1536 reaction locations, at least 3072 reaction locations, or at least 12,288 reaction locations.

46. The biological analysis system of any of 43-45, wherein the RFID writer is configured to write assay information generated during an assay onto the sample holder RFID tag and, optionally, the system is configured to use the assay information to analyze data obtained during the assay.

47. The biological analysis system of any of 43-46, wherein the plurality of characteristics comprises one or more of a:
sample holder ID;
sample holder expiration date;
sample holder part number;
sample holder barcode;
sample holder lot number;
sample holder type;
storage temperature and/or storage temperature range;
sample concentration - recommended range; provision for E1 pipette support?
sales order number;
assay name(s) and/or locations on sample holder;
assay IDs;
suggested protocol or required protocol;
sample name(s)
master mix name(s);
master mix change(s);
dye name(s);
suggested or required filter or set of filters to be used during an assay on the sample holder;
EDT file format and/or EDF file format;
internet links or addresses;
passive reference dye(s);
reaction volume(s);
target name(s);
dye name(s);
sample name(s);
analysis settings;
flag setting(s);
sample type(s);
target type(s);
run protocol(s) comprising one or more of a heated cover temperature, reaction volume(s), temperature step value(s), temperature stage value(s); or
well information for one or more wells, the information including one or more of target name, dye name, or sample name; reagent name.

48. The biological analysis system of 47, wherein the plate type is characterized by 48, 96, 384, 1536, or 3072 wells or through-holes

49. The biological analysis system of any of 47-48, wherein the plate type is characterized by wells having a volume of 0.1 milliliters or 0.2 milliliters.

50. The biological analysis system of any of 47-49, wherein the RFID data on the sample holder RFID include re-writeable data comprising one or more of a:
passive reference dye(s);
reaction volume(s);
target name(s);
dye name(s);
sample name(s);
analysis settings;
flag setting(s);
sample type(s);
target type(s);
run protocol(s) comprising one or more of a heated cover temperature, reaction volume(s), temperature step value(s), temperature stage value(s); or
well information for one or more wells, the information including one or more of target name, dye name, or sample name; reagent name.

51. The biological analysis system of any of 36-50, further comprising a sensor disposed on or embedded in one or more of the sample holder RFID tag, the sample block, or a thermal block coupled to the sample block.

52. The biological analysis system of 51, wherein the sensor is in communication with the sample holder RFID tag.

53. The biological analysis system of any of 51-52, wherein the sensor comprises one or more of the thermal sensor, an accelerometer, a shock sensor, a photo sensor, a light detector.

54. The biological analysis system of any of 51-53, wherein information from the sensor is written to the sample holder RFID tag at least one time over the life of the sample holder.

55. The biological analysis system of any of 51-54, wherein the sensor is a temperature sensor, the sample holder is configured for use in a PCR assay, and the sample holder RFID tag is configured to record temperatures of the sample holder over one or more thermal cycles during the PCR assay.

56. The biological analysis system of any of 36-55, wherein the at least one RFID reader comprises a first RFID reader configured to receive the RFID data from the first RFID antenna and a second RFID reader configured to receive the RFID data from the second RFID antenna.

57. The biological analysis system of any of 36-56, wherein the system is configured such that during use, when the sample holder is received by the sample block, only one of the RFID antennas is able to receive the RFID data.

58. The biological analysis system of any of 36-57, further comprising a processor and a memory coupled to the processor.

59. The biological analysis system of 58, wherein the memory comprises instructions to:
verify whether at least one of the first RFID antenna or the second RFID antenna is(are) receiving RFID data or signal;
perform at least one of:
   if no RFID data or signal is received by either the first RFID antenna or the second RFID antenna, generate (1) a signal indicative that the sample holder does not contain an RFID tag and/or (2) a signal indicative that no sample holder is present;
   if RFID data is received by at least one of the RFID antennas, generate at least one of (1) a signal indicative that the sample holder contains a sample holder RFID tag and/or (2) a signal indicative of an orientation of the sample holder; and
   if RFID data is received by both of the RFID antennas, generate (1) a signal indicative that the sample holder contains two sample holder RFID tags and/or (2) a signal indicative that two sample holders with sample a holder RFID tag are present.

60. The biological analysis system of 59, wherein the orientation of the sample holder is based on the strength of the data or signal from the RFID tag.

61. The biological analysis system of any of 58-60, wherein the memory comprises instructions to:
receive from a user an initial user input comprising at least one of (1) an input to load or receive a sample holder into the system or (2) an input to initiate an assay;
read at least some of the RFID data;
based at least in part on the read RFID data, generate an assay protocol;
after receiving the initial user input, either (1) execute the assay protocol to perform an assay without any further input or intervention from the user until the assay is completed or (2) modify the assay protocol based on additional input and then execute the modified assay protocol to perform an assay without any further input or intervention from the user until the assay is completed.

62. The biological analysis system of 61, further comprising a reagent container comprising a reagent container RFID tag, wherein the memory comprises instructions to read information from the reagent container RFID tag and, based at least in part on the information from the reagent container RFID tag, generate the assay protocol.

63. The biological analysis system of any of 58-62, wherein the memory comprises instructions to:

prior to performing an assay, confirm or validate the assay protocol using an alternative data source and, if the alternative data source differs from RFID data, then perform at least one of modify the assay protocol, send an alert, or abort the assay protocol.

64. The biological analysis system of any of 58-63, wherein the memory comprising one or more of instructions to:
write over at least a portion of the RFID data using the at least one RFID writer;
encrypt at least a portion of the RFID data using the at least one RFID writer;
erase at least a portion of the RFID data using the at least one RFID writer;
generate a signal indicating the completion of an assay or run;
modify data produced during or after completion of an assay; or
analyze data produced during or after completion of an assay.

65. A method for performing a biological analysis comprising:
providing a biological analysis system comprising:
   a housing;
   a sample block disposed within the housing and configured to receive a sample holder comprising a sample holder RFID tag;
   a first RFID antenna configured during use to receive RFID data from the sample holder RFID tag; and
   at least one RFID reader configured to receive the RFID data from the first RFID antenna;
placing a sample holder into or onto the biological analysis system;
receiving from a user an initial user input to initiate an assay;
reading at least some of the RFID data using the first RFID antenna;
generating instructions to perform an assay based at least in part on the read RFID data;
after receiving the initial user input, executing a set of steps to perform an assay on the sample holder without any further input or intervention from the user until the assay is completed or (2) receiving additional input and then executing a set of steps to perform an assay on the sample holder without any further input or intervention from the user until the assay is completed.

66. The method of 65, further comprising:
providing a reagent container comprising a reagent container RFID tag;
reading information from the reagent container RFID tag; and
based at least in part on the information read from the reagent container RFID tag, generating the assay protocol.

67. A method for performing a biological analysis comprising:
providing a biological analysis system comprising:
   a housing;
   a sample block disposed within the housing;
   a first RFID antenna;
   a second RFID antenna; and
   at least one RFID reader configured to receive the RFID data from the first RFID antenna and from the second RFID antenna;
placing a sample holder in or on the sample block, the sample holder possibly comprising a sample holder RFID tag;
verify whether at least one of the first RFID antenna or the second RFID antenna is(are) receiving RFID data or signal from the sample holder;
perform at least one of:
   if no RFID data is received by either the first RFID antenna or the second RFID antenna, generating (1) a signal indicative that the sample holder does not contain an RFID tag and/or (2) a signal indicative that no sample holder is present;
   if RFID data is received by at least one of the RFID antennas, generating at least one of (1) a signal indicative that the sample holder contains a sample holder RFID tag and/or (2) a signal indicative of an orientation of the sample holder; and
   if RFID data is received by both of the RFID antennas, generating (1) a signal indicative that the sample holder contains two sample holder RFID tags and/or (2) a signal indicative that two sample holders with sample a holder RFID tag are present.

68. The method of any of 65-67, further comprising:
receiving from a user an initial user input comprising at least one of (1) an input to load or receive a sample holder into the system or (2) an input to initiate an assay;
reading at least some of the RFID data;
based on the RFID data read, generating an assay protocol;
after receiving the initial user input, either (1) executing the assay protocol to perform an assay without any further input or intervention from the user until the assay is completed or (2) modifying the assay protocol based on additional input and then executing the modified assay protocol to perform an assay without any further input or intervention from the user until the assay is completed.

69. The method of any of 65-68, further comprising:

prior to performing an assay, confirming or validating the assay protocol using an alternative data source and, if the alternative data source differs from RFID data, then performing at least one of modifying the assay protocol, sending an alert, or aborting the assay protocol.

70. The method of any of 65-69, further comprising:
writing over at least a portion of the RFID data using the at least one RFID writer;
encrypting at least a portion of the RFID data using the at least one RFID writer;
erasing at least a portion of the RFID data using the at least one RFID writer;
generating a signal indicating the completion of an assay or run;
modifying data produced during or after completion of an assay; or
analyzing data produced during or after completion of an assay.

71. The method of any of 65-70, writing information generated during a first assay on the sample holder RFID tag and optionally using the written information to analyze data obtained during the first assay.

72. The method of any of 65-71, wherein the first assay is a PCR assay.

73. The method of 72, wherein the sample holder comprises a temperature sensor, the method further comprises recording a temperature of the sample holder over one or more thermal cycles of the PCR assay.

74. A biological analysis system comprising:
a housing;
a sample block disposed within the housing and configured to receive a sample holder comprising a sample holder RFID tag;
an RFID antenna configured during use to receive RFID data from the sample holder RFID tag;
an RFID reader configured to receive the RFID data from the first RFID antenna;
wherein the RFID antenna is spatially separated from the RFID reader.

75. The biological analysis system of 74, wherein the RFID antennas communicate with the at least one RFID reader via an electrical wire or electrical cable.

76. The biological analysis system of any of 74-75, wherein the first RFID antenna is disposed proximal one side of the sample block and the second RFID antenna is disposed proximal a different side of the sample block.

77. The biological analysis system of any of 74-76, wherein the first RFID antenna is disposed proximal one side of the sample block and the second RFID antenna is disposed proximal an opposite side of the sample block.

78. The biological analysis system of any of 74-76, wherein the sample block has an uppermost surface, the at least one RFID reader is(are) disposed below the uppermost surface, and the RFID antennas are disposed above the uppermost surface.

79. The biological analysis system of any of 74-77, wherein the memory comprises instructions to:
verify whether the RFID antenna is receiving RFID data or signal; perform at least one of:
   if no RFID data or signal is received by the RFID antenna generate (1) a signal indicative that the sample holder does not contain an RFID tag and/or (2) a signal indicative that no sample holder is present;
   if RFID data is received by the RFID antenna, generate at least one of (1) a signal indicative that the sample holder contains a sample holder RFID tag and/or (2) a signal indicative of an orientation of the sample holder; or
   if RFID data is received by the RFID antenna, generate (1) a signal indicative that the sample holder contains two sample holder RFID tag or (2) a signal indicative that two sample holders with sample a holder RFID tag are present.

80. The biological analysis system of 79, wherein the orientation of the sample holder is based on the strength of the data or signal from the RFID tag.

81. A sample holder for a biological analysis, comprising:
a holder comprising a plurality of spatially separated reaction locations, each of the plurality of spatially separated reaction locations comprising a plurality of characteristics;
a sample holder RFID tag disposed in or on the sample holder, the sample holder RFID tag including RFID data comprising data for the plurality of characteristics each of the reaction location;
wherein the RFID data comprises at least 8 kilobytes, at least 64 kilobytes, or at least 128 kilobytes.

82. The sample holder of 81, wherein the plurality of spatially separated reaction locations comprises at least 96 reaction locations, at least 384 reaction locations, at least 1536 reaction locations, at least 3072 reaction locations, or at least 12,288 reaction locations.

83. The sample holder of any of 81-82, wherein the RFID data on the sample holder RFID comprises one or more of:
sample holder ID;
sample holder expiration date;
sample holder part number;
sample holder barcode;
sample holder lot number;
sample holder type;
storage temperature and/or storage temperature range;
sample concentration - recommended range; provision for E1 pipette support?
sales order number;
assay name(s) and/or locations on sample holder;
assay IDs;
suggested protocol or required protocol;
sample name(s)
master mix name(s);
master mix change(s);
dye name(s);
suggested or required filter or set of filters to be used during an assay on the sample holder;
EDT file format and/or EDF file format;
internet links or addresses;
passive reference dye(s);
reaction volume(s);
target name(s);
dye name(s);
sample name(s);
analysis settings;
flag setting(s);
sample type(s);
target type(s);
reagent name;
run protocol(s) comprising one or more of a heated cover temperature, reaction volume(s), temperature step value(s), temperature stage value(s);
well information for one or more wells, the information including one or more of target name, dye name, or sample name.

84. The sample holder of any of 83, wherein the plate type is characterized by 48, 96, 384, 1536, or 3072 wells or through-holes

85. The sample holder of any of 83-84, wherein the plate type is characterized by wells having a volume of 0.1 milliliters or 0.2 milliliters.

86. The sample holder of any of 83-85, wherein the RFID data on the sample holder RFID include re-writeable data comprising one or more of:
passive reference dye(s);
reaction volume(s);
target name(s);
dye name(s);
sample name(s);
analysis settings;
flag setting(s);
sample type(s);
target type(s);
reagent name;
run protocol(s) comprising one or more of a heated cover temperature, reaction volume(s), temperature step value(s), temperature stage value(s);
well information for one or more wells, the information including one or more of target name, dye name, or sample name.

87. The sample holder of any of 81-86, wherein the sample holder comprises a sensor.

88. The sample holder of 87, wherein the sensor is in communication with the sample holder RFID tag.

89. The sample holder of any of 87-88, wherein the sensor comprises one or more of the thermal sensor, an accelerometer, a shock sensor, a photo sensor, a light detector.

90. The sample holder of any of 87-89, wherein information from the sensor is written to the sample holder RFID tag at least one time over the life of the sample holder.

91. The sample holder of any of 87-90, wherein the sensor is a temperature sensor, the sample holder is configured for use in a PCR assay, and the sample holder RFID tag is configured to record temperatures of the sample holder over one or more thermal cycles during the PCR assay.

92. A biological analysis system comprising:
a housing;
a sample block disposed within the housing;
the sample holder of any of 81-91, the sample holder disposed in or on the sample block;
an RFID antenna configured during use to receive RFID data from the sample holder RFID tag;
an RFID reader configured to receive the RFID data from the first RFID antenna.

93. The biological analysis system of 92, wherein an RFID writer is configured to write assay information generated during an assay onto the sample holder RFID tag and, optionally, the system is configured to use the assay information to analyze data obtained during the assay.

94. A biological analysis system comprising:
a housing;
a block assembly comprising a sample block and a base configured to receive the sample block;
a first drive mechanism configured to generate relative movement between the sample block and the housing along a first axis between a closed position to an open position;
a lock configured to lock the sample block to the base;
a processor and a memory coupled to the processor, the memory including instructions to:
   based on a first command, operate the lock to provide a locked position in which the sample block is locked to the tray;
   based on a second command, operate the lock to provide an unlocked position in which the sample block is not locked to the tray;
   move the sample block and the base from a closed position to an open position with the lock in either the locked position or the unlocked position.

95. The biological analysis system of 79, wherein at least one of the commands is provided by a user of the biological analysis system.

96. A method for biological analysis comprising:
providing a system comprising:
   a sample block;
   a base configured to receive the sample block;
   a heated cover configured to be placed over the sample block;
   a carrier configured to receive the heated cover;
   a processor and a memory coupled to the processor, the memory including instructions to move the sample block and base between an open position and a closed position;
attaching the heated cover to the carrier;
separating the heated cover from the sample block by lifting the carrier;
using the drive mechanism, moving the sample block and the base from the closed position to the open position;
placing a sample plate in the sample block;
using the drive mechanism, moving the sample block from the open position to the closed position;
placing the heated cover onto the sample block by lowering the carrier.;

97. A method for biological analysis comprising:
providing a system comprising:
   a sample block;
   a base configured to receive the sample block;
   a heated cover configured to be placed over the sample block;
   a carrier configured to engage the heated cover using an engagement apparatus;
   a processor and a memory coupled to the processor, the memory including instructions to move the sample block and base between an open position and a closed position;
detaching the carrier from the first heated cover; grab separating the first heated cover from the carrier by lifting the carrier;
using the drive mechanism, moving the first sample block and the first heated cover from a closed position to an open position;
providing a second block configuration by replacing at least one of the first sample block with a second sample block or the first heated cover with a second heated cover.

98. The method of 82, wherein the engagement apparatus comprises a one or more gripper arms disposed on opposite sides of the carrier.

99. The method of any of 82-83, further comprising:
optionally placing a sample plate in the sample block;
using the drive mechanism, moving the sample block from the open position to the closed position;
lowering the carrier;
locking the carrier to the heated cover using the gripper arms;
performing a qPCR assay;
retracting the heated cover from the sample block by lifting the carrier.

100. A biological analysis instrument comprising:
a proximity sensor configured determine the presence or distance of a perspective user of the instrument;
an activation and/or recognition system comprising at least one of a voice activation and/or recognition system or a face activation and/or recognition system;
a processor and a memory coupled to the processor, the memory including instructions to:
   query the activation and/or recognition system to produce a first output;
   determine whether the first output meets one or more first predetermined criteria;
   query the proximity sensor to produce a second output;
   determine whether the second output meets one or more second predetermined criteria;
   start, power up, or activate the instrument if both (1) the first output meets the one or more first predetermined criteria and (2) the second output meets one or more second predetermined criteria.

101. A method of starting, powering up, or activating biological analysis instrument comprising:
querying an activation and/or recognition system to produce a first output, the activation and/or recognition system comprising one or more of a voice activation and/or recognition system or a face activation and/or recognition system;
determining whether the first output meets one or more first predetermined criteria;
querying a proximity sensor to produce a second output;
determining whether the second output meets one or more second predetermined criteria;
starting, powering up, or activating the instrument if both (1) the first output meets the one or more first predetermined criteria and (2) the second output meets one or more second predetermined criteria.

102. A method of starting, powering up, or activating biological analysis instrument comprising:
querying an activation and/or recognition system to produce a first output, the activation and/or recognition system comprising one or more of a voice activation and/or recognition system or a face activation and/or recognition system;
determining whether the first output meets one or more first predetermined criteria;
querying a proximity sensor to produce a second output;
determining whether the second output meets one or more second predetermined criteria;
starting, powering up, or activating the instrument if both (1) the first output meets the one or more first predetermined criteria and (2) the second output meets one or more second predetermined criteria.

103. A biological analysis system, comprising:
one or more of a carrier, base, or tray configured to interchangeably receive (1) a first block and a corresponding first cover placed over the first block or (2) a second block and a corresponding second cover placed over the second block;
a computer readable memory comprising instructions for detecting when the second cover is placed over the first block and/or for detecting when the first cover is placed over the second block based on lack of electrical continuity along an electrical path comprising one of the blocks and one of the covers.

104. A biological analysis system of 103, wherein the memory further comprises instruction for one or more of:
sending a message or an alarm when the second cover is placed over the first block and/or when the first cover is placed over the second block;
preventing the carrier, base, or tray from being received by the analysis system;
preventing the system from conducting a biological assay.

105. A biological analysis system of 104, wherein:
the first block is configured to receive a sample holder comprising a biological sample and comprises a first block connector including a first block connector element in electrical communication with a first block electrical conductor;
the first cover comprises a first cover connector including a first cover connector element in electrical communication with a first cover electrical conductor;
the second block is configured to receive a sample holder comprising a biological sample and comprises a second block connector including a second block connector element in electrical communication with a second block electrical conductor;
the second cover comprises a second cover connector including a second cover connector element in electrical communication with a second cover electrical conductor; wherein:
   the first cover connector is configured to engage the first block connector to provide electrical continuity between the first block electrical conductor and the first cover electrical conductor;
   the second cover connector is configured to engage the second block connector to provide electrical continuity between the second block electrical conductor and the second cover electrical conductor; and
   at least one of (1) the first block connector is configured to engage the second cover connector to provide electrical isolation or lack of electrical continuity between the first block electrical conductor and the second cover electrical conductor or (2) the second block connector is configured to engage the first cover connector to provide electrical isolation or lack of electrical continuity between the second block electrical conductor and the first cover electrical conductor.

106. A biological analysis system, comprising:
a first block configured to receive a sample holder comprising a biological sample, the first block comprising a first block connector including a first block connector element in electrical communication with a first block electrical conductor;
a first cover configured to cover the first block, the first cover comprising a first cover connector including a first cover connector element in electrical communication with a first cover electrical conductor;
a second block configured to receive a sample holder comprising a biological sample, the second block comprising a second block connector including a second block connector element in electrical communication with a second block electrical conductor;
a second cover configured to cover the second block, the second cover comprising a second cover connector including a second cover connector element in electrical communication with a second cover electrical conductor; wherein:
   the first cover connector is configured to engage the first block connector to provide electrical continuity between the first block electrical conductor and the first cover electrical conductor;
   the second cover connector is configured to engage the second block connector to provide electrical continuity between the second block electrical conductor and the second cover electrical conductor; and
   at least one of (1) the first block connector is configured to engage the second cover connector to provide electrical isolation between the first block electrical conductor and the second cover electrical conductor or (2) the second block connector is configured to engage the first cover connector to provide electrical isolation between the second block electrical conductor and the first cover electrical conductor.

107. The system of any one of 105 to 106, further comprising a sample holder disposed on or in at least one of the blocks.

108. The system of any one of 105 to 107, at least one of the blocks comprises a wavy spring disposed on a surface of the at least one of the blocks and configured to apply a force to the sample holder in a direction away from the at least one of the blocks.

109. The system of any one of 105 to 108, wherein one or more of the connector elements is an electrically conductive pin, electrically conductive boss, electrically conductive wire or cable end, or connector element.

110. The system of any one of 105 to 109, wherein one or more of the electrical conductors comprises at least one of an electrical wire, an electrical cable, or at least a portion of an electrical circuit.

111. The system of any one of 105 to 110, wherein at least one of:
the first block connector comprises a first block cavity and the first cover connector comprises a first projecting portion configured to fit at least partially inside the first block cavity; or
the second block connector comprises a second block cavity and the second cover connector comprises a second projecting portion configured to fit inside the second block cavity.

112. The system of 111, wherein at least one of the projecting portions is a boss.

113. The system of any one of 111 to 112, wherein:
the first projecting portion comprises a first annulus having a first inner volume containing the first cover connector element;
the first block cavity comprises the first block connector element;
the second projecting portion comprises a second annulus including a slotted, grooved, and/or cutout wall portion and a second inner volume containing the second cover connector element;
the second block cavity comprises a crossmember configured to fit inside the slotted, grooved, and/or cutout portion and the second block connector element.

114. The system of 113, wherein the crossmember and the second block connector element form a single piece.

115. The system of any one of 113 to 114, wherein the second annulus includes two slotted, grooved, and/or cutout wall portions located about 180 degrees apart about a circumference of the second annulus.

116. The system of any one of 113 to 115, wherein:
the first cover connector element is recessed within the first annulus of the first projecting portion by a first distance;
the second block connector element protrude away from the crossmember by a second distance that is less than the first distance.

117. The system of any one of 113 to 116, wherein:
the second cover connector element is recessed within the second annulus of the first projecting portion by a third distance;
the first block connector element protrudes away from a floor of the first block cavity by a fourth distance that is less than the third distance.

118. The system of any one of 105 to 110, further comprising:
the first block comprises a first auxiliary block connector including a first auxiliary block connector element in electrical communication with a first auxiliary block electrical conductor;
the first cover comprises a first cover auxiliary connector including a first cover auxiliary connector element in electrical communication with a first cover auxiliary electrical conductor;
the second block comprises a second block auxiliary connector including a second block auxiliary connector element in electrical communication with a second block auxiliary electrical conductor;
the second cover comprising a second cover auxiliary connector including a second cover auxiliary connector element in electrical communication with a second cover auxiliary electrical conductor; wherein:
   the first cover auxiliary connector is configured to engage the first block auxiliary connector to provide electrical continuity between the first block auxiliary electrical conductor and the first cover auxiliary electrical conductor;
   the second cover auxiliary connector is configured to engage the second block auxiliary connector to provide electrical continuity between the second block auxiliary electrical conductor and the second cover auxiliary electrical conductor; and
   optionally, at least one of (1) the first block auxiliary connector is configured to engage the second cover auxiliary connector to provide electrical isolation between the first block auxiliary electrical conductor and the second auxiliary cover electrical conductor or (2) the second block auxiliary connector is configured to engage the first cover auxiliary connector to provide electrical isolation between the second auxiliary block auxiliary electrical conductor and the first cover auxiliary electrical conductor.

119. The system of 118, wherein at least one of:
the first block connector comprises a first block cavity and the first cover connector comprises a first projecting portion configured to fit at least partially inside the first block cavity;
the second block connector comprises a second block cavity and the second cover connector comprises a second projecting portion configured to fit inside the second block cavity;
the first block auxiliary connector comprises a first block auxiliary cavity and the first cover auxiliary connector comprises a first auxiliary projecting portion configured to fit at least partially inside the first block auxiliary cavity; or
the second block auxiliary connector comprises a second block auxiliary cavity and the second cover auxiliary connector comprises a second auxiliary projecting portion configured to fit inside the second block auxiliary cavity.

120. The system of 119, wherein:
the first projecting portion comprises a first annulus having a first inner volume containing the first cover connector element;
the first block cavity comprises the first block connector element
the second projecting portion comprises a second annulus including a slotted, grooved, and/or cutout wall portion and a second inner volume containing the second cover connector element;
the second block cavity comprises a crossmember configured to fit inside the slotted, grooved, and/or cutout portion and the second block connector element;
the first auxiliary projecting portion comprises a first auxiliary annulus having a first auxiliary inner volume containing the first cover auxiliary connector element;
the first block auxiliary cavity comprises the first block auxiliary connector element;
the second auxiliary projecting portion comprises a second auxiliary annulus including an auxiliary slotted, grooved, and/or cutout wall portion and a second auxiliary inner volume containing a second cover auxiliary connector element;
the second block cavity comprises an auxiliary crossmember configured to fit inside the auxiliary slotted, grooved, and/or cutout portion and the second block auxiliary connector element;

121. The system of 120, wherein the second block cavity and the second auxiliary projecting portion of the second cover produce electrical isolation or lack of electrical continuity between the second block electrical conductor and the second cover auxiliary electrical conductor when the orientation of the second cover relative to the second block does not match a predetermined or intended orientation of the second cover relative to the second block.

122. The system of 121, wherein the orientation of the second cover relative to the second block is rotated 180 degrees from the predetermined or intended orientation of the second cover relative to the second block.

123. The system of any one of 120 to 122, wherein:
the crossmember of the second block cavity is disposed along a first axis;
the auxiliary crossmember of the second block auxiliary cavity is disposed along a second axis that is oriented at a different angle than the first axis;
the slotted, grooved, and/or cutout wall portion of the annulus of the second projecting member is disposed about a ring of the annulus along the first axis;
the auxiliary slotted, grooved, and/or cutout wall portion of the auxiliary annulus of the second auxiliary projecting member is disposed about a ring of the annulus along the second axis;

124. The system of 123, wherein the second axis is orthogonal or approximately orthogonal to the first axis.

125. The system of any one of 113 to 124, wherein:
the first annulus comprises a slotted, grooved, and/or cutout wall portion;
the first block cavity comprises a crossmember configured to fit inside the slotted, grooved, and/or cutout portion of the first annulus.

126. The system of any one of 120 to 124, wherein:
the first annulus comprises a slotted, grooved, and/or cutout wall portion;
the first block cavity comprises a crossmember configured to fit inside the slotted, grooved, and/or cutout portion of the first annulus;
the first auxiliary annulus including an auxiliary slotted, grooved, and/or cutout wall portion;
the first block cavity comprises an auxiliary crossmember configured to fit inside the slotted, grooved, and/or cutout portion of the first annulus.

127. The system of 126, wherein:
the crossmember of the first block cavity is disposed along a third axis;
the auxiliary crossmember of the first block auxiliary cavity is disposed along a fourth axis that is oriented at a different angle than the third axis;
the slotted, grooved, and/or cutout wall portion of the annulus of the first projecting member is disposed about a ring of the annulus along the third axis;
the auxiliary slotted, grooved, and/or cutout wall portion of the auxiliary annulus of the first auxiliary projecting member is disposed about a ring of the annulus along the fourth axis;

128. The system of 127, wherein the fourth axis is orthogonal or approximately orthogonal to the third axis.

129. The system of any one of 105 to 110, wherein at least one of:
the first cover connector comprises a first cover cavity and the first block connector comprises a first projecting portion configured to fit at least partially inside the first cover cavity; or
the second cover connector comprises a second cover cavity and the second block connector comprises a second projecting portion configured to fit inside the second cover cavity.

130. The system of 129, wherein at least one of the projecting portions is a boss.

131. The system of any one of 129 to 130, wherein:
the first projecting portion comprises a first annulus having a first inner volume containing the first block connector element;
the first cover cavity comprises the first cover connector element;
the second projecting portion comprises a second annulus including a slotted, grooved, and/or cutout wall portion and a second inner volume containing the second block connector element;
the second cover cavity comprises a crossmember configured to fit inside the slotted, grooved, and/or cutout portion and the second cover connector element.

132. The system of 131, wherein the crossmember and the second cover connector element form a single piece.

133. The system of any one of 113 to 132, wherein the second annulus includes two slotted, grooved, and/or cutout wall portions located about 180 degrees apart about a circumference of the second annulus.

134. The system of any one of 113 to 133, wherein:
the first block connector element is recessed within the first annulus of the first projecting portion by a first distance;
the second cover connector element protrude away from the crossmember by a second distance that is less than the first distance.

135. The system of any one of 113 to 134, wherein:
the second block connector element is recessed within the second annulus of the first projecting portion by a third distance;
the first cover connector element protrudes away from a floor of the first cover cavity by a fourth distance that is less than the third distance.

136. The system of any one of 105 to 110, further comprising:
the first cover comprises a first auxiliary cover connector including a first auxiliary cover connector element in electrical communication with a first auxiliary cover electrical conductor;
the first block comprises a first block auxiliary connector including a first block auxiliary connector element in electrical communication with a first block auxiliary electrical conductor;
the second cover comprises a second cover auxiliary connector including a second cover auxiliary connector element in electrical communication with a second cover auxiliary electrical conductor;
the second block comprising a second block auxiliary connector including a second block auxiliary connector element in electrical communication with a second block auxiliary electrical conductor; wherein:
   the first block auxiliary connector is configured to engage the first cover auxiliary connector to provide electrical continuity between the first cover auxiliary electrical conductor and the first block auxiliary electrical conductor;
   the second block auxiliary connector is configured to engage the second cover auxiliary connector to provide electrical continuity between the second cover auxiliary electrical conductor and the second block auxiliary electrical conductor; and
   optionally, at least one of (1) the first cover auxiliary connector is configured to engage the second block auxiliary connector to provide electrical isolation between the first cover auxiliary electrical conductor and the second auxiliary block electrical conductor or (2) the second cover auxiliary connector is configured to engage the first block auxiliary connector to provide electrical isolation between the second auxiliary cover auxiliary electrical conductor and the first block auxiliary electrical conductor.

137. The system of 136, wherein at least one of:
the first cover connector comprises a first cover cavity and the first block connector comprises a first projecting portion configured to fit at least partially inside the first cover cavity;
the second cover connector comprises a second cover cavity and the second block connector comprises a second projecting portion configured to fit inside the second cover cavity;
the first cover auxiliary connector comprises a first cover auxiliary cavity and the first block auxiliary connector comprises a first auxiliary projecting portion configured to fit at least partially inside the first cover auxiliary cavity; or
the second cover auxiliary connector comprises a second cover auxiliary cavity and the second block auxiliary connector comprises a second auxiliary projecting portion configured to fit inside the second cover auxiliary cavity.

138. The system of 137, wherein:
the first projecting portion comprises a first annulus having a first inner volume containing the first block connector element;
the first cover cavity comprises the first cover connector element;
the second projecting portion comprises the second annulus including a slotted, grooved, and/or cutout wall portion and a second inner volume containing a second block connector element;
the second cover cavity comprises a crossmember configured to fit inside the slotted, grooved, and/or cutout portion and the second cover connector element;
the first auxiliary projecting portion comprises a first auxiliary annulus having a first auxiliary inner volume containing the first block auxiliary connector element;
the first cover auxiliary cavity comprises the first cover auxiliary connector element;
the second auxiliary projecting portion comprises a second auxiliary annulus including an auxiliary slotted, grooved, and/or cutout wall portion and a second auxiliary inner volume containing the second block auxiliary connector element;
the second cover cavity comprises an auxiliary crossmember configured to fit inside the auxiliary slotted, grooved, and/or cutout portion and the second cover auxiliary connector element.

139. The system of 138, wherein the second cover cavity and the second auxiliary projecting portion of the second block produce electrical isolation or lack of electrical continuity between the second cover electrical conductor and the second block auxiliary electrical conductor when the orientation of the second block relative to the second cover does not match a predetermined or intended orientation of the second block relative to the second cover.

140. The system of 139, wherein the orientation of the second block relative to the second cover is rotated 180 degrees from the predetermined or intended orientation of the second block relative to the second cover.

141. The system of any one of 138 to 140, wherein:
the crossmember of the second cover cavity is disposed along a first axis;
the auxiliary crossmember of the second cover auxiliary cavity is disposed along a second axis that is oriented at a different angle than the first axis;
the slotted, grooved, and/or cutout wall portion of the annulus of the second projecting member is disposed about a ring of the annulus along the first axis;
the auxiliary slotted, grooved, and/or cutout wall portion of the auxiliary annulus of the second auxiliary projecting member is disposed about a ring of the annulus along the second axis;

142. The system of 123, wherein the second axis is orthogonal or approximately orthogonal to the first axis.

143. The system of any one of 113 to 141, wherein:
the first annulus comprises a slotted, grooved, and/or cutout wall portion;
the first cover cavity comprises a crossmember configured to fit inside the slotted, grooved, and/or cutout portion of the first annulus.

144. The system of any one of 138 to 141, wherein:
the first annulus comprises a slotted, grooved, and/or cutout wall portion;
the first cover cavity comprises a crossmember configured to fit inside the slotted, grooved, and/or cutout portion of the first annulus;
the first auxiliary annulus including an auxiliary slotted, grooved, and/or cutout wall portion;
the first cover cavity comprises an auxiliary crossmember configured to fit inside the slotted, grooved, and/or cutout portion of the first annulus.

145. The system of 144, wherein:
the crossmember of the first cover cavity is disposed along a third axis;
the auxiliary crossmember of the first cover auxiliary cavity is disposed along a fourth axis that is oriented at a different angle than the third axis;
the slotted, grooved, and/or cutout wall portion of the annulus of the first projecting member is disposed about a ring of the annulus along the third axis;
the auxiliary slotted, grooved, and/or cutout wall portion of the auxiliary annulus of the first auxiliary projecting member is disposed about a ring of the annulus along the fourth axis;

146. The system of 145, wherein the fourth axis is orthogonal or approximately orthogonal to the third axis.

147. The system of any one of 103 to 146, wherein the system comprises a system configured to perform one or more of a polymerase chain reaction (PCR) assay, experiment, or test, a real-time PCR assay, experiment, or test, a digital PCR assay, experiment, or test, an DNA amplification assay, experiment, or test, a sequencing assay, experiment, or test, a flow cytometry assay, experiment, or test, or a capillary electrophoresis assay, experiment, or test.

148. A method of conducting a biological assay using a biological analysis system, the method comprising:
placing one of a first block or a second block in or on a carrier, base, or tray;
optionally placing in or on the carrier, base, or tray a sample holder comprising a biological sample;
placing a run cover over the received first block or second block, wherein at least one of:
   the first block comprises a first block connector including a first block connector element in electrical communication with a first block electrical conductor and the first cover comprises a first cover connector including a first cover connector element in electrical communication with a first cover electrical conductor; and/or
   the second block comprises a first block connector including a first block connector element in electrical communication with a second block electrical conductor and the second cover comprises a second cover connector including a second cover connector element in electrical communication with a second cover electrical conductor;
performing a continuity check;
based on the continuity check, confirming at least one of:
   (a) the run cover is the first cover if the first base is in or on the carrier, base, or tray;
   (b) the run cover is the second cover if the second base is in or on the carrier, base, or tray;
   (c) the run cover is not the first cover if the first base is in or on the carrier, base, or tray;
   (d) the run cover is not the second cover if the second base is in or on the carrier, base, or tray;
if (a) or (b) is confirmed, at least one of:
   loading or transporting the placed block and tray into or on the biological analysis system;
   providing a signal or message that the base and cover are suitable for running a biological analysis or assay;
   running a biological analysis or assay using the biological analysis system;
if (c) or (d) is confirmed, at least one of:
   discontinuing the method;
   providing a message, signal, or alarm that the base and cover are not suitable;
   providing a message, signal, or alarm to change at least one of the cover or the block;
   loading or transporting the placed block and tray into or on the biological analysis system, but not running a biological analysis or assay.

149. The method of 148, wherein the biological analysis system comprises a polymerase chain reaction (PCR) assay, experiment, or test, a real-time PCR assay, experiment, or test, a digital PCR assay, experiment, or test, an DNA amplification assay, experiment, or test, a sequencing assay, experiment, or test, a flow cytometry assay, experiment, or test, or a capillary electrophoresis assay, experiment, or test.

150. A method of aligning a sample block of a biological analysis system, comprising:
loosening a moveable portion of a block from a fixed portion of the block;
placing an alignment fixture on the block;
locating the block in an instrument;
performing a scan over of at least one reaction location of the fixture;
locating the moveable portion to an aligned position based on scan;
optionally, securing the moveable portion to the fixed portion;
confirming the alignment by scanning over of the at least one reaction location of the fixture:
optionally, removing the fixture from the block.

151. The method of 150, wherein:
the alignment fixture comprises one or more openings or wells in a top surface of the alignment fixture corresponding to the a respective one or more openings in a cover
one or more of the wells comprises a smaller opening located at a bottom of the well.

152. The method of 150 or 151, wherein the one or more wells further comprise a reflective or optically active material within or at the bottom of the opening

152 The method any one of 150-152, wherein the openings comprise an elongated opening or slit that is at a location to which the sample block is to be aligned.

152 The method any one of 150-153, wherein opening are centered within the well or are disposed at a different alignment location.

It will be appreciated by a person skilled in the art that numerous variations and/or modifications may be made to the present disclosure as shown in the specific embodiments without departing from the scope of the present disclosure as broadly described. The present embodiments are, therefore, to be considered in all respects to be illustrative and not restrictive.

1. A biological analysis system comprising:
a sample block configured to hold a biological sample and a base configured to hold the sample block, the sample block comprising a first connector;
a first driver 502 comprising a second connector;
a cover disposed to cover the sample block and a cover carrier configured to hold the cover, the cover comprising a third connector;
a second driver 712 comprising a fourth connector;
a controller communicatively coupled to the first driver and to the second driver, the controller configured to:
align the cover and/or the sample block to the cover carrier using the second driver 712;
engage the third connector with the fourth connector using the second driver 712;
engage the first connector with the second connector using the first driver 502; and
secure and/or lock the sample block to the base using the first driver 502.

2. The system as claimed in claim 1, wherein the connectors are electrical connectors configured to provide electrical power and/or communication between the system and the sample block and between the system and the cover.

3. The system as claimed in claims 1 or 2, further comprising:
a third driver 810, the controller being communicatively coupled to the third driver;
wherein the controller is configured to secure and/or lock cover to the cover carrier using the third driver.

4. The system as claimed in claim 3, wherein the controller is configured to:
disengage the cover from the cover carrier using the third driver 810; and
disengage the third electrical connector from the fourth electrical connector using the second driver 712 to separate the cover carrier from the cover.

5. The system as claimed in claims 1-4, wherein the controller is configured to disengage the third electrical connector from the fourth electrical connector using the third driver 810 by moving a linkage from a first position to release the cover from the cover carrier to a second position to separate the third electrical connector from the fourth electrical connector.

6. A biological analysis system comprising:
a sample block configured to hold a biological sample and a base configured to hold the sample block, the sample block comprising a first connector;
a first driver comprising a second connector;
a controller communicatively coupled to the first driver, the controller configured to:
engage the first connector with the second connector using the first driver; and
secure and/or lock the sample block to the base using the first driver.

7. The system as claimed in claim 6, wherein the connectors are electrical connectors configured to provide electrical power and/or communication between the system and the sample block.

8. A biological analysis system comprising:
a sample block configured to hold a biological sample;
a cover disposed to cover the sample block and a cover carrier configured to hold the cover, the cover comprising a first connector;
a first driver 712 comprising a second connector;
a controller communicatively coupled to the first driver, the controller configured to:
align the cover and/or the sample block to the cover carrier using the first driver 712; and
engage the first connector with the second connector using the first driver 712.

9. The system as claimed in claim 8, wherein the connectors are electrical connectors configured to provide electrical power and/or communication between the system and the cover.

10. The system as claimed in claims 8 or 9, further comprising:
a second driver 810, the controller being communicatively coupled to the second driver;
wherein the controller is configured to secure and/or lock cover to the cover carrier using the second driver.

11. The system as claimed in claim 10, wherein the controller is configured to:
disengage the cover from the cover carrier using the second driver 810; and
disengage the first electrical connector from the second electrical connector using the first driver 712 to separate the cover carrier from the cover.

12. The system as claimed in claims 8-11, wherein the controller is configured to disengage the third electrical connector from the fourth electrical connector using the third driver 810 by moving a linkage from a first position to release the cover from the cover carrier to a second position to separate the third electrical connector from the fourth electrical connector.

13. The system as claimed in claims 1-12, wherein the cover is a heated cover.

14. A biological analysis system comprising:
a sample block and a base configured to hold the sample block;
a heated cover and a cover carrier configured to hold the heated cover;
a first drive mechanism configured to engage the sample block;
a second drive mechanism configured to engage the heated cover; and
a controller communicatively coupled to the first and second drive mechanisms,
wherein the controller is configured to, based on a first command, automatically operate the first drive mechanism to releasably engage the sample block with the base, and automatically operate the second drive mechanism to releasably engage the heated cover with the cover carrier.

15. The system as claimed in claim 14, wherein the controller is configured to, based on a second command, automatically operate the first drive mechanism to disengage the sample block from the base, and automatically operate the second drive mechanism to disengage the heated cover from the cover carrier.

16. The system as claimed in claim 14, further comprising a third drive mechanism and a fourth drive mechanism, and wherein, based on the first command, the third drive mechanism is configured to move the base and sample block to an open position and the fourth drive mechanism is configured to move the heated cover and cover carrier to a raised position.

17. The system as claimed in claim 15, wherein, based on the second command, a third drive mechanism is configured to move the base and sample block to an open position and a fourth drive mechanism is configured to move the heated cover and cover carrier to a lowered position.

18. The system as in claim 17, wherein the heated cover is disposed on top of the sample block between the closed and open positions.

19. The system as in claim 18, further comprising at least one sensor configured to determine a presence on the heated cover on top of the sample block.

20. The system as in claim 16, further comprising at least one first lock member connected to the sample block and at least one second lock member connected to the base, and wherein the first and second lock members are configured to engage with each other when the sample block engages with the base to positionally secure the sample block.

21. The system as in claim 16, further comprising a plurality of alignment pins configured to align the cover carrier with the sample block in the closed position.

22. The system as in claim 14, further comprising an optics assembly and an extendable bellow, wherein the bellow is disposed between the optics assembly and the cover carrier.

23. The system as in claim 17, wherein:
the sample block comprises a top surface including a two-dimensional array of reaction regions defining a periphery at the top surface that surround the reaction regions, the periphery comprising a pair of opposing long edges having a first length and a pair of opposing short edges having a second length that is shorter than the first length;
the sample block comprises a pair of ejector members adjacent and substantially parallel to respective ones of the long edges;
the sample block is configured to receive a sample holder
the ejector members are configured to at least partially raise the sample holder relative to the sample block when the sample block is in the open position.

24. The system as in claim 23, further comprising an RFID reader configured to read a sample holder RFID tag attached to the sample holder.

25. The system as in claim 23, further comprising a detector configured to detect a presence of the sample holder on the sample block.

26. The system as in claim 23, further comprising a double lip seal attached to a lower surface of the heated cover, wherein, in use, the double lip seal is configured to contact the sample block and sealingly surround the sample holder.

27. The system as in claim 15, wherein the first command comprises an installation command to install the sample block and heated cover, and the second command comprises a removal command to remove the sample block and heated cover.

28. The system as in claim 15, wherein the first or second command comprises one of a touch input, a keypad input, a voice command, or a gesture.

29. A method of installing a sample block and heated cover in a biological analysis system, the method comprising:
disposing a sample block and heated cover on a base;
positioning a cover carrier to engage the heated cover;
in response to a confirmation of a presence of the sample block and heated cover, automatically moving the cover carrier to engage heated cover.

30. The method as in claim 29, further comprising raising the cover carrier together with engaged the heated cover to separate heated cover from the sample block.

31. The method as in claim 29, wherein engaging the heated cover with the sample block comprises simultaneously aligning the heated cover with the sample block.

32. The method as in claim 29, wherein automatically engaging the heated cover with a cover carrier comprises moving the cover carrier toward the heated cover, and simultaneously aligning the cover carrier with the heated cover.

33. A method of removing a sample block and heated cover from a biological analysis system, the sample block supported by a base, the method comprising:
using a cover carrier, automatically lowering the heated cover onto the sample block while the sample block;
disengaging the heated cover from the cover carrier such that the heated cover is on top of the sample block; and
automatically moving the sample block together with the heated cover from a closed position to an open position; and
removing the sample block from the base of the block assembly.

34. The method as in claim 33, further comprising retrieving the sample block together with the heated cover in the open position.

35. The method as in claim 33, wherein automatically lowering the heated cover onto the sample block comprises aligning the heated cover with the sample block.

36. A biological analysis system comprising:
a housing;
a sample block disposed within the housing and configured to receive a sample holder comprising a sample holder RFID tag;
a first RFID antenna and a second RFID antenna, the RFID antennas configured during use to receive RFID data from the sample holder RFID tag;
at least one RFID reader configured to receive the RFID data from the first RFID antenna and configured to receive the RFID data from the second RFID antenna.

37. The biological analysis system as in claim 36, further comprising at least one RFID writer configured to write data on the sample holder RFID tag.

38. The biological analysis system as in any of claims 36-37, wherein the RFID antennas are spatially separated from the at least one RFID reader.

39. The biological analysis system as in claim 38, wherein the RFID antennas communicate with the at least one RFID reader via an electrical wire or electrical cable.

40. The biological analysis system as in any of claims 38-39, wherein the first RFID antenna is disposed proximal one side of the sample block and the second RFID antenna is disposed proximal a different side of the sample block.

41. The biological analysis system as in any of claims 38-40, wherein the first RFID antenna is disposed proximal one side of the sample block and the second RFID antenna is disposed proximal an opposite side of the sample block.

42. The biological analysis system as in any of claims 38-41, wherein the sample block has an uppermost surface, the at least one RFID reader is(are) disposed below the uppermost surface, and the RFID antennas are disposed above the uppermost surface.

43. The biological analysis system as in any of claims 36-42, wherein the system comprises the sample holder and the sample holder RFID tag.

44. The biological analysis system as in claim 43, wherein:
sample holder comprises a plurality of spatially separated reaction locations, each of the plurality of spatially separated reaction locations comprising a plurality of characteristics;
the sample holder RFID tag includes RFID data comprising data for the plurality of characteristics each of the reaction location;
wherein the RFID data comprises at least 8 kilobytes, at least 64 kilobytes, or at least 128 kilobytes.

45. The biological analysis system as in claim 44, wherein the plurality of spatially separated reaction locations comprises at least 96 reaction locations, at least 384 reaction locations, at least 1536 reaction locations, at least 3072 reaction locations, or at least 12,288 reaction locations.

46. The biological analysis system as in any of claims 43-45, wherein the RFID writer is configured to write assay information generated during an assay onto the sample holder RFID tag and, optionally, the system is configured to use the assay information to analyze data obtained during the assay.

47. The biological analysis system as in any of claims 43-46, wherein the plurality of characteristics comprises one or more of a:
sample holder ID;
sample holder expiration date;
sample holder part number;
sample holder barcode;
sample holder lot number;
sample holder type;
storage temperature and/or storage temperature range;
sample concentration - recommended range; provision for E1 pipette support?
sales order number;
assay name(s) and/or locations on sample holder;
assay IDs;
suggested protocol or required protocol;
sample name(s)
master mix name(s);
master mix change(s);
dye name(s);
suggested or required filter or set of filters to be used during an assay on the sample holder;
EDT file format and/or EDF file format;
internet links or addresses;
passive reference dye(s);
reaction volume(s);
target name(s);
dye name(s);
sample name(s);
analysis settings;
flag setting(s);
sample type(s);
target type(s);
run protocol(s) comprising one or more of a heated cover temperature, reaction volume(s), temperature step value(s), temperature stage value(s); or
well information for one or more wells, the information including one or more of target name, dye name, or sample name; reagent name.

48. The biological analysis system as in claim 47, wherein the plate type is characterized by 48, 96, 384, 1536, or 3072 wells or through-holes.

49. The biological analysis system as in any of claims 47-48, wherein the plate type is characterized by wells having a volume of 0.1 milliliters or 0.2 milliliters.

50. The biological analysis system as in any of claims 47-49, wherein the RFID data on the sample holder RFID include re-writeable data comprising one or more of a:
passive reference dye(s);
reaction volume(s);
target name(s);
dye name(s);
sample name(s);
analysis settings;
flag setting(s);
sample type(s);
target type(s);
run protocol(s) comprising one or more of a heated cover temperature, reaction volume(s), temperature step value(s), temperature stage value(s); or
well information for one or more wells, the information including one or more of target name, dye name, or sample name; reagent name.

51. The biological analysis system as in any of claims 36-50, further comprising a sensor disposed on or embedded in one or more of the sample holder RFID tag, the sample block, or a thermal block coupled to the sample block.

52. The biological analysis system as in claim 51, wherein the sensor is in communication with the sample holder RFID tag.

53. The biological analysis system as in any of claims 51-52, wherein the sensor comprises one or more of the thermal sensor, an accelerometer, a shock sensor, a photo sensor, a light detector.

54. The biological analysis system as in any of claims 51-53, wherein information from the sensor is written to the sample holder RFID tag at least one time over the life of the sample holder.

55. The biological analysis system as in any of claims 51-54, wherein the sensor is a temperature sensor, the sample holder is configured for use in a PCR assay, and the sample holder RFID tag is configured to record temperatures of the sample holder over one or more thermal cycles during the PCR assay.

56. The biological analysis system as in any of claims 36-55, wherein the at least one RFID reader comprises a first RFID reader configured to receive the RFID data from the first RFID antenna and a second RFID reader configured to receive the RFID data from the second RFID antenna.

57. The biological analysis system as in any of claims 36-56, wherein the system is configured such that during use, when the sample holder is received by the sample block, only one of the RFID antennas is able to receive the RFID data.

58. The biological analysis system as in any of claims 36-57, further comprising a processor and a memory coupled to the processor.

59. The biological analysis system as in claim 58, wherein the memory comprises instructions to:
verify whether at least one of the first RFID antenna or the second RFID antenna is(are) receiving RFID data or signal;
perform at least one of:
if no RFID data or signal is received by either the first RFID antenna or the second RFID antenna, generate (1) a signal indicative that the sample holder does not contain an RFID tag and/or (2) a signal indicative that no sample holder is present;
if RFID data is received by at least one of the RFID antennas, generate at least one of (1) a signal indicative that the sample holder contains a sample holder RFID tag and/or (2) a signal indicative of an orientation of the sample holder; and
if RFID data is received by both of the RFID antennas, generate (1) a signal indicative that the sample holder contains two sample holder RFID tags and/or (2) a signal indicative that two sample holders with sample a holder RFID tag are present.

60. The biological analysis system as in claim 59, wherein the orientation of the sample holder is based on the strength of the data or signal from the RFID tag.

61. The biological analysis system as in any of claims 58-60, wherein the memory comprises instructions to:
receive from a user an initial user input comprising at least one of (1) an input to load or receive a sample holder into the system or (2) an input to initiate an assay;
read at least some of the RFID data;
based at least in part on the read RFID data, generate an assay protocol;
after receiving the initial user input, either (1) execute the assay protocol to perform an assay without any further input or intervention from the user until the assay is completed or (2) modify the assay protocol based on additional input and then execute the modified assay protocol to perform an assay without any further input or intervention from the user until the assay is completed.

62. The biological analysis system as in claim 61, further comprising a reagent container comprising a reagent container RFID tag, wherein the memory comprises instructions to read information from the reagent container RFID tag and, based at least in part on the information from the reagent container RFID tag, generate the assay protocol.

63. The biological analysis system as in any of claims 58-62, wherein the memory comprises instructions to:
prior to performing an assay, confirm or validate the assay protocol using an alternative data source and, if the alternative data source differs from RFID data, then perform at least one of modify the assay protocol, send an alert, or abort the assay protocol.

64. The biological analysis system as in any of claims 58-63, wherein the memory comprising one or more of instructions to:
write over at least a portion of the RFID data using the at least one RFID writer;
encrypt at least a portion of the RFID data using the at least one RFID writer;
erase at least a portion of the RFID data using the at least one RFID writer;
generate a signal indicating the completion of an assay or run;
modify data produced during or after completion of an assay; or
analyze data produced during or after completion of an assay.

65. A method for performing a biological analysis comprising:
providing a biological analysis system comprising:
a housing;
a sample block disposed within the housing and configured to receive a sample holder comprising a sample holder RFID tag;
a first RFID antenna configured during use to receive RFID data from the sample holder RFID tag; and
at least one RFID reader configured to receive the RFID data from the first RFID antenna;
placing a sample holder into or onto the biological analysis system;
receiving from a user an initial user input to initiate an assay;
reading at least some of the RFID data using the first RFID antenna;
generating instructions to perform an assay based at least in part on the read RFID data;
after receiving the initial user input, executing a set of steps to perform an assay on the sample holder without any further input or intervention from the user until the assay is completed or (2) receiving additional input and then executing a set of steps to perform an assay on the sample holder without any further input or intervention from the user until the assay is completed.

66. The method as in claim 65, further comprising:
providing a reagent container comprising a reagent container RFID tag;
reading information from the reagent container RFID tag; and
based at least in part on the information read from the reagent container RFID tag, generating the assay protocol.

67. A method for performing a biological analysis comprising:
providing a biological analysis system comprising:
a housing;
a sample block disposed within the housing;
a first RFID antenna;
a second RFID antenna; and
at least one RFID reader configured to receive the RFID data from the first RFID antenna and from the second RFID antenna;
placing a sample holder in or on the sample block, the sample holder possibly comprising a sample holder RFID tag;
verify whether at least one of the first RFID antenna or the second RFID antenna is(are) receiving RFID data or signal from the sample holder;
perform at least one of:
if no RFID data is received by either the first RFID antenna or the second RFID antenna, generating (1) a signal indicative that the sample holder does not contain an RFID tag and/or (2) a signal indicative that no sample holder is present;
if RFID data is received by at least one of the RFID antennas, generating at least one of (1) a signal indicative that the sample holder contains a sample holder RFID tag and/or (2) a signal indicative of an orientation of the sample holder; and
if RFID data is received by both of the RFID antennas, generating (1) a signal indicative that the sample holder contains two sample holder RFID tags and/or (2) a signal indicative that two sample holders with sample a holder RFID tag are present.

68. The method as in any of claims 65-67, further comprising:
receiving from a user an initial user input comprising at least one of (1) an input to load or receive a sample holder into the system or (2) an input to initiate an assay;
reading at least some of the RFID data;
based on the RFID data read, generating an assay protocol;
after receiving the initial user input, either (1) executing the assay protocol to perform an assay without any further input or intervention from the user until the assay is completed or (2) modifying the assay protocol based on additional input and then executing the modified assay protocol to perform an assay without any further input or intervention from the user until the assay is completed.

69. The method as in any of claims 65-68, further comprising:
prior to performing an assay, confirming or validating the assay protocol using an alternative data source and, if the alternative data source differs from RFID data, then performing at least one of modifying the assay protocol, sending an alert, or aborting the assay protocol.

70. The method as in any of claims 65-69, further comprising:
writing over at least a portion of the RFID data using the at least one RFID writer;
encrypting at least a portion of the RFID data using the at least one RFID writer;
erasing at least a portion of the RFID data using the at least one RFID writer;
generating a signal indicating the completion of an assay or run;
modifying data produced during or after completion of an assay; or
analyzing data produced during or after completion of an assay.

71. The method as in any of claims 65-70, writing information generated during a first assay on the sample holder RFID tag and optionally using the written information to analyze data obtained during the first assay.

72. The method as in any of claims 65-71, wherein the first assay is a PCR assay.

73. The method as in claim 72, wherein the sample holder comprises a temperature sensor, the method further comprises recording a temperature of the sample holder over one or more thermal cycles of the PCR assay.

74. A biological analysis system comprising:
a housing;
a sample block disposed within the housing and configured to receive a sample holder comprising a sample holder RFID tag;
an RFID antenna configured during use to receive RFID data from the sample holder RFID tag;
an RFID reader configured to receive the RFID data from the first RFID antenna;
wherein the RFID antenna is spatially separated from the RFID reader.

75. The biological analysis system as in claim 74, wherein the RFID antennas communicate with the at least one RFID reader via an electrical wire or electrical cable.

76. The biological analysis system as in any of claims 74-75, wherein the first RFID antenna is disposed proximal one side of the sample block and the second RFID antenna is disposed proximal a different side of the sample block.

77. The biological analysis system as in any of claims 74-76, wherein the first RFID antenna is disposed proximal one side of the sample block and the second RFID antenna is disposed proximal an opposite side of the sample block.

78. The biological analysis system as in any of claims 74-76, wherein the sample block has an uppermost surface, the at least one RFID reader is(are) disposed below the uppermost surface, and the RFID antennas are disposed above the uppermost surface.

79. The biological analysis system as in any of claims 74-77, wherein the memory comprises instructions to:
verify whether the RFID antenna is receiving RFID data or signal;
perform at least one of:
if no RFID data or signal is received by the RFID antenna generate (1) a signal indicative that the sample holder does not contain an RFID tag and/or (2) a signal indicative that no sample holder is present;
if RFID data is received by the RFID antenna, generate at least one of (1) a signal indicative that the sample holder contains a sample holder RFID tag and/or (2) a signal indicative of an orientation of the sample holder; or
if RFID data is received by the RFID antenna, generate (1) a signal indicative that the sample holder contains two sample holder RFID tag or (2) a signal indicative that two sample holders with sample a holder RFID tag are present.

80. The biological analysis system as in claim 79, wherein the orientation of the sample holder is based on the strength of the data or signal from the RFID tag.

81. A sample holder for a biological analysis, comprising:
a holder comprising a plurality of spatially separated reaction locations, each of the plurality of spatially separated reaction locations comprising a plurality of characteristics;
a sample holder RFID tag disposed in or on the sample holder, the sample holder RFID tag including RFID data comprising data for the plurality of characteristics each of the reaction location;
wherein the RFID data comprises at least 8 kilobytes, at least 64 kilobytes, or at least 128 kilobytes.

82. The sample holder as in claim 81, wherein the plurality of spatially separated reaction locations comprises at least 96 reaction locations, at least 384 reaction locations, at least 1536 reaction locations, at least 3072 reaction locations, or at least 12,288 reaction locations.

83. The sample holder as in any of claims 81-82, wherein the RFID data on the sample holder RFID comprises one or more of:
sample holder ID;
sample holder expiration date;
sample holder part number;
sample holder barcode;
sample holder lot number;
sample holder type;
storage temperature and/or storage temperature range;
sample concentration - recommended range; provision for E1 pipette support?
sales order number;
assay name(s) and/or locations on sample holder;
assay IDs;
suggested protocol or required protocol;
sample name(s)
master mix name(s);
master mix change(s);
dye name(s);
suggested or required filter or set of filters to be used during an assay on the sample holder;
EDT file format and/or EDF file format;
internet links or addresses;
passive reference dye(s);
reaction volume(s);
target name(s);
dye name(s);
sample name(s);
analysis settings;
flag setting(s);
sample type(s);
target type(s);
reagent name;
run protocol(s) comprising one or more of a heated cover temperature, reaction volume(s), temperature step value(s), temperature stage value(s);
well information for one or more wells, the information including one or more of target name, dye name, or sample name.

84. The sample holder as in any of claims 83, wherein the plate type is characterized by 48, 96, 384, 1536, or 3072 wells or through-holes.

85. The sample holder as in any of claims 83-84, wherein the plate type is characterized by wells having a volume of 0.1 milliliters or 0.2 milliliters.

86. The sample holder as in any of claims 83-85, wherein the RFID data on the sample holder RFID include re-writeable data comprising one or more of:
passive reference dye(s);
reaction volume(s);
target name(s);
dye name(s);
sample name(s);
analysis settings;
flag setting(s);
sample type(s);
target type(s);
reagent name;
run protocol(s) comprising one or more of a heated cover temperature, reaction volume(s), temperature step value(s), temperature stage value(s);
well information for one or more wells, the information including one or more of target name, dye name, or sample name.

87. The sample holder as in any of claims 81-86, wherein the sample holder comprises a sensor.

88. The sample holder as in claim 87, wherein the sensor is in communication with the sample holder RFID tag.

89. The sample holder as in any of claims 87-88, wherein the sensor comprises one or more of the thermal sensor, an accelerometer, a shock sensor, a photo sensor, a light detector.

90. The sample holder as in any of claims 87-89, wherein information from the sensor is written to the sample holder RFID tag at least one time over the life of the sample holder.

91. The sample holder as in any of claims 87-90, wherein the sensor is a temperature sensor, the sample holder is configured for use in a PCR assay, and the sample holder RFID tag is configured to record temperatures of the sample holder over one or more thermal cycles during the PCR assay.

92. A biological analysis system comprising:
a housing;
a sample block disposed within the housing;
the sample holder of any of claims 81-91, the sample holder disposed in or on the sample block;
an RFID antenna configured during use to receive RFID data from the sample holder RFID tag;
an RFID reader configured to receive the RFID data from the first RFID antenna.

93. The biological analysis system as in claim 92, wherein an RFID writer is configured to write assay information generated during an assay onto the sample holder RFID tag and, optionally, the system is configured to use the assay information to analyze data obtained during the assay.

94. A biological analysis system comprising:
a housing;
a block assembly comprising a sample block and a base configured to receive the sample block;
a first drive mechanism configured to generate relative movement between the sample block and the housing along a first axis between a closed position to an open position;
a lock configured to lock the sample block to the base;
a processor and a memory coupled to the processor, the memory including instructions to:
based on a first command, operate the lock to provide a locked position in which the sample block is locked to the tray;
based on a second command, operate the lock to provide an unlocked position in which the sample block is not locked to the tray;
move the sample block and the base from a closed position to an open position with the lock in either the locked position or the unlocked position.

95. The biological analysis system as in claim 79, wherein at least one of the commands is provided by a user of the biological analysis system.

96. A method for biological analysis comprising:
providing a system comprising:
a sample block;
a base configured to receive the sample block;
a heated cover configured to be placed over the sample block;
a carrier configured to receive the heated cover;
a processor and a memory coupled to the processor, the memory including instructions to move the sample block and base between an open position and a closed position;
attaching the heated cover to the carrier;
separating the heated cover from the sample block by lifting the carrier;
using the drive mechanism, moving the sample block and the base from the closed position to the open position;
placing a sample plate in the sample block;
using the drive mechanism, moving the sample block from the open position to the closed position;
placing the heated cover onto the sample block by lowering the carrier.;
.

97. A method for biological analysis comprising:
providing a system comprising:
a sample block;
a base configured to receive the sample block;
a heated cover configured to be placed over the sample block;
a carrier configured to engage the heated cover using an engagement apparatus;
a processor and a memory coupled to the processor, the memory including instructions to move the sample block and base between an open position and a closed position;
detaching the carrier from the first heated cover; grab
separating the first heated cover from the carrier by lifting the carrier;
using the drive mechanism, moving the first sample block and the first heated cover from a closed position to an open position;
providing a second block configuration by replacing at least one of the first sample block with a second sample block or the first heated cover with a second heated cover.

98. The method as in claim 82, wherein the engagement apparatus comprises a one or more gripper arms disposed on opposite sides of the carrier.

99. The method as in any of claims 82-83, further comprising:
optionally placing a sample plate in the sample block;
using the drive mechanism, moving the sample block from the open position to the closed position;
lowering the carrier;
locking the carrier to the heated cover using the gripper arms;
performing a qPCR assay;
retracting the heated cover from the sample block by lifting the carrier.

100. A biological analysis instrument comprising:
a proximity sensor configured determine the presence or distance of a perspective user of the instrument;
an activation and/or recognition system comprising at least one of a voice activation and/or recognition system or a face activation and/or recognition system;
a processor and a memory coupled to the processor, the memory including instructions to:
query the activation and/or recognition system to produce a first output;
determine whether the first output meets one or more first predetermined criteria;
query the proximity sensor to produce a second output;
determine whether the second output meets one or more second predetermined criteria;
start, power up, or activate the instrument if both (1) the first output meets the one or more first predetermined criteria and (2) the second output meets one or more second predetermined criteria.

101. A method of starting, powering up, or activating biological analysis instrument comprising:
querying an activation and/or recognition system to produce a first output, the activation and/or recognition system comprising one or more of a voice activation and/or recognition system or a face activation and/or recognition system;
determining whether the first output meets one or more first predetermined criteria;
querying a proximity sensor to produce a second output;
determining whether the second output meets one or more second predetermined criteria;
starting, powering up, or activating the instrument if both (1) the first output meets the one or more first predetermined criteria and (2) the second output meets one or more second predetermined criteria.

102. A method of starting, powering up, or activating biological analysis instrument comprising:
querying an activation and/or recognition system to produce a first output, the activation and/or recognition system comprising one or more of a voice activation and/or recognition system or a face activation and/or recognition system;
determining whether the first output meets one or more first predetermined criteria;
querying a proximity sensor to produce a second output;
determining whether the second output meets one or more second predetermined criteria;
starting, powering up, or activating the instrument if both (1) the first output meets the one or more first predetermined criteria and (2) the second output meets one or more second predetermined criteria.

103. A biological analysis system, comprising:
one or more of a carrier, base, or tray configured to interchangeably receive (1) a first block and a corresponding first cover placed over the first block or (2) a second block and a corresponding second cover placed over the second block;
a computer readable memory comprising instructions for detecting when the second cover is placed over the first block and/or for detecting when the first cover is placed over the second block based on lack of electrical continuity along an electrical path comprising one of the blocks and one of the covers.

104. A biological analysis system of claim 103, wherein the memory further comprises instruction for one or more of:
sending a message or an alarm when the second cover is placed over the first block and/or when the first cover is placed over the second block;
preventing the carrier, base, or tray from being received by the analysis system;
preventing the system from conducting a biological assay.

105. A biological analysis system of claim 104, wherein:
the first block is configured to receive a sample holder comprising a biological sample and comprises a first block connector including a first block connector element in electrical communication with a first block electrical conductor;
the first cover comprises a first cover connector including a first cover connector element in electrical communication with a first cover electrical conductor;
the second block is configured to receive a sample holder comprising a biological sample and comprises a second block connector including a second block connector element in electrical communication with a second block electrical conductor;
the second cover comprises a second cover connector including a second cover connector element in electrical communication with a second cover electrical conductor; wherein:
the first cover connector is configured to engage the first block connector to provide electrical continuity between the first block electrical conductor and the first cover electrical conductor;
the second cover connector is configured to engage the second block connector to provide electrical continuity between the second block electrical conductor and the second cover electrical conductor; and
at least one of (1) the first block connector is configured to engage the second cover connector to provide electrical isolation or lack of electrical continuity between the first block electrical conductor and the second cover electrical conductor or (2) the second block connector is configured to engage the first cover connector to provide electrical isolation or lack of electrical continuity between the second block electrical conductor and the first cover electrical conductor.

106. A biological analysis system, comprising:
a first block configured to receive a sample holder comprising a biological sample, the first block comprising a first block connector including a first block connector element in electrical communication with a first block electrical conductor;
a first cover configured to cover the first block, the first cover comprising a first cover connector including a first cover connector element in electrical communication with a first cover electrical conductor;
a second block configured to receive a sample holder comprising a biological sample, the second block comprising a second block connector including a second block connector element in electrical communication with a second block electrical conductor;
a second cover configured to cover the second block, the second cover comprising a second cover connector including a second cover connector element in electrical communication with a second cover electrical conductor; wherein:
the first cover connector is configured to engage the first block connector to provide electrical continuity between the first block electrical conductor and the first cover electrical conductor;
the second cover connector is configured to engage the second block connector to provide electrical continuity between the second block electrical conductor and the second cover electrical conductor; and
at least one of (1) the first block connector is configured to engage the second cover connector to provide electrical isolation between the first block electrical conductor and the second cover electrical conductor or (2) the second block connector is configured to engage the first cover connector to provide electrical isolation between the second block electrical conductor and the first cover electrical conductor.

107. The system of any one of claims 105 to 106, further comprising a sample holder disposed on or in at least one of the blocks.

108. The system of any one of claims 105 to 107, at least one of the blocks comprises a wavy spring disposed on a surface of the at least one of the blocks and configured to apply a force to the sample holder in a direction away from the at least one of the blocks.

109. The system of any one of claims 105 to 108, wherein one or more of the connector elements is an electrically conductive pin, electrically conductive boss, electrically conductive wire or cable end, or connector element.

110. The system of any one of claims 105 to 109, wherein one or more of the electrical conductors comprises at least one of an electrical wire, an electrical cable, or at least a portion of an electrical circuit.

111. The system of any one of claims 105 to 110, wherein at least one of:
the first block connector comprises a first block cavity and the first cover connector comprises a first projecting portion configured to fit at least partially inside the first block cavity; or
the second block connector comprises a second block cavity and the second cover connector comprises a second projecting portion configured to fit inside the second block cavity.

112. The system of claim 111, wherein at least one of the projecting portions is a boss.

113. The system of any one of claims 111 to 112, wherein:
the first projecting portion comprises a first annulus having a first inner volume containing the first cover connector element;
the first block cavity comprises the first block connector element;
the second projecting portion comprises a second annulus including a slotted, grooved, and/or cutout wall portion and a second inner volume containing the second cover connector element;
the second block cavity comprises a crossmember configured to fit inside the slotted, grooved, and/or cutout portion and the second block connector element.

114. The system of claim 113, wherein the crossmember and the second block connector element form a single piece.

115. The system of any one of claims 113 to 114, wherein the second annulus includes two slotted, grooved, and/or cutout wall portions located about 180 degrees apart about a circumference of the second annulus.

116. The system of any one of claims 113 to 115, wherein:
the first cover connector element is recessed within the first annulus of the first projecting portion by a first distance;
the second block connector element protrude away from the crossmember by a second distance that is less than the first distance.

117. The system of any one of claims 113 to 116, wherein:
the second cover connector element is recessed within the second annulus of the first projecting portion by a third distance;
the first block connector element protrudes away from a floor of the first block cavity by a fourth distance that is less than the third distance.

118. The system of any one of claims 105 to 110, further comprising:
the first block comprises a first auxiliary block connector including a first auxiliary block connector element in electrical communication with a first auxiliary block electrical conductor;
the first cover comprises a first cover auxiliary connector including a first cover auxiliary connector element in electrical communication with a first cover auxiliary electrical conductor;
the second block comprises a second block auxiliary connector including a second block auxiliary connector element in electrical communication with a second block auxiliary electrical conductor;
the second cover comprising a second cover auxiliary connector including a second cover auxiliary connector element in electrical communication with a second cover auxiliary electrical conductor; wherein:
the first cover auxiliary connector is configured to engage the first block auxiliary connector to provide electrical continuity between the first block auxiliary electrical conductor and the first cover auxiliary electrical conductor;
the second cover auxiliary connector is configured to engage the second block auxiliary connector to provide electrical continuity between the second block auxiliary electrical conductor and the second cover auxiliary electrical conductor; and
optionally, at least one of (1) the first block auxiliary connector is configured to engage the second cover auxiliary connector to provide electrical isolation between the first block auxiliary electrical conductor and the second auxiliary cover electrical conductor or (2) the second block auxiliary connector is configured to engage the first cover auxiliary connector to provide electrical isolation between the second auxiliary block auxiliary electrical conductor and the first cover auxiliary electrical conductor.

119. The system of claim 118, wherein at least one of:
the first block connector comprises a first block cavity and the first cover connector comprises a first projecting portion configured to fit at least partially inside the first block cavity;
the second block connector comprises a second block cavity and the second cover connector comprises a second projecting portion configured to fit inside the second block cavity;
the first block auxiliary connector comprises a first block auxiliary cavity and the first cover auxiliary connector comprises a first auxiliary projecting portion configured to fit at least partially inside the first block auxiliary cavity; or
the second block auxiliary connector comprises a second block auxiliary cavity and the second cover auxiliary connector comprises a second auxiliary projecting portion configured to fit inside the second block auxiliary cavity.

120. The system of claim 119, wherein:
the first projecting portion comprises a first annulus having a first inner volume containing the first cover connector element;
the first block cavity comprises the first block connector element
the second projecting portion comprises a second annulus including a slotted, grooved, and/or cutout wall portion and a second inner volume containing the second cover connector element;
the second block cavity comprises a crossmember configured to fit inside the slotted, grooved, and/or cutout portion and the second block connector element;
the first auxiliary projecting portion comprises a first auxiliary annulus having a first auxiliary inner volume containing the first cover auxiliary connector element;
the first block auxiliary cavity comprises the first block auxiliary connector element;
the second auxiliary projecting portion comprises a second auxiliary annulus including an auxiliary slotted, grooved, and/or cutout wall portion and a second auxiliary inner volume containing a second cover auxiliary connector element;
the second block cavity comprises an auxiliary crossmember configured to fit inside the auxiliary slotted, grooved, and/or cutout portion and the second block auxiliary connector element.

121. The system of claim 120, wherein the second block cavity and the second auxiliary projecting portion of the second cover produce electrical isolation or lack of electrical continuity between the second block electrical conductor and the second cover auxiliary electrical conductor when the orientation of the second cover relative to the second block does not match a predetermined or intended orientation of the second cover relative to the second block.

122. The system of claim 121, wherein the orientation of the second cover relative to the second block is rotated 180 degrees from the predetermined or intended orientation of the second cover relative to the second block.

123. The system of any one of claims 120 to 122, wherein:
the crossmember of the second block cavity is disposed along a first axis;
the auxiliary crossmember of the second block auxiliary cavity is disposed along a second axis that is oriented at a different angle than the first axis;
the slotted, grooved, and/or cutout wall portion of the annulus of the second projecting member is disposed about a ring of the annulus along the first axis;
the auxiliary slotted, grooved, and/or cutout wall portion of the auxiliary annulus of the second auxiliary projecting member is disposed about a ring of the annulus along the second axis.

124. The system of claim 123, wherein the second axis is orthogonal or approximately orthogonal to the first axis.

125. The system of any one of claims 113 to 124, wherein:
the first annulus comprises a slotted, grooved, and/or cutout wall portion;
the first block cavity comprises a crossmember configured to fit inside the slotted, grooved, and/or cutout portion of the first annulus.

126. The system of any one of claims 120 to 124, wherein:
the first annulus comprises a slotted, grooved, and/or cutout wall portion;
the first block cavity comprises a crossmember configured to fit inside the slotted, grooved, and/or cutout portion of the first annulus;
the first auxiliary annulus including an auxiliary slotted, grooved, and/or cutout wall portion;
the first block cavity comprises an auxiliary crossmember configured to fit inside the slotted, grooved, and/or cutout portion of the first annulus.

127. The system of claim 126, wherein:
the crossmember of the first block cavity is disposed along a third axis;
the auxiliary crossmember of the first block auxiliary cavity is disposed along a fourth axis that is oriented at a different angle than the third axis;
the slotted, grooved, and/or cutout wall portion of the annulus of the first projecting member is disposed about a ring of the annulus along the third axis;
the auxiliary slotted, grooved, and/or cutout wall portion of the auxiliary annulus of the first auxiliary projecting member is disposed about a ring of the annulus along the fourth axis.

128. The system of claim 127, wherein the fourth axis is orthogonal or approximately orthogonal to the third axis.

129. The system of any one of claims 105 to 110, wherein at least one of:
the first cover connector comprises a first cover cavity and the first block connector comprises a first projecting portion configured to fit at least partially inside the first cover cavity; or
the second cover connector comprises a second cover cavity and the second block connector comprises a second projecting portion configured to fit inside the second cover cavity.

130. The system of claim 129, wherein at least one of the projecting portions is a boss.

131. The system of any one of claims 129 to 130, wherein:
the first projecting portion comprises a first annulus having a first inner volume containing the first block connector element;
the first cover cavity comprises the first cover connector element;
the second projecting portion comprises a second annulus including a slotted, grooved, and/or cutout wall portion and a second inner volume containing the second block connector element;
the second cover cavity comprises a crossmember configured to fit inside the slotted, grooved, and/or cutout portion and the second cover connector element.

132. The system of claim 131, wherein the crossmember and the second cover connector element form a single piece.

133. The system of any one of claims 113 to 132, wherein the second annulus includes two slotted, grooved, and/or cutout wall portions located about 180 degrees apart about a circumference of the second annulus.

134. The system of any one of claims 113 to 133, wherein:
the first block connector element is recessed within the first annulus of the first projecting portion by a first distance;
the second cover connector element protrude away from the crossmember by a second distance that is less than the first distance.

135. The system of any one of claims 113 to 134, wherein:
the second block connector element is recessed within the second annulus of the first projecting portion by a third distance;
the first cover connector element protrudes away from a floor of the first cover cavity by a fourth distance that is less than the third distance.

136. The system of any one of claims 105 to 110, further comprising:
the first cover comprises a first auxiliary cover connector including a first auxiliary cover connector element in electrical communication with a first auxiliary cover electrical conductor;
the first block comprises a first block auxiliary connector including a first block auxiliary connector element in electrical communication with a first block auxiliary electrical conductor;
the second cover comprises a second cover auxiliary connector including a second cover auxiliary connector element in electrical communication with a second cover auxiliary electrical conductor;
the second block comprising a second block auxiliary connector including a second block auxiliary connector element in electrical communication with a second block auxiliary electrical conductor; wherein:
the first block auxiliary connector is configured to engage the first cover auxiliary connector to provide electrical continuity between the first cover auxiliary electrical conductor and the first block auxiliary electrical conductor;
the second block auxiliary connector is configured to engage the second cover auxiliary connector to provide electrical continuity between the second cover auxiliary electrical conductor and the second block auxiliary electrical conductor; and
optionally, at least one of (1) the first cover auxiliary connector is configured to engage the second block auxiliary connector to provide electrical isolation between the first cover auxiliary electrical conductor and the second auxiliary block electrical conductor or (2) the second cover auxiliary connector is configured to engage the first block auxiliary connector to provide electrical isolation between the second auxiliary cover auxiliary electrical conductor and the first block auxiliary electrical conductor.

137. The system of claim 136, wherein at least one of:
the first cover connector comprises a first cover cavity and the first block connector comprises a first projecting portion configured to fit at least partially inside the first cover cavity;
the second cover connector comprises a second cover cavity and the second block connector comprises a second projecting portion configured to fit inside the second cover cavity;
the first cover auxiliary connector comprises a first cover auxiliary cavity and the first block auxiliary connector comprises a first auxiliary projecting portion configured to fit at least partially inside the first cover auxiliary cavity; or
the second cover auxiliary connector comprises a second cover auxiliary cavity and the second block auxiliary connector comprises a second auxiliary projecting portion configured to fit inside the second cover auxiliary cavity.

138. The system of claim 137, wherein:
the first projecting portion comprises a first annulus having a first inner volume containing the first block connector element;
the first cover cavity comprises the first cover connector element;
the second projecting portion comprises the second annulus including a slotted, grooved, and/or cutout wall portion and a second inner volume containing a second block connector element;
the second cover cavity comprises a crossmember configured to fit inside the slotted, grooved, and/or cutout portion and the second cover connector element;
the first auxiliary projecting portion comprises a first auxiliary annulus having a first auxiliary inner volume containing the first block auxiliary connector element;
the first cover auxiliary cavity comprises the first cover auxiliary connector element;
the second auxiliary projecting portion comprises a second auxiliary annulus including an auxiliary slotted, grooved, and/or cutout wall portion and a second auxiliary inner volume containing the second block auxiliary connector element;
the second cover cavity comprises an auxiliary crossmember configured to fit inside the auxiliary slotted, grooved, and/or cutout portion and the second cover auxiliary connector element.

139. The system of claim 138, wherein the second cover cavity and the second auxiliary projecting portion of the second block produce electrical isolation or lack of electrical continuity between the second cover electrical conductor and the second block auxiliary electrical conductor when the orientation of the second block relative to the second cover does not match a predetermined or intended orientation of the second block relative to the second cover.

140. The system of claim 139, wherein the orientation of the second block relative to the second cover is rotated 180 degrees from the predetermined or intended orientation of the second block relative to the second cover.

141. The system of any one of claims 138 to 140, wherein:
the crossmember of the second cover cavity is disposed along a first axis;
the auxiliary crossmember of the second cover auxiliary cavity is disposed along a second axis that is oriented at a different angle than the first axis;
the slotted, grooved, and/or cutout wall portion of the annulus of the second projecting member is disposed about a ring of the annulus along the first axis;
the auxiliary slotted, grooved, and/or cutout wall portion of the auxiliary annulus of the second auxiliary projecting member is disposed about a ring of the annulus along the second axis.

142. The system of claim 123, wherein the second axis is orthogonal or approximately orthogonal to the first axis.

143. The system of any one of claims 113 to 141, wherein:
the first annulus comprises a slotted, grooved, and/or cutout wall portion;
the first cover cavity comprises a crossmember configured to fit inside the slotted, grooved, and/or cutout portion of the first annulus.

144. The system of any one of claims 138 to 141, wherein:
the first annulus comprises a slotted, grooved, and/or cutout wall portion;
the first cover cavity comprises a crossmember configured to fit inside the slotted, grooved, and/or cutout portion of the first annulus;
the first auxiliary annulus including an auxiliary slotted, grooved, and/or cutout wall portion;
the first cover cavity comprises an auxiliary crossmember configured to fit inside the slotted, grooved, and/or cutout portion of the first annulus.

145. The system of claim 144, wherein:
the crossmember of the first cover cavity is disposed along a third axis;
the auxiliary crossmember of the first cover auxiliary cavity is disposed along a fourth axis that is oriented at a different angle than the third axis;
the slotted, grooved, and/or cutout wall portion of the annulus of the first projecting member is disposed about a ring of the annulus along the third axis;
the auxiliary slotted, grooved, and/or cutout wall portion of the auxiliary annulus of the first auxiliary projecting member is disposed about a ring of the annulus along the fourth axis.

146. The system of claim 145, wherein the fourth axis is orthogonal or approximately orthogonal to the third axis.

147. The system of any one of claims 103 to 146, wherein the system comprises a system configured to perform one or more of a polymerase chain reaction (PCR) assay, experiment, or test, a real-time PCR assay, experiment, or test, a digital PCR assay, experiment, or test, an DNA amplification assay, experiment, or test, a sequencing assay, experiment, or test, a flow cytometry assay, experiment, or test, or a capillary electrophoresis assay, experiment, or test.

148. A method of conducting a biological assay using a biological analysis system, the method comprising:
placing one of a first block or a second block in or on a carrier, base, or tray;
optionally placing in or on the carrier, base, or tray a sample holder comprising a biological sample;
placing a run cover over the received first block or second block, wherein at least one of:
the first block comprises a first block connector including a first block connector element in electrical communication with a first block electrical conductor and the first cover comprises a first cover connector including a first cover connector element in electrical communication with a first cover electrical conductor; and/or
the second block comprises a first block connector including a first block connector element in electrical communication with a second block electrical conductor and the second cover comprises a second cover connector including a second cover connector element in electrical communication with a second cover electrical conductor;
performing a continuity check;
based on the continuity check, confirming at least one of:
(e) the run cover is the first cover if the first base is in or on the carrier, base, or tray;
(f) the run cover is the second cover if the second base is in or on the carrier, base, or tray;
(g) the run cover is not the first cover if the first base is in or on the carrier, base, or tray;
(h) the run cover is not the second cover if the second base is in or on the carrier, base, or tray;
if (a) or (b) is confirmed, at least one of:
loading or transporting the placed block and tray into or on the biological analysis system;
providing a signal or message that the base and cover are suitable for running a biological analysis or assay;
running a biological analysis or assay using the biological analysis system;
if (c) or (d) is confirmed, at least one of:
discontinuing the method;
providing a message, signal, or alarm that the base and cover are not suitable;
providing a message, signal, or alarm to change at least one of the cover or the block;
loading or transporting the placed block and tray into or on the biological analysis system, but not running a biological analysis or assay.

149. The method of claim 148, wherein the biological analysis system comprises a polymerase chain reaction (PCR) assay, experiment, or test, a real-time PCR assay, experiment, or test, a digital PCR assay, experiment, or test, an DNA amplification assay, experiment, or test, a sequencing assay, experiment, or test, a flow cytometry assay, experiment, or test, or a capillary electrophoresis assay, experiment, or test.

150. A method of aligning a sample block of a biological analysis system, comprising:
loosening a moveable portion of a block from a fixed portion of the block;
placing an alignment fixture on the block;
locating the block in an instrument;
performing a scan over of at least one reaction location of the fixture;
locating the moveable portion to an aligned position based on scan;
optionally, securing the moveable portion to the fixed portion;
confirming the alignment by scanning over of the at least one reaction location of the fixture:
optionally, removing the fixture from the block.

151. The method of claim 150, wherein:
the alignment fixture comprises one or more openings or wells in a top surface of the alignment fixture corresponding to the a respective one or more openings in a cover
one or more of the wells comprises a smaller opening located at a bottom of the well.

152. The method of claim 150 or 151, wherein the one or more wells further comprise a reflective or optically active material within or at the bottom of the opening 152 The method any one of claim 150-152, wherein the openings comprise an elongated opening or slit that is at a location to which the sample block is to be aligned. 152 The method any one of claim 150-153, wherein opening are centered within the well or are disposed at a different alignment location.
